(19) United States
(12) Patent Application Publication
(10) Pub. No.: US 2015/0185512 A1
(43) Pub. Date: Jul. 2, 2015

(54) LIQUID-CRYSTAL DISPLAY ELEMENT AND SUBSTRATE USED IN SAME

(71) Applicants: KYUSHU UNIVERSITY, NATIONAL UNIVERSITY CORPORATION, Fukuoka-shi (JP); JNC CORPORATION, Tokyo (JP); JNC PETROCHEMICAL CORPORATION, Tokyo (JP)

(72) Inventors: Hirotsugu KIKUCHI, Fukuoka-shi (JP); Shin-ichi YAMAMOTO, Ichihara-shi (JP); Yasuhiro HASEBA, Ichihara-shi (JP); Takafumi KUNINOBU, Ichihara-shi (JP)

(73) Assignees: KYUSHU UNIVERSITY, NATIONAL UNIVERSITY CORPORATION, Fukuoka-shi (JP); JNC CORPORATION, Tokyo (JP); JNC PETROCHEMICAL CORPORATION, Tokyo (JP)

(21) Appl. No.: 14/634,426

(22) Filed: Feb. 27, 2015

Related U.S. Application Data
(62) Division of application No. 13/392,803, filed on Mar. 8, 2012.

(30) Foreign Application Priority Data
Aug. 28, 2009 (JP) 2009198596

(51) Int. Cl. G02F 1/137; G02F 1/133; C09K 19/02

(52) U.S. Cl. CPC G02F 1/137; C09K 19/0275; G02F 1/13306; G02F 2001/13793

(57) ABSTRACT

A substrate used for a liquid crystal display element having two or more substrates arranged oppositely to each other and a liquid crystal material exhibiting a blue phase between the substrates, where a polar component of surface free energy on a substrate surface in contact with the liquid crystal material is less than 5 mJm⁻²; and a substrate used for a liquid crystal display element having two or more substrates arranged oppositely to each other and a liquid crystal material exhibiting a blue phase between the substrates, where a polar component of surface free energy on a substrate surface in contact with the liquid crystal material is in the range of 5 to 20 mJm⁻², and a contact angle with an isotropic phase of the liquid crystal material on the substrate surface is 50 degrees or less.

### TECHNICAL FIELD

The present invention relates to a liquid crystal display element and a substrate used for the element. More specifically, the invention relates to a liquid crystal display element using a liquid crystal material exhibiting a blue phase and a substrate used for the element.

### BACKGROUND ART

A liquid crystal display element using a liquid crystal composition has been widely used for a display for a watch, a calculator, a word processor and so forth. The liquid crystal display elements utilize a refractive index anisotropy, a dielectric anisotropy or the like of a liquid crystal compound. As an operating mode in the liquid crystal display element, phase change (PC), twisted nematic (TN), super twisted nematic (STN), bistable twisted nematic (BTN), electrically controlled birefringence (ECB), optically compensated bend (OCB), in-plane switching (IPS), vertical alignment (VA) or the like for performing a display mainly using at least one polarizer has been known. Furthermore, a mode for exhibiting electric birefringence by applying an electric field in an optically isotropic liquid crystal phase has also been extensively studied in recent years (Patent literatures No. 1 to No. 9, Non-patent literatures No. 1 to No. 3).

Furthermore, a wavelength variable filter, a wavefront control element, a liquid crystal lens, an aberration correction element, an aperture control element, an optical head device or the like using the electric birefringence in a blue phase as one of the optically isotropic liquid crystal phases has been proposed (Patent literatures No. 10 to No. 12). A classification based on a driving mode in the element includes a passive matrix (PM) and an active matrix (AM). The passive matrix (PM) is further classified into static, multiplex and so forth, and the AM is classified into a thin film transistor (TFT), a metal insulator metal (MIM) and so forth.

The blue phase is positioned as a frustrated phase in which double twisted structure and defects coexist. The phase is exhibited near an isotropic phase in a slight temperature range. A finding that a temperature range is extended to several tens of degrees Centigrade or more by forming a small amount of polymer in the range of 7 to 8 wt. % in the blue phase has been reported as a polymer-stabilized blue phase (Non-patent literature No. 1). The finding is considered such that the polymer is concentrated in a defect constituting the blue phase, the defect is thermally stabilized, and thus the blue phase is stabilized.

There are low contrast ratio and high driving voltage in a problem of a display element using the polymer-stabilized blue phase. A decrease of contrast occurs when diffracted light originating from three-dimensional periodic structure of the blue phase exists in a visible region. The decrease of contrast can be suppressed by preparing liquid crystals having a high chirality and allowing the diffracted light from the blue phase to exist in an ultraviolet region. However, as a result, the driving voltage is increased. The increase of the driving voltage is caused by a high critical voltage for loosening helical structures of a chiral liquid crystal composition with a high chirality.

A plural optical diffraction is caused by structure in three-dimensional period of blue phase. The blue phase is a liquid crystal phase in which the double twisted structure is three-dimensionally expanded. From a history of long years of research on the blue phase, a cubic structure in which double twists are crossed at right angles has been proposed for structure of the blue phase. Blue phase I and blue phase II take a complicated hierarchical structure having a body-centered cubic lattice and a simple cubic lattice, respectively.

In the blue phase, the lattice plane which it is pearled for the substrate is determined by optical diffraction due to the lattice structure. In an optical diffraction, diffraction from lattice planes such as 110, 200 and 211 appears in order from a long wavelength in blue phase I, and diffraction from lattice planes such as 100 and 110 appears in blue phase II. The diffraction phenomenon is given by equation (I):

$$λ = \frac{2 na}{\sqrt{{h}^{2} + {k}^{2} + {l}^{2}}} \qquad ( I )$$

Where λ represents an incident wavelength, n represents a refractive index, and a is a lattice constant. Moreover, h, k and l are a Miller's index.

In the blue phase, a plurality of reflection peaks appear, and thus the lattice plane aligned in parallel to the substrate can be specified by analyzing the diffraction from the blue phase.

In general, the diffracted light from the blue phase and the polymer-stabilized blue phase can be caused to disappear from the visible region by increasing chirality. A colorless and transparent polymer-stabilized blue phase can be prepared by using a colorless blue phase in which the optical diffraction is shifted from the visible region to an ultraviolet region. However, the technique involves a problem that the critical voltage for loosing helical structures is increased, as a result, the driving voltage of the liquid crystal display element is increased. On the other hand, a blue phase merely exhibiting a single color is also expected to be applied to a variety of optical elements.
Patent literature No. 1: JP 2003-327966 A.
Patent literature No. 2: WO 2005/90520 A.
Patent literature No. 3: JP 2005-336477 A.
Patent literature No. 4: JP 2006-89622 A.
Patent literature No. 5: JP 2006-299084 A.
Patent literature No. 6: JP 2006-506477 A.
Patent literature No. 7: JP 2006-506515 A.
Patent literature No. 8: WO 2006/063662 A.
Patent literature No. 9: JP 2006-225655 A.
Patent literature No. 10: JP 2005-157109 A.
Patent literature No. 11: WO 2005/80529 A.
Patent literature No. 12: JP 2006-127707 A.
Non-patent literature No. 1: Nature Materials, 1, 64 (2002).
Non-patent literature No. 2: Adv. Mater., 17, 96 (2005).
Non-patent literature No. 3: Journal of the SID, 14, 551 (2006).

### DISCLOSURE OF INVENTION

### Technical Problem

By circumstances such as the above, it is demanded that plural Bragg optical diffraction from circular polarized light due to the structure of blue phase is controlled with the substrates contacting with liquid crystal. A request has been made for a liquid crystal display element in which a colorless blue phase having a low drive voltage is exhibited by controlling chirality of the blue phase for a specific lattice plane to be directed in parallel to the substrate used for the liquid crystal element, and allowing Bragg diffraction light of the blue phase to shift outside a visible region. Moreover, a request has been made for an optical element containing a blue phase exhibiting a single color. For example, if a 110 plane is directed in parallel to suppress high-order diffracted light, and chirality is adjusted for allowing a lattice plane 110 to be located in a longer wavelength side, as compared with a visible light region, a blue phase having a low chirality and a high contrast can be prepared. As a result, the driving voltage can be reduced by the low chirality.

A request has been made for a liquid crystal display element using a liquid crystal material exhibiting the blue phase in which the element can be used in a wide temperature range, and can achieve a short response time, a large contrast and a low drive voltage.

### Solution to Problem

The inventors of the invention diligently have made efforts, as a result, found out a new knowledge that a correlation exists between surface free energy on a substrate surface, and a lattice plane ratio in a blue phase of a liquid crystal material in contact with the substrate surface.

More specifically, the invention provides a liquid crystal display element, a substrate used for the element and so forth as shown below.

Item 1. A substrate used for a liquid crystal display element having two or more substrates arranged oppositely to each other and a liquid crystal material exhibiting a blue phase between the substrates, where a polar component of surface free energy on a substrate surface in contact with the liquid crystal material is less than 5 mJm⁻².

Item 2. The substrate according to item 1, where the polar component of surface free energy on the substrate surface is 3 mJm⁻² or less.

Item 3. The substrate according to item 1, where the polar component of surface free energy on the substrate surface is 2 mJm⁻² or less.

Item 4. The substrate according to any one of items 1 to 3, where total surface free energy on the substrate surface is 30 mJm⁻² or less.

Item 5. The substrate according to any one of items 1 to 4, where the contact angle with water on the substrate surface is 10 degrees or more.

Item 6. The substrate according to any one of items 1 to 5, where the organosilane is formed on the substrate surface.

Item 7. A substrate used for a liquid crystal display element having two or more substrates arranged oppositely to each other and a liquid crystal material exhibiting a blue phase between the substrates, where a polar component of surface free energy on a substrate surface in contact with the liquid crystal material is in the range of 5 to 20 mJm⁻², and a contact angle with an isotropic phase of the liquid crystal material on the substrate surface is 50 degrees or less.

Item 8. The substrate according to item 7, where the polar component of surface free energy on the substrate surface is in the range of 5 to 15 mJm⁻², and the contact angle is 30 degrees or less.

Item 9. The substrate according to item 7 or 8, where the contact angle on the substrate surface of the liquid crystal material in the isotropic phase is 20 degrees or less.

Item 10. The substrate according to item 7 or 8, where the contact angle on the substrate surface of the liquid crystal material in the isotropic phase is in the range of 5 to 10 degrees.

Item 11. The substrate according to any one of items 7 to 10, where total surface free energy on the substrate surface is 30 mJm⁻² or more.

Item 12. The substrate according to item 7 to 11, where a contact angle with water on the substrate surface is 10 degrees or more.

Item 13. The substrate according to any one of items 7 to 12, where the substrate surface is subjected to silane coupling treatment.

Item 14. The substrate according to any one of items 7 to 13, where the substrate surface is subjected to rubbing treatment.

Item 15. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 1 to 14, and a lattice plane of the blue phase of the liquid crystal material is single.

Item 16. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 1 to 14, and a lattice plane of blue phase I of the liquid crystal material is single.

Item 17. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 1 to 6, and only diffraction from a (110) plane of blue phase I is observed.

Item 18. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 1 to 6, and only diffraction from a (110) plane of blue phase II is observed.

Item 19. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 7 to 14, and the optical diffraction from a (110) plane or (200) plane of blue phase I is observed.

Item 20. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 7 to 14, and only the optical diffraction from a (110) plane of blue phase II is observed.

Item 21. A liquid crystal display element in which a liquid crystal material exhibiting a blue phase is prepared between substrates, and an electric field application means is provided for applying an electric field to a liquid crystal medium through an electrode provided on one or both of the substrates, where at least one of the substrates includes the substrate according to any one of items 1 to 14, only the optical diffraction from a (110) plane of blue phase I is observed, and a wavelength of diffracted light from the (110) plane is in the range of 700 to 1,000 nanometers.

Item 22. The element according to any one of items 15 to 21, where at least one of the substrates includes the substrate according to the liquid crystal material contains a chiral agent in the range of 1 to 40% by weight and an optically inactive liquid crystal material in the range of 60 to 99% by weight in total based on the whole liquid crystal material, and exhibits an optically isotropic liquid crystal phase.

Item 23. The element according to any one of items 15 to 22, where at least one of the substrates includes the substrate according to the liquid crystal material contains a liquid crystal composition including any one of compounds represented by formula (1), or two or more compounds selected from compounds represented by formula (1) as the optically inactive liquid crystal material:

R-(A⁰-Z⁰)n-A⁰-R (1)

where at least one of the substrates includes the substrate according to, in formula (1), A⁰ is independently an aromatic or non-aromatic 3-membered ring to 8-membered ring or a condensed ring having 9 or more carbons, and at least one hydrogen of the rings may be replaced by halogen, or alkyl or halogenated alkyl having 1 to 3 carbons, —CH₂— may be replaced by —O—, —S— or —NH—, and —CH═ may be replaced by —N═; R is independently hydrogen, halogen, —CN, —N═C═O, —N═C═S or alkyl having 1 to 20 carbons, and in the alkyl, arbitrary —CH₂— may be replaced by —O—, —S—, —COO—, —OCO—, —CH═CH—, —CF═CF— or —C≡C—, and arbitrary hydrogen may be replaced by halogen; Z⁰ is independently a single bond or alkylene having 1 to 8 carbons, and arbitrary —CH₂— may be replaced by —O—, —S—, —COO—, —OCO—, —CSO—, —OCS—, —N═N—, —CH═N—, —N═CH—, —N(O)═N—, —N═N(O)—, —CH═CH—, —CF═CF— or —C≡C—, and arbitrary hydrogen may be replaced by halogen; and n is 1 to 5.

Item 24. The element according to item 23, where at least one of the substrates includes the substrate according to the liquid crystal material contains at least one compound selected from the group of compounds represented by each of formula (2) to formula (15):

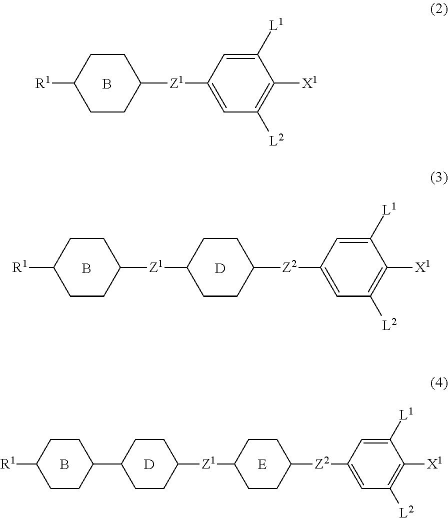

where at least one of the substrates includes the substrate according to, in formula (2) to formula (4), R¹ is alkyl having 1 to 10 carbons, and in the alkyl, arbitrary —CH₂— may be replaced by —O— or —CH═CH—, and arbitrary hydrogen may be replaced by fluorine; X¹ is fluorine, chlorine, —OCF₃, —OCHF₂, —CF₃, —CHF₂, —CH₂F, —OCF₂CHF₂, —OCHF₃ or —OCF₂CHFCF₃; ring B and ring D are independently 1,4-cyclohexylene, 1,3-dioxane-2,5-diyl, or 1,4-phenylene in which arbitrary hydrogen may be replaced by fluorine, ring E is 1,4-cyclohexylene, or 1,4-phenylene in which arbitrary hydrogen may be replaced by fluorine; Z¹ and Z² are independently —(CH₂)₂—, —(CH₂)₄—, —COO—, —C≡C—, —(C≡C)₂—, —(C≡C)₃—, —CF₂O—, —OCF₂—, —CH═CH—, —CH₂O— or a single bond; and L¹ and L² are independently hydrogen or fluorine;

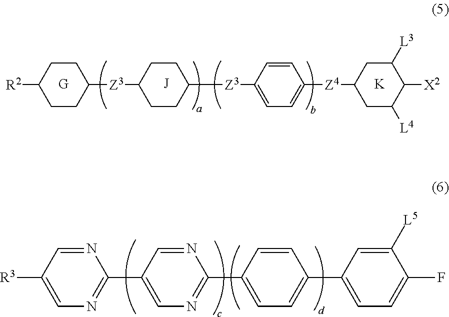

where at least one of the substrates includes the substrate according to, in formula (5) and formula (6), R² and R³ are independently alkyl having 1 to 10 carbons, and in the alkyl, arbitrary —CH₂— may be replaced by —O— or —CH═CH—, and arbitrary hydrogen may be replaced by fluorine; X² is —CN or —C≡C≡CN; ring G is 1,4-cyclohexylene, 1,4-phenylene, 1,3-dioxane-2,5-diyl or pyrimidine-2,5-diyl; ring J is 1,4-cyclohexylene or pyrimidine-2,5-diyl, or 1,4-phenylene in which arbitrary hydrogen may be replaced by fluorine; ring K is 1,4-cyclohexylene, pyrimidine-2,5-diyl, pyridine-2,5-diyl or 1,4-phenylene; Z³ and Z⁴ are —(CH₂)₂—, —COO—, —CF₂O—, —OCF₂—, —C≡C—, —(C≡C)₂—, (C≡C)₃—, —CH═CH—, —CH₂O—, —CH═CH—COO— or a single bond; L³, L⁴ and L⁵ are independently hydrogen or fluorine; and a, b, c and d are independently 0 or 1;

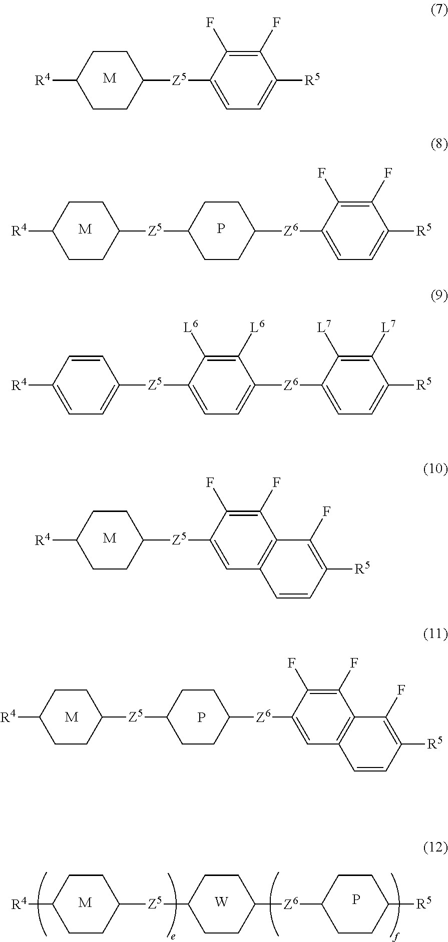

where at least one of the substrates includes the substrate according to, in formula (7) to formula (12), R⁴ and R⁵ are independently alkyl having 1 to 10 carbons, and in the alkyl, arbitrary —CH₂— may be replaced by —O— or —CH═CH—, and arbitrary hydrogen may be replaced by fluorine, or R⁵ may be fluorine; ring M and ring P are independently 1,4-cyclohexylene, 1,4-phenylene, naphthalene-2,6-diyl or octahydronaphthalene-2,6-diyl; Z⁵ and Z⁶ are independently —(CH₂)₂—, —COO—, —CH═CH—, —C≡C—, —(C≡C)₂—, —(C≡C)₃—, —SCH₂CH₂—, —SCO— or a single bond; L⁶ and L⁷ are independently hydrogen or fluorine, at least one of L⁶ and L⁷ is fluorine, ring W is independently W1 to W15 represented below; and, e and f are independently 0, 1 or 2, but e and f are not 0 simultaneously;

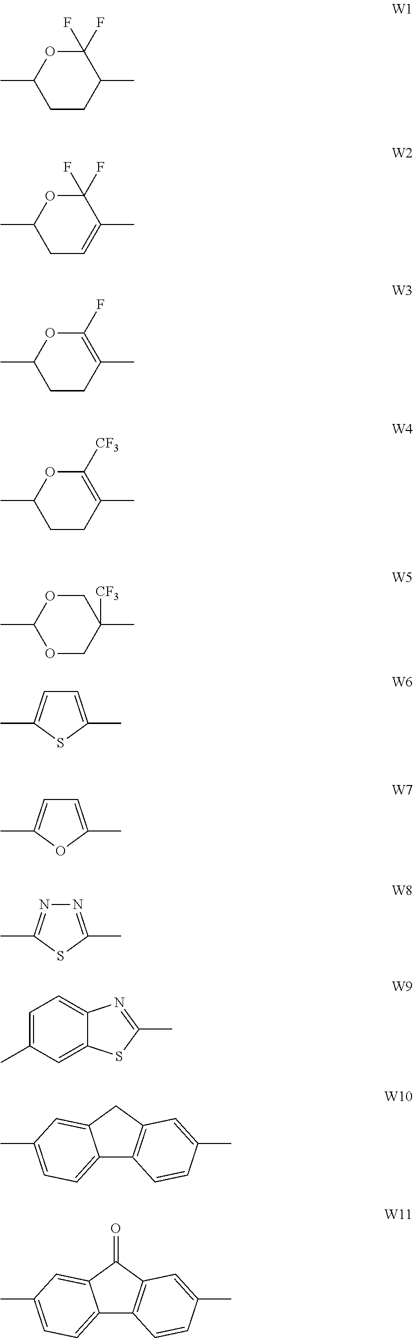

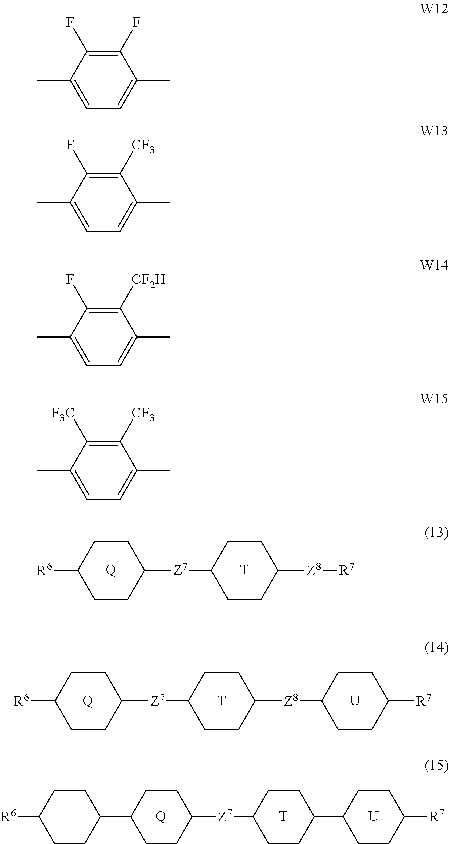

where at least one of the substrates includes the substrate according to, in formula (13) to formula (15), R⁶ and R⁷ are independently hydrogen or alkyl having 1 to 10 carbons, and in the alkyl, arbitrary —CH₂— may be replaced by —O—, —CH═CH— or —C≡C—, and arbitrary hydrogen may be replaced by fluorine; ring Q, ring T and ring U are independently 1,4-cyclohexylene, pyridine-2,5-diyl, pyrimidine-2,5-diyl, or 1,4-phenylene in which arbitrary hydrogen may be replaced by fluorine; and Z⁷ and Z⁸ are independently —C≡C—, —(C≡C)₂—, —(C≡C)₃—, —CH═CH—C≡C—, —C≡C—CH═CH—C≡C—, —C≡C—(CH₂)₂—C≡C—, —CH₂O—, —COO—, —(CH₂)₂—, —CH═CH— or a single bond.

Item 25. The element according to item 24, where at least one of the substrates includes the substrate according to the liquid crystal material further contains at least one compound selected from the group of compounds represented by each of formula (16), formula (17), formula (18) and formula (19):

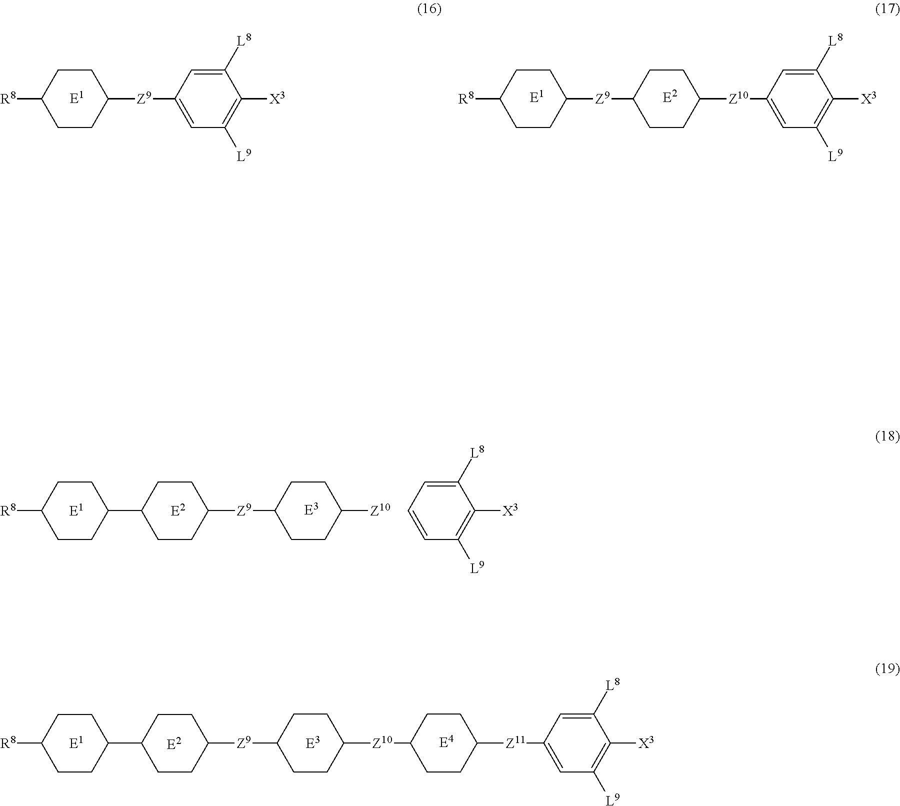

where at least one of the substrates includes the substrate according to, in formula (16) to formula (19), R⁸ is alkyl having 1 to 10 carbons, alkenyl having 2 to 10 carbons or alkynyl having 2 to 10 carbons, and in the alkyl, the alkenyl and the alkynyl, arbitrary hydrogen may be replaced by fluorine, and arbitrary —CH₂— may be replaced by —O—; X³ is fluorine, chlorine, —SF₅, —OCF₃, —OCHF₂, —CF₃, —CHF₂, —CH₂F, —OCF₂CHF₂ or —OCF₂CHFCF₃; ring E¹, ring E², ring E³ and ring E⁴ are independently 1,4-cyclohexylene, 1,3-dioxane-2,5-diyl, pyrimidine-2,5-diyl, tetrahydropyran-2,5-diyl, 1,4-phenylene, naphthalene-2,6-diyl, or 1,4-phenylene in which arbitrary hydrogen is replaced by fluorine or chlorine, or naphthalene-2,6-diyl in which arbitrary hydrogen is replaced by fluorine or chlorine; Z⁹, Z¹⁰ and Z¹¹ are independently —(CH₂)₂—, —(CH₂)₄—, —COO—, —CF₂O—, —OCF₂—, —CH═CH—, —C≡C—, —CH₂O— or a single bond, however, when any one of ring E¹, ring E², ring E³ and ring E⁴ is 3-chloro-5-fluoro-1,4-phenylene, Z⁹, Z¹⁰ and Z¹¹ are not —CF₂O—; and, L⁸ and L⁹ are independently hydrogen or fluorine.

Item 26. The element according to item 24 or 25, where the liquid crystal material further contains at least one compound selected from the group of compounds represented by formula (20):

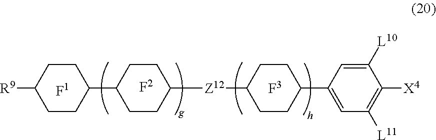

where at least one of the substrates includes the substrate according to, in formula (20), R⁹ is alkyl having 1 to 10 carbons, alkenyl having 2 to 10 carbons or alkynyl having 2 to 10 carbons, and in the alkyl, the alkenyl and the alkynyl, arbitrary hydrogen may be replaced by fluorine, and arbitrary —CH₂— may be replaced by —O—; X⁴ is —C≡N, —N═C═S or —C≡C—C≡N; ring F¹, ring F² and ring F³ are independently 1,4-cyclohexylene or 1,4-phenylene, or 1,4-phenylene in which arbitrary hydrogen is replaced by fluorine or chlorine, naphthalene-2,6-diyl, or naphthalene-2,6-diyl in which arbitrary hydrogen is replaced by fluorine or chlorine, 1,3-dioxane-2,5-diyl, tetrahydropyran-2,5-diyl, or pyrimidine-2,5-diyl; Z¹² is —(CH₂)₂—, —COO—, —CF₂O—, —OCF₂—, —C≡C—, —CH₂O— or a single bond; L¹⁰ and L¹¹ are independently hydrogen or fluorine; and g is 0, 1 or 2, h is 0 or 1, and g+h is 0, 1 or 2.

Item 27. The element according to any one of items 15 to 26, where at least one of the substrates includes the substrate according to the liquid crystal material contains at least one antioxidant and/or ultraviolet absorber.

Item 28. The where at least one of the substrates includes the substrate according to according to any one of items 15 to 27, where at least one of the substrates includes the substrate according to the liquid crystal material contains the chiral agent in the range of 1 to 20% by weight based on the whole liquid crystal material.

Item 29. The element according to any one of items 15 to 27, where at least one of the substrates includes the substrate according to the liquid crystal material contains the chiral agent in the range of 1 to 10% by weight based on the whole liquid crystal material.

Item 30. The element according to item 28 or 29, where at least one of the substrates includes the substrate according to the chiral agent contains at least one kind of compounds represented by any one of the following formula (K1) to formula

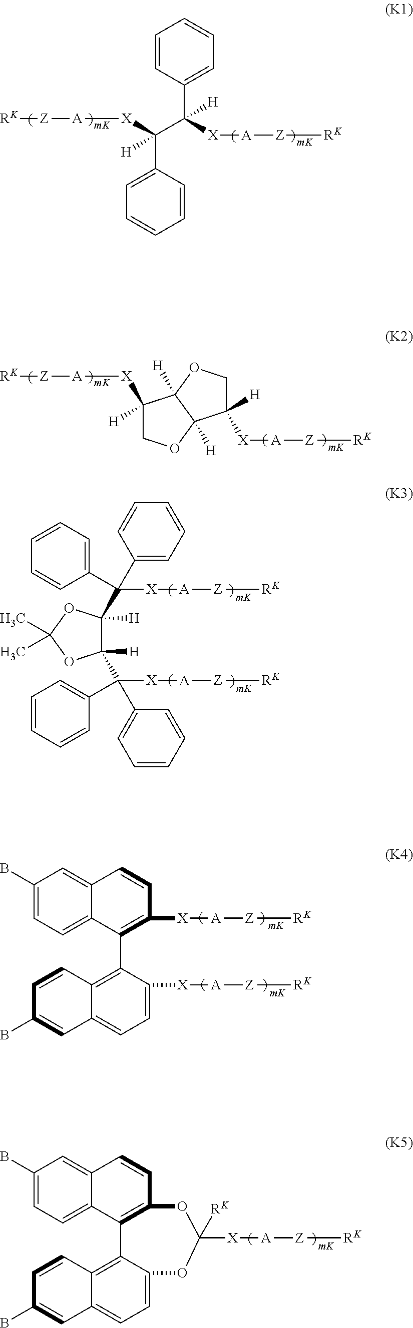

where, in formula (K1) to formula (KS), R^{K} is each independently hydrogen, halogen, —CN, —N═C═O, —N═C═S or alkyl having 1 to 20 carbons, and in the alkyl, arbitrary —CH₂— may be replaced by —O—, —S—, —COO—, —OCO—, —CH═CH—, —CF═CF— or —C≡C—, and arbitrary hydrogen may be replaced by halogen; A is each independently an aromatic or non-aromatic 3-membered ring to 8-membered ring or a condensed ring having 9 or more carbons, and in the rings, arbitrary hydrogen may be replaced by halogen, or alkyl or haloalkyl having 1 to 3 carbons, CH₂— may be replaced by —O—, —S— or —NH—, and CH═ may be replaced by —N═; B is independently hydrogen, halogen, alkyl having 1 to 3 carbons, haloalkyl having 1 to 3 carbons, an aromatic or non-aromatic 3-membered ring to 8-membered ring or a condensed ring having 9 or more carbons, and in the rings, arbitrary hydrogen may be replaced by halogen, or alkyl or haloalkyl having 1 to 3 carbons, —CH₂— may be replaced by —O—, —S— or —NH—, and —CH═ may be replaced by —N═; Z is each independently a single bond or alkylene having 1 to 8 carbons, and in the alkylene, arbitrary —CH₂— may be replaced by —O—, —S—, —COO—, —OCO—, —CSO—, —OCS—, —N═N—, —CH═N—, —N═CH—, —N(O)═N—, —N═N(O)—, —CH═CH—, —CF═CF— or —C≡C—, and arbitrary hydrogen may be replaced by halogen; X is a single bond, —COO—, —CH₂O—, —CF₂O— or —CH₂CH₂—; and mK is an integer of 1 to 4.

Item 31. The element according to any one of items 28 to 30, where the chiral agent is included at least one kind of compounds represented by any one of the following formula (K2-1) to formula (K2-8) and formula (K5-1) to formula (K5-3):

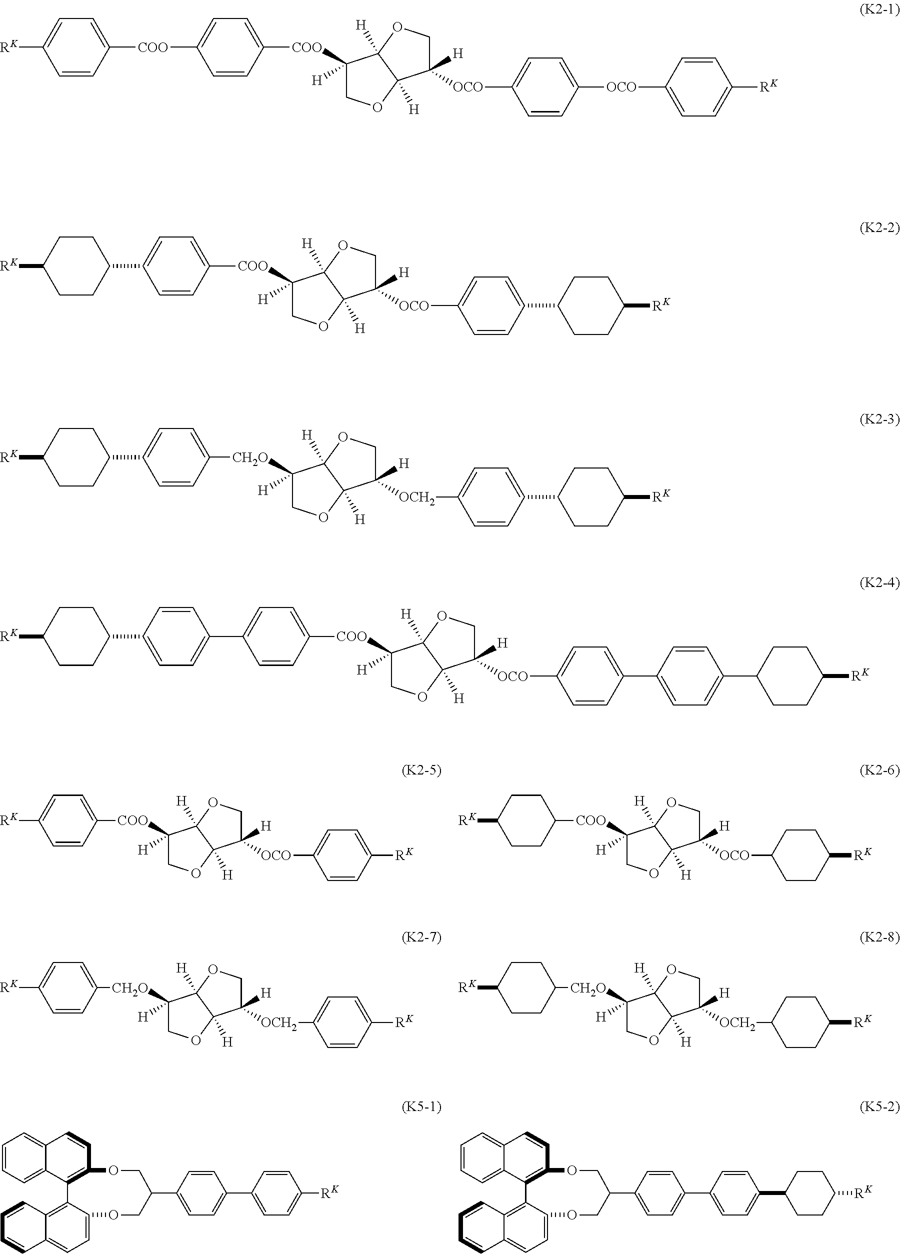

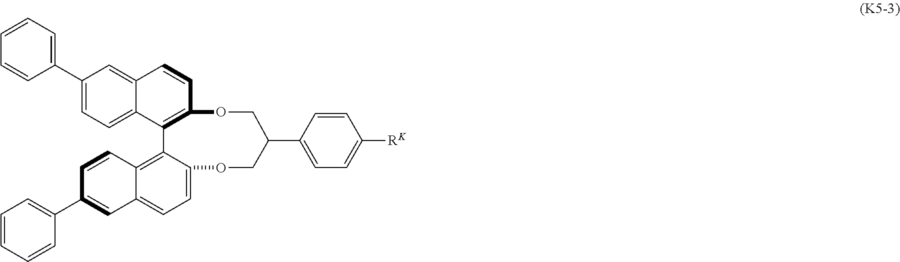

where, in formula (K2-1) to formula (K2-8) and formula (K5-1) to formula (K5-3), R^{K} is independently alkyl having 3 to 10 carbons, and —CH₂— adjacent to a ring in the alkyl may be replaced by —O—, and in the alkyl, arbitrary —CH₂— may be replaced by —CH═CH—.

Item 32. The element according to any one of items 15 to 31, where the liquid crystal material exhibit a chiral nematic phase at temperature in the range of 70° C. to −20° C., and a helical pitch is 700 nanometers or less at least in a part of the temperature range.

Item 33. The element according to any one of items 15 to 32, where the liquid crystal material further contains a polymerizable monomer.

Item 34. The element according to item 33, where the polymerizable monomer is a photopolymerizable monomer or a thermally polymerizable monomer.

Item 35. The element according to any one of items 15 to 32, where the liquid crystal material is a polymer/liquid crystal composite material.

Item 36. The element according to item 35, where the polymer/liquid crystal composite material is obtained by polymerizing a polymerizable monomer in the liquid crystal material.

Item 37. The element according to item 35, where the polymer/liquid crystal composite material is obtained by polymerizing a polymerizable monomer in the liquid crystal material in a non-liquid crystal isotropic phase or the optically isotropic liquid crystal phase.

Item 38. The element according to any one of items 35 to 37, where a polymer contained in the polymer/liquid crystal composite material has a mesogen moiety.

Item 39. The element according to any one of items 35 to 38, where the polymer contained in the polymer/liquid crystal composite material has cross-linked structure.

Item 40. The element according to any one of items 35 to 39, where the polymer/liquid crystal composite material contains the liquid crystal composition in the range of 60 to 99% by weight, and the polymer in the range of 1 to 40% by weight.

Item 41. The element according to any one of items 15 to 40, where at least one substrate is transparent and a polarizer is arranged outside the substrate.

Item 42. The element according to any one of items 15 to 41, where the electric field application means can apply the electric field at least in two directions.

Item 43. The element according to any one of items 15 to 42, where the substrates are arranged in parallel to each other.

Item 44. The element according to any one of items 15 to 43, where the electrode is a pixel electrode arranged in a matrix, each pixel includes an active element, and the active element is a thin film transistor (TFT).

Item 45. A polyimide resin thin film, used for the substrate according to any one of items 1 to 5.

Item 46. A polyimide resin thin film, used for the substrate according to any one of items 7 to 12.

Item 47. The polyimide resin thin film according to item 46, obtained from diamine A having side chain structure, diamine B having no side chain structure, alicyclic tetracarboxylic dianhydride C and aromatic tetracarboxylic dianhydride D.

Item 48. The polyimide resin thin film according to item 47, where diamine A having side chain structure is at least one compound selected from compounds represented by the following formula DA-a1 to formula DA-a3, diamine B having no side chain structure is a compound represented by the following formula DA-b1, alicyclic tetracarboxylic dianhydride C is a compound represented by the following formula AA-c1, and aromatic tetracarboxylic dianhydride D is a compound represented by formula AA-d1:

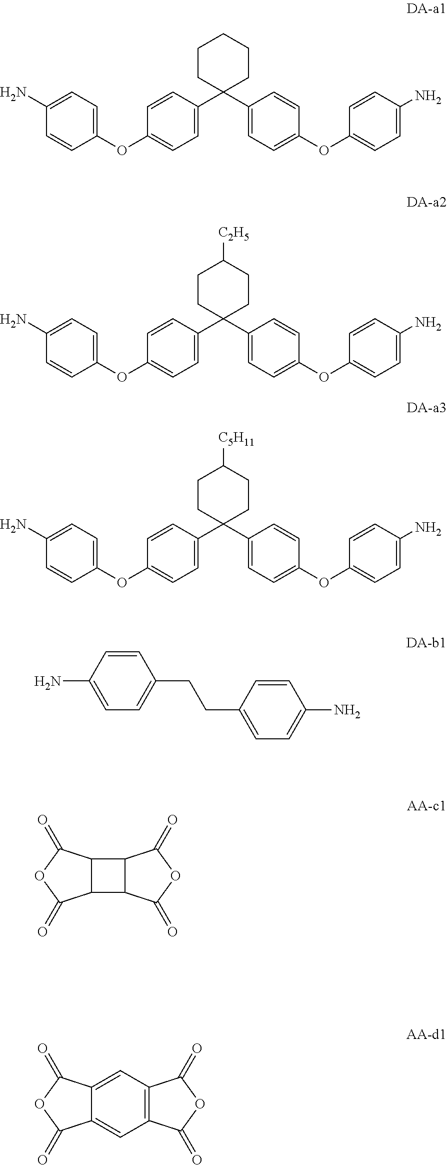

Item 49. An organosilane thin film, used for the substrate according to any one of items 7 to 12.

In the present specification, “liquid crystal compound” is used as a generic term for a compound having a liquid crystal phase such as a nematic phase and a smectic phase, and a compound having no liquid crystal phase but being useful as a component of a liquid crystal composition. In the specification, “chiral agent” is an optically active compound, and is added in order to give a desired twisted molecular arrangement to the liquid crystal composition. In the specification, “chirality” means strength of a twist induced to the liquid crystal composition by the chiral agent, and is represented by a reciprocal number of a pitch. In the specification, “liquid crystal display element” is used as a generic term for a liquid crystal display panel, a liquid crystal display module and so forth. “Liquid crystal compound,” “liquid crystal composition,” and “liquid crystal display element” may be abbreviated as “compound,” “composition,” and “element,” respectively.

In the specification, a compound represented by formula (1) may be abbreviated as compound (1). The abbreviation may also apply to a compound represented by formula (2) and so forth. In formula (1) to formula (19), symbols such as B, D and E surrounded by a hexagonal shape correspond to rings such as ring B, ring D and ring E, respectively. The amount of the compound expressed by means of “percent” means weight percent (% by weight) based on the total weight of the composition. A plurality of identical symbols such as ring A¹, Y¹ and B are described in identical or different formulas, and the symbols may be identical or different.

In the specification, “arbitrary” represents any of not only positions but also numbers without including the case where the number is zero (0). An expression “arbitrary A may be replaced by B, C or D” includes the case where arbitrary A is replaced by B, the case where arbitrary A is replaced by C, and the case where arbitrary A is replaced by D, and also the case where a plurality of A are replaced by at least two of B to D. For example, an expression “alkyl in which arbitrary —CH₂— may be replaced by —O— or —CH═CH—” includes alkyl, alkenyl, alkoxy, alkoxyalkyl, alkoxyalkenyl and alkenyloxyalkyl. Incidentally, according to the invention, it is not preferred that two successive —CH₂— are replaced by —O— to form —O—O— or the like. Then it is not preferred either that a terminal —CH₂— in alkyl is replaced by —O—.

### Advantageous Effects of the Invention

According to a preferred embodiment of the invention, a plural optical diffraction originating from circular polarized light resulting from structure of a blue phase can be controlled on a substrate in contact with liquid crystals.

According to a preferred embodiment of the invention, a colorless blue phase having a low drive voltage is exhibited by controlling chirality of a blue phase in which a specific lattice plane is directed in parallel to a substrate used for a liquid crystal element, and allowing Bragg diffraction light from the blue phase to shift outside a visible range.

According to a liquid crystal display element of a preferred embodiment of the invention, the element can be used in a wide temperature range, and a short response time, a large contrast and a low drive voltage can be achieved.

### BRIEF DESCRIPTION OF DRAWINGS

FIG. 1 is a diagram showing a comb electrode used for a substrate of the invention.

FIG. 2 is a diagram showing an optical system in which a substrate of the invention is used.

FIG. 3A shows images obtained by photographing optical textures of cell PA1 to cell PF1.

FIG. 3B shows images obtained by photographing optical textures of cell SA1 to cell SF1.

FIG. 4A shows images obtained by photographing optical textures of cell PA1 to cell PF1.

FIG. 4B shows images obtained by photographing optical textures of cell SA1 to cell SF1.

FIG. 5A is a graph showing a relationship between total surface free energy of substrate PA1 to substrate PF1 and substrate SA1 to substrate SF1 and a lattice plane ratio (lattice plane 110) of liquid crystal composition Y.

FIG. 5B is a graph showing a relationship between surface free energy (γ^{d}) of substrate PA1 to substrate PF1 and substrate SA1 to substrate SF1 and a lattice plane ratio (lattice plane 110) of liquid crystal composition Y.

FIG. 5C is a graph showing a relationship between surface free energy (γ^{p}) of substrate PA1 to substrate PF1 and substrate SA1 to substrate SF1 and a lattice plane ratio (lattice plane 110) of liquid crystal composition Y.

FIG. 6 is a graph showing a relationship between a contact angle to liquid crystal composition Y in substrate PB1 to substrate PF1 and substrate SA1 to substrate SC1 and a lattice plane ratio (lattice plane 110) of liquid crystal composition Y.

FIG. 7 is a graph showing a relationship between total surface free energy of substrate PA1 to substrate PF1 and substrate SA1 to substrate SF1 and a lattice plane ratio (lattice plane 110) of liquid crystal composition Y.

FIG. 8 is a graph showing a relationship between total surface free energy (γ^{T}) of substrate PA1 to substrate PF1 and substrate SA1 to substrate SF1 and a lattice plane ratio (lattice plane 110) of liquid crystal composition Y.

FIG. 9 is a graph showing a relationship between a contact angle to liquid crystal composition Y in substrate PB1 to substrate PF1 and substrate SA1 to substrate SC1 and a lattice plane ratio (lattice plane 200) of liquid crystal composition Y.

FIG. 10 shows images obtained by photographing optical textures of the comb electrode cells according to Examples 13 to 15.

FIG. 11 is a diagram showing VT properties of the comb electrode cells according to Examples 14 and 15.

### DESCRIPTION OF EMBODIMENTS

A liquid crystal display element, a substrate used for the element and so forth of the invention will be explained in detail below.

Generally, surface free energy on the substrate is classified into orientation force, induction force, dispersion force and hydrogen bonding force based on intermolecular force. In the specification, unless otherwise noted, total surface free energy of the substrate is referred to as γ^{T}, a polar component of surface free energy as γ^{p}, and a dispersion component of total surface free energy as γ^{d}. The values are calculated from a contact angle on a substrate surface at 60° C.

A blue phase exhibited in the substrate means a liquid crystal phase that an optically isotropic liquid crystal composition sandwiched and held between two substrates with predetermined surface treatment or untreated glass substrates.

A lattice plane ratio means a value obtained by calculating a lattice plane (for example, lattice plane 110) of the blue phase observed with a polarizing microscope from an occupancy rate in an observation region.

### 1. Substrate of the Invention

The substrate of the invention is used for an optical element, particularly, a liquid crystal display element, and has predetermined surface free energy.

Specifically, a first embodiment of the invention refers to a substrate used for a liquid crystal display element having two or more substrates arranged oppositely to each other and a liquid crystal material exhibiting a blue phase between the substrates, in which polar component (γ^{p}) of surface free energy on a substrate surface in contact with the liquid crystal material is less than 5 mJm⁻². In the substrate according to the first embodiment of the invention, the polar component (γ^{p}) of surface free energy on the substrate surface is preferably 3.0 mJm⁻² or less, further preferably, 1.5 mJm⁻² or less, particularly preferably, 1.0 mJm−2 or less. A (110) plane of blue phase I is easily aligned by using such a substrate.

A second embodiment of the invention refers to a substrate used for a liquid crystal display element having two or more substrates arranged oppositely to each other and a liquid crystal material exhibiting a blue phase between the substrates, in which polar component (γ^{p}) of surface free energy on a substrate surface in contact with the liquid crystal material is in the range of 5 to 20 mJm−2. In the substrate according to the second embodiment of the invention, the polar component (γ^{p}) of surface free energy on the substrate surface is preferably 7.0 mJm⁻² or more, further preferably, 9.0 mJm⁻² or more, particularly preferably, 10.0 mJm−2 or more. Herein, when a contact angle on the substrate surface of the liquid crystal material having an isotropic phase is in the range of 20 degrees to 50 degrees, a plane other than a (110) plane of blue phase I is easily aligned by using such a substrate.

Moreover, when the contact angle on the substrate surface of the liquid crystal material having the isotropic phase is 8 degrees or less in the substrate according to the second embodiment of the invention, the (110) plane of blue phase I is easily aligned by using such a substrate. In order to easily align the (110) plane of blue phase I in the substrate according to the second embodiment of the invention, the contact angle on the substrate surface of the liquid crystal material having the isotropic phase is preferably 8.0 degrees or less, further preferably, 5.0 degrees or less, particularly preferably, 3.0 degrees or less.

In the substrate of the invention, when substrates having an identical value of γ^{d} on the substrate surface are compared with each other, a lattice plane (110) ratio becomes higher as a solid surface substrate having a lower value of γ^{p} is applied, and therefore a blue phase of a single color is more easily exhibited when a liquid crystal element using a substrate having a lower value of γ^{p} on the substrate surface is applied.

Magnitude of chirality in the liquid crystal material of the invention is not particularly limited. A smaller chirality of the liquid crystal material is preferred upon reducing driving voltage.

If a substrate has a predetermined value of surface free energy, the substrate of the invention is not limited in particular and the form may have form of curved surface without limiting it in flat form.

Moreover, a material of the substrate that can be used in the invention is not particularly limited. Specific examples include glass, a plastic film of a polyester resin such as polyethylene terephthalate (PET) and polybutyrene terephthalate (PBT), a polyolefin resin such as polyethylene and polypropylene, polyvinyl chloride, a fluorocarbon resin, an acrylic resin, polyamide, polycarbonate and polyimide, cellophane, acetate, metal foil, a laminated film of polyimide and metal foil, glassine paper or parchment paper having a sealing effect, and paper subjected to sealing treatment by polyethylene, a clay binder, polyvinyl alcohol, starch or carboxymethyl cellulose (CMC). In addition, an additive such as a pigment, a dye, an antioxidant, an antidegradant, a filler, an ultraviolet absorber, an antistatic agent and/or an electromagnetic wave preventative may also be contained in a substance constituting the substrate within the range where advantageous effects of the invention are not adversely affected.

Thickness of the substrate is not particularly limited, but ordinarily in the range of about 10 micrometers to about 2 millimeters, and appropriately adjusted depending on the purpose for using the substrate. The thickness is preferably in the range of 15 micrometers to 1.2 millimeters, further preferably, in the range of 20 micrometers to 0.8 millimeter.

A thin film is preferably provided on the substrate surface, particularly on the substrate surface in contact with the liquid crystal material. A type of the thin film provided on the substrate is not particularly limited. Specific examples of preferred thin films include a polyimide resin thin film and an organosilane thin film.

### 1.1 Polyimide Resin Thin Film

The polyimide resin thin film includes a polyimide obtained from a diamine and an acid anhydride. A preferred diamine is at least one diamine selected from diamine A and diamine B, and a preferred acid anhydride is at least one acid anhydride selected from acid anhydride C and acid anhydride D, for example. Herein, diamine A is a diamine having side chain structure, and diamine B is a diamine having no side chain structure, acid anhydride C is an alicyclic tetracarboxylic dianhydride, and acid anhydride D is an aromatic tetracarboxylic dianhydride.

“Diamine” and “tetracarboxylic dianhydride” being raw materials of a polymer contained in the polyimide resin thin film of the invention will be explained in order.

### 1.1.1 Diamine

Examples of diamines used for the polyimide resin thin film of the invention include compounds represented by formula (III-1) to formula (III-7). The diamine may be used alone by selecting one from the diamines, or may be used by selecting two or more from the diamines and being mixed, or may be used by mixing at least one selected from the diamines with any other diamine (diamine other than compound (III-1) to compound (III-7)):

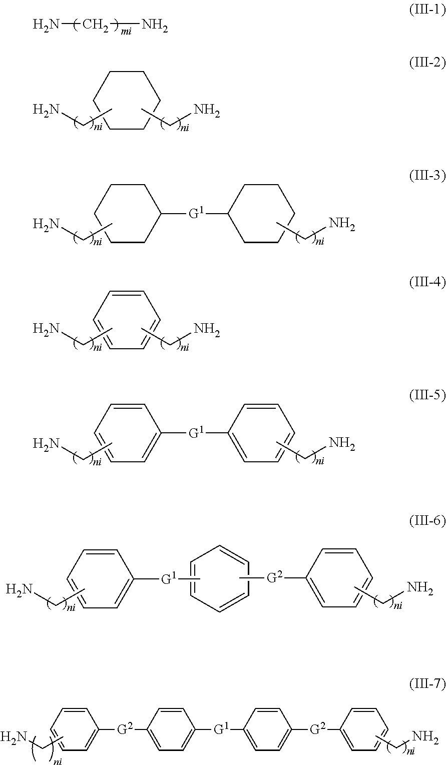

where, in the formula (III-1) to formula (III-7) above, “mi” is independently an integer of 1 to 12, and “ni” is independently an integer of 0 to 2; G¹ is independently a single bond, —O—, —S—, —S—S—, —SO₂—, —CO—, —CONH—, —NHCO—, —C(CH₃)₂—, —C(CF₃)₂—, —(CH₂)ₚ—, —O—(CH₂)ₚ—O— or —S—(CH₂)ₚ—S—, the p is independently an integer of 1 to 12; G² is independently a single bond, —O—, —S—, —CO—, —C(CH₃)₂—, —C(CF₃)₂— or alkylene having 1 to 10 carbons; arbitrary —H of a cyclohexane ring and a benzene ring in the formula may be replaced by —F, —OH, —CF₃, —CH₃ or benzyl; and a bonding position of —NH₂ to the cyclohexane ring or the benzene ring is an arbitrary position except for a bonding position of G¹ or G².

Examples of compound (III-1) to compound (III-3) are shown below.

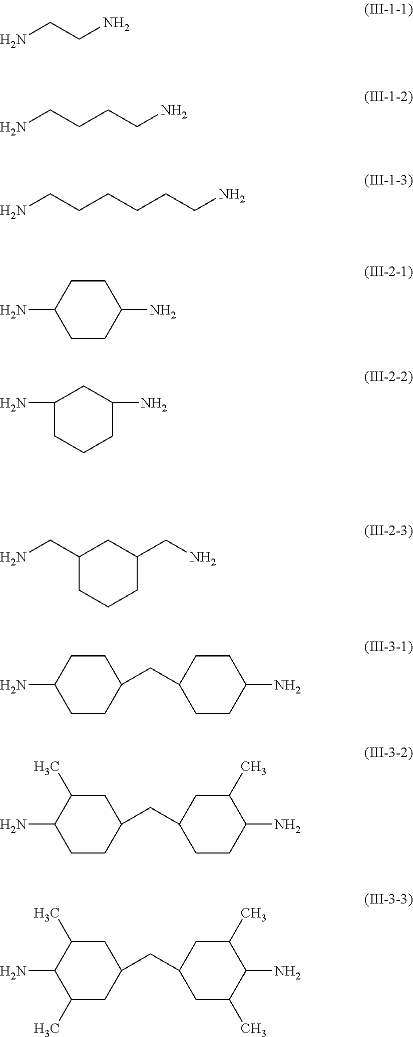

Examples of compound (III-4) are shown below.

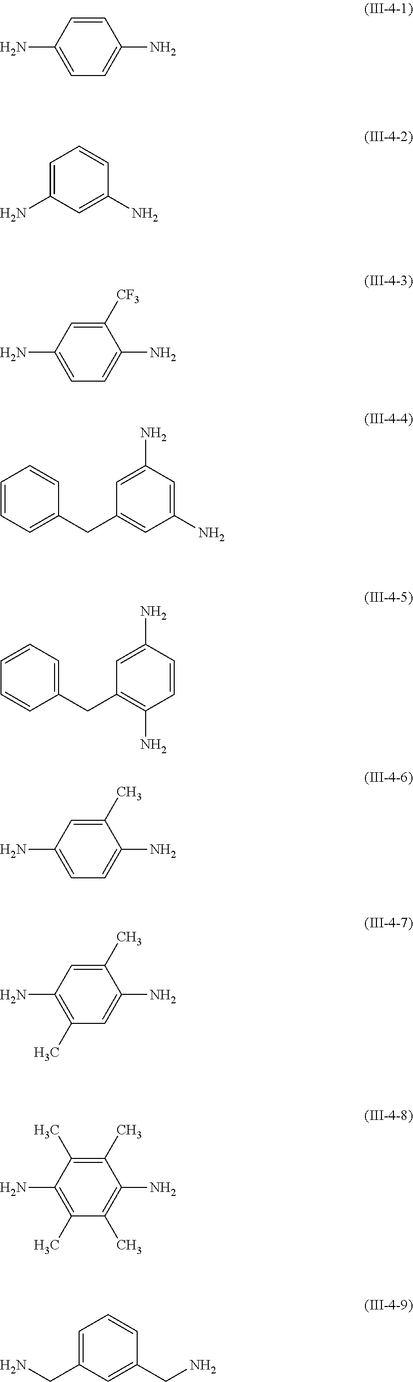

Examples of compound (III-5) are shown below.

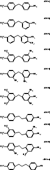

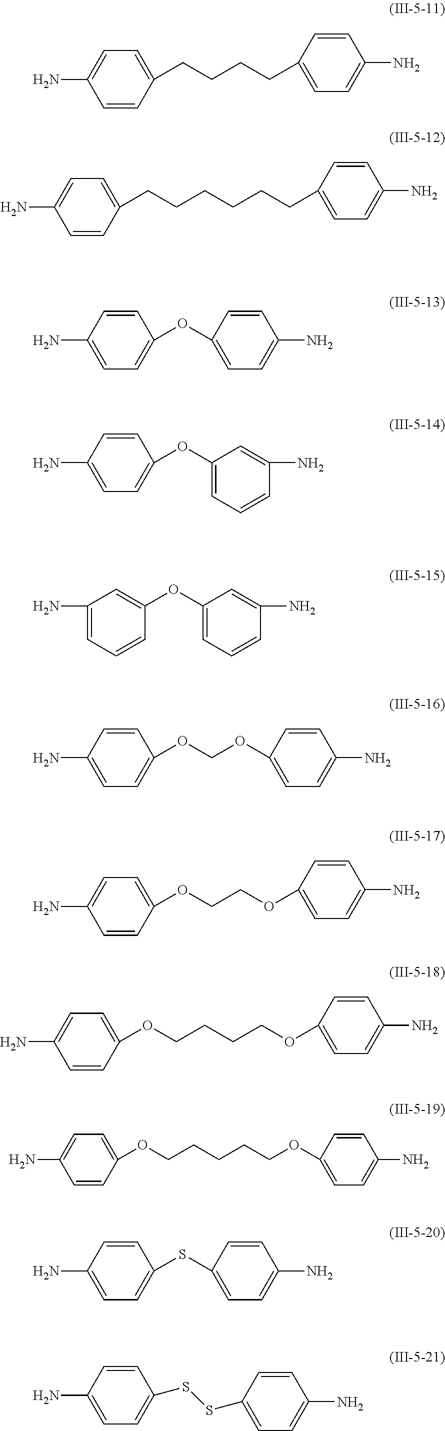

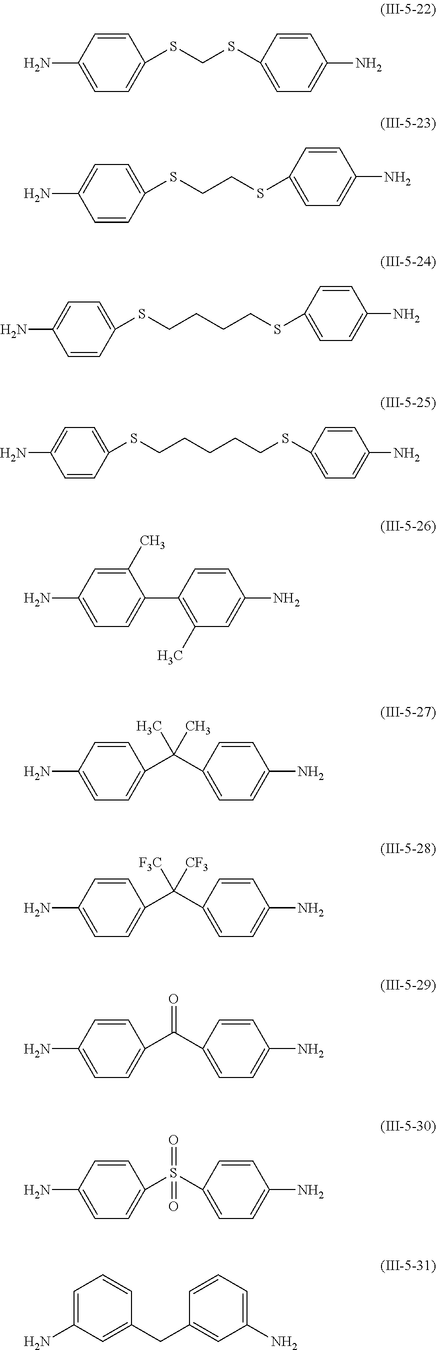

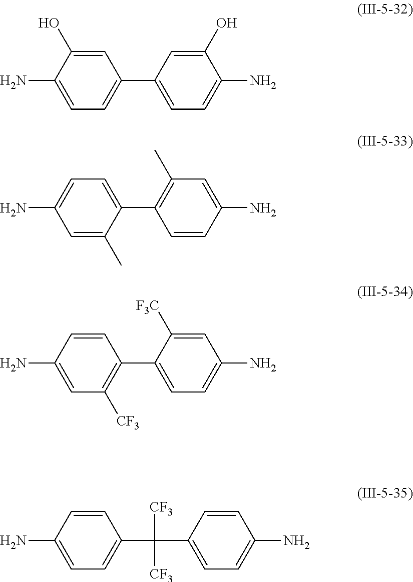

Examples of compound (III-6) are shown below.

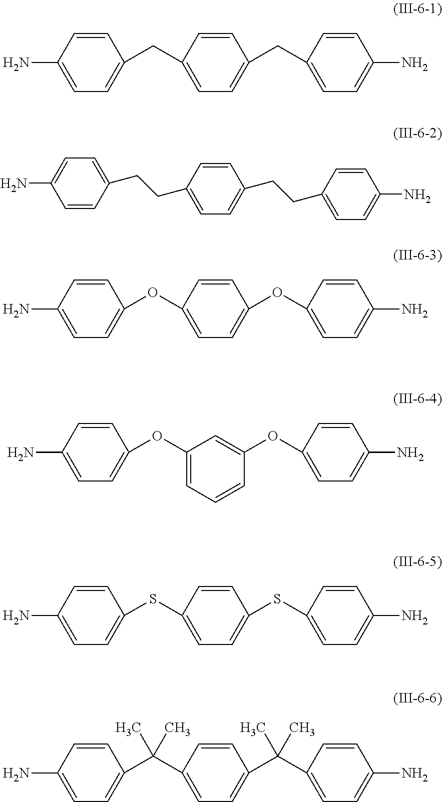 [SMILES: Nc1ccc(Cc2ccc(Cc3ccc(N)cc3)cc2)cc1 ; Nc1ccc(CCc2ccc(CCc3ccc(N)cc3)cc2)cc1 ; Nc1ccc(Oc2ccc(Oc3ccc(N)cc3)cc2)cc1 ; Nc1ccc(Oc2cccc(Oc3ccc(N)cc3)c2)cc1 ; Nc1ccc(Sc2ccc(Sc3ccc(N)cc3)cc2)cc1 ; CC(C)(c1ccc(N)cc1)c1ccc(C(C)(C)c2ccc(N)cc2)cc1]

Examples of compound (III-7) are shown below.

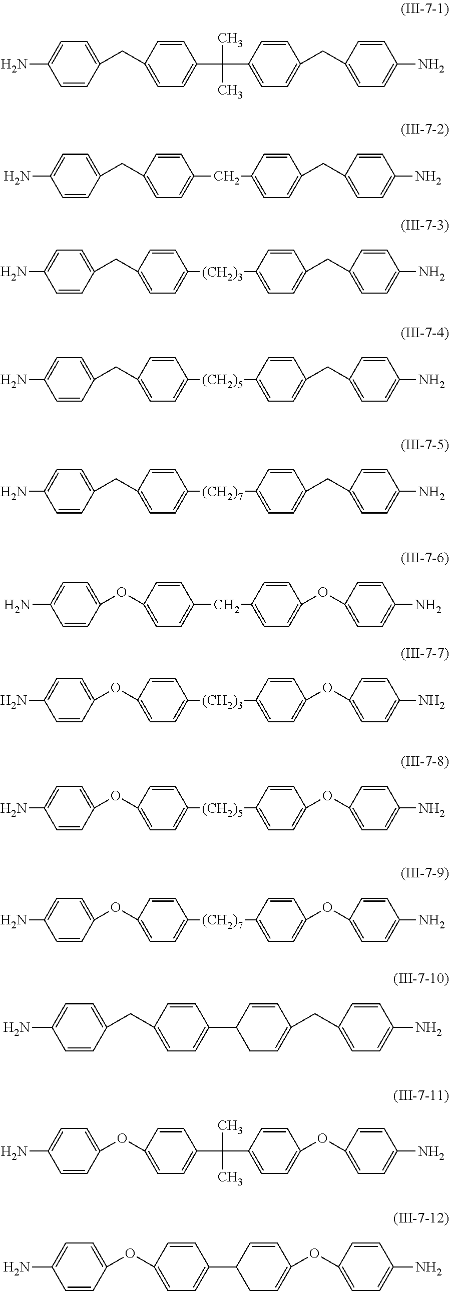

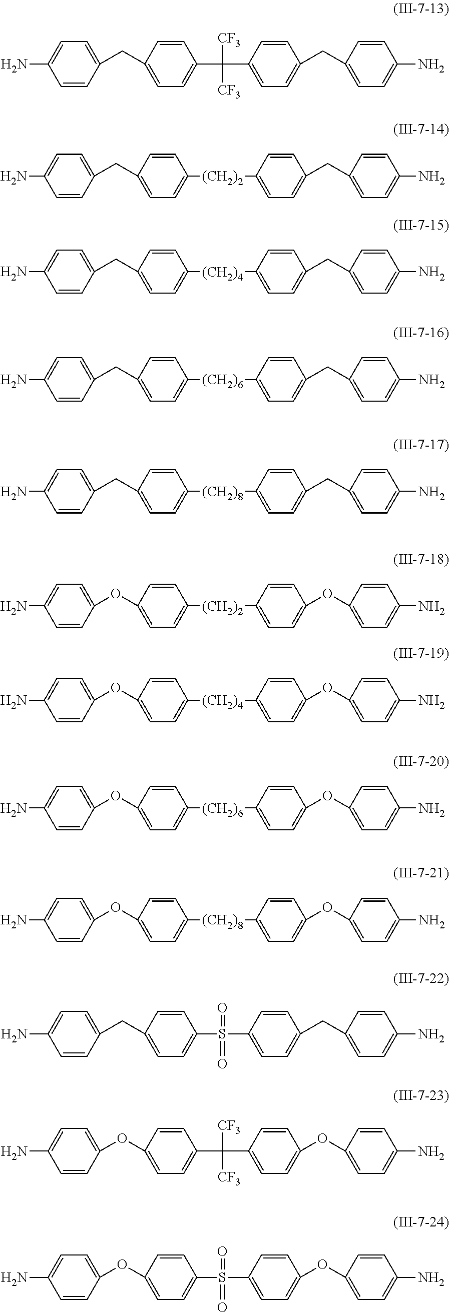

Among the specific examples relating to compound (III-1) to compound (III-7), further preferred examples include compounds represented by formulas (III-2-3), (III-4-1) to (III-4-5), (III-4-9), (III-5-1) to (III-5-12), (III-5-26), (III-5-27), (III-5-31) to (III-5-35), (III-6-1), (III-6-2), (III-6-6), (III-7-1) to (III-7-5) and (III-7-15) to (III-7-16), particularly preferred examples include compounds represented by formulas (III-2-3), (III-4-1) to (III-4-5), (III-4-9), (III-5-1) to (III-5-12), (III-5-31) to (III-5-35) and (III-7-3).

When using compound (III-1) to compound (III-7) in the invention, a ratio of compound (III-1) to compound (III-7) based on the total amount of diamine to be used is adjusted according to structure, and a desired voltage holding ratio and a residual DC reduction effect of a selected diamine. A preferred ratio is in the range of 20 to 100 mol %, a further preferred ratio is in the range of 50 to 100 mol %, a still further preferred ratio is in the range of 70 to 100 mol %.

Another example of a preferred diamine is the diamine having side chain structure. In addition, according to the specification, the diamine having side chain structure means a diamine having a substituent positioned laterally to a main chain, when a chain bonding two amino groups is defined as the main chain. More specifically, the diamine having side chain structure reacts with the tetracarboxylic dianhydride, and thus a polyamic acid, a polyamic acid derivative or a polyimide having a substituent positioned laterally to the polymer main chain (a branchedpolyamic acid, branched polyamic acid derivative or branched polyimide) can be provided.

Accordingly, a lateral substituent in the diamine having side chain structure may be appropriately selected according to required surface free energy. Specific examples of the lateral substituents preferably include a group having 3 or more carbons.

### Specific Examples Include

1) phenyl that may have a substituent, cyclohexyl that may have a substituent, cyclohexylphenyl that may have a substituent, bi(cyclohexyl)phenyl that may have a substituent, or alkyl, alkenyl or alkynyl having 3 or more carbons;

2) phenyloxy that may have a substituent, cyclohexyloxy that may have a substituent, bi(cyclohexyl)oxy that may have a substituent, phenylcyclohexyloxy that may have a substituent, cyclohexylphenyloxy that may have a substituent, or alkyloxy, alkenyloxy or alkynyloxy having 3 or more carbons;

3) phenylcarbonyl, or alkylcarbonyl, alkenyl carbonyl or alkynyl carbonyl having 3 or more carbons;

4) phenylcarbonyloxy, or alkylcarbonyloxy, alkenylcarbonyloxy or alkynylcarbonyloxy having 3 or more carbons;

5) phenyloxycarbonyl that may have a substituent, cyclohexyloxycarbonyl that may have a substituent, bicyclohexyloxycarbonyl that may have a substituent, bicyclohexylphenyloxycarbonyl that may have a substituent, cyclohexylbiphenyloxycarbonyl that may have a substituent, or alkyloxycarbonyl, alkenyloxycarbonyl or alkynyloxycarbonyl having 3 or more carbons;

6) phenylaminocarbonyl, or alkylaminocarbonyl, alkenylaminocarbonyl or alkynylaminocarbonyl having 3 or more carbons;

7) cycloalkyl having 3 or more carbons;

8) cyclohexylalkyl that may have a substituent, phenylalkyl that may have a substituent, bicyclohexylalkyl that may have a substituent, cyclohexylphenylalkyl that may have a substituent, bicyclohexylphenylalkyl that may have a substituent, phenylalkyloxy that may have a substituent, alkylphenyloxycarbonyl or alkyl biphenylyloxycarbonyl;

9) a group having two or more rings or a group having a steroid skeleton in which a benzene ring that may have a substituent and/or a cyclohexane ring that may have a substituent are bonded through a single bond, —O—, —COO—, —OCO—, —CONH— or alkylene having 1 to 3 carbons. However, the lateral substituent is not limited thereto.

Specific examples of the substituents include alkyl, fluorine-substituted alkyl, alkoxy and alkoxyalkyl. In addition, in the specification, “alkyl” used without particular explanation indicates both straight-chain alkyl and branched chain alkyl without preference. A same rule applies to “alkenyl” and “alkynyl.” In order to align the lattice plane (110) of the blue phase, the substituent is preferably alkyl and fluorine-substituted alkyl.

Preferred examples of the diamine having side chain structure include a compound selected from the group of compounds represented by each of formula (III-8) to formula (III-12):

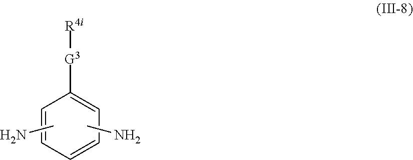

Definitions of symbols in formula (III-8) are as described below. G³ is a single bond, —O—, —COO—, —OCO—, —CONH— or —(CH₂)ₘₕ—, and mh is an integer of 1 to 12. R⁴ⁱ is alkyl having 3 to 20 carbons or phenyl, a group having a steroid skeleton, or a group represented by the following formula (III-8-a). In the alkyl, arbitrary —H may be replaced by —F, and arbitrary —CH₂— may be replaced by —O—, —CH═CH— or —C≡C—. Then, —H in the phenyl may be replaced by —F, —CH₃, —OCH₃, —OCH₂F, —OCHF₂, —OCF₃, alkyl having 3 to 20 carbons or alkoxy having 3 to 20 carbons; —H of the cyclohexyl may be replaced by alkyl having 3 to 20 carbons or alkoxy having 3 to 20 carbons. A bonding position of NH₂ to a benzene ring is arbitrary, but a bonding position relationship between two of NH₂ is preferably meta or para. More specifically, when a bonding position of a “R⁴ⁱ-G³-” group is defined as position 1, two of NH₂ are preferably bonded to position 3 and position 5, or position 2 and position 5, respectively.

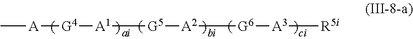

where, in formula (III-8-a), R⁵ⁱ is —H, —F, alkyl having 1 to 20 carbons, fluorine-substituted alkyl having 1 to 20 carbons, alkoxy having 1 to 20 carbons, —CN, —OCH₂F, —OCHF₂ or —OCF₃; G⁴, G⁵ and G⁶ are bonding groups, and the bonding groups are independently a single bond or alkylene having 1 to 12 carbons; at least one of —CH₂— in the alkylene may be replaced by —O—, —COO—, —OCO—, —CONH— or —CH═CH—; A, A¹, A² and A³ are rings, and the rings are independently 1,4-phenylene, 1,4-cyclohexylene, 1,3-dioxane-2,5-diyl, pyrimidine-2,5-diyl, pyridine-2,5-diyl, naphthalene-1,5-diyl, naphthalene-2,7-diyl or anthracene-9,10-diyl; and in A, A¹, A² and A³, arbitrary —H may be replaced by —F or —CH₃; ai, bi and ci are independently an integer of 0 to 2, a sum thereof is 1 to 5; and when ai, bi or ci is 2, two bonding groups in each parenthesis may be identical or different, and two rings may be identical or different.

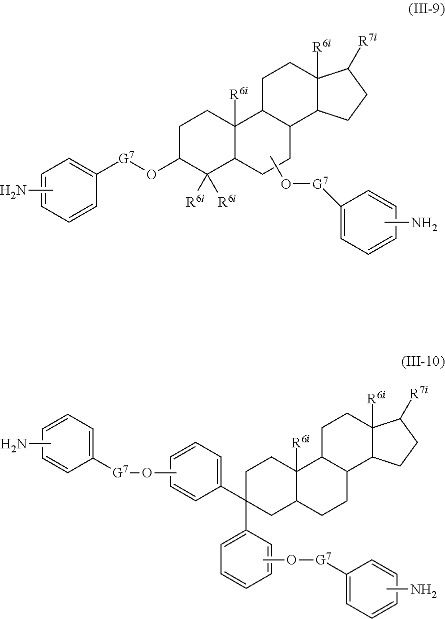

Definitions of symbols in formula (III-9) and formula (III-10) are as described below. R⁶ⁱ is independently —H or —CH₃. R⁷ⁱ is independently —H, alkyl having 1 to 20 carbons or alkenyl having 2 to 20 carbons. G⁷ is independently a single bond, —CO— or —CH₂—. One of —H of a benzene ring in formula (III-10) may be replaced by alkyl having 1 to 20 carbons or phenyl. Then, a group in a bonding position being not fixed to any one of carbon atoms constituting a ring indicates that the bonding position in the ring is arbitrary. One of two “NH₂-phenylene-G⁷-O—” groups in formula (III-9) is preferably bonded to position 3 of a steroid nucleus, and the other is preferably bonded to position 6 of the steroid nucleus. Bonding positions of two “NH₂-phenylene-G⁷-O—” groups to a benzene ring in formula (III-10) is preferably a meta position or a para position relative to a bonding position of the steroid nucleus, respectively. In formula (III-9) and formula (III-10), a bonding position of NH₂ to a benzene ring is preferably a meta position or a para position relative to a bonding position of G⁷.

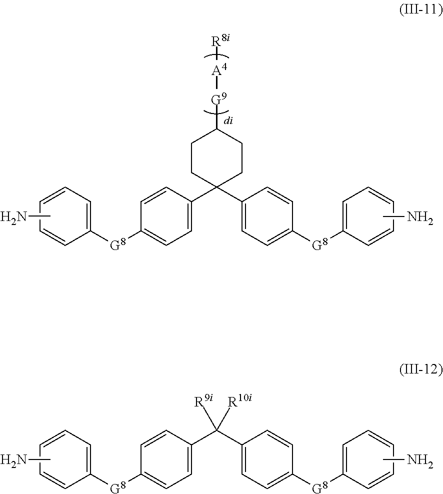

Definitions of symbols in formula (III-11) and formula (III-12) are as described below. R⁸ⁱ is —H or alkyl having 1 to 20 carbons, and arbitrary —CH₂— in the alkyl may be replaced by —O—, —CH═CH— or —C≡C—. R⁹ⁱ is alkyl having 6 to 22 carbons, and R¹⁰ⁱ is —H or alkyl having 1 to 22 carbons. G⁸ is —O— or alkylene having 1 to 6 carbons. A⁴ is 1,4-phenylene or 1,4-cyclohexylene, G⁹ is a single bond or alkylene having 1 to 3 carbons, and di is 0 or 1. A bonding position of NH₂ to a benzene ring is arbitrary, but preferably a meta position or a para position relative to a bonding position of G⁸.

When compound (III-8) to compound (III-12) are used as a diamine raw material in the invention, at least one may be selected from the diamines and thus used, or the diamine or the diamines and any other diamine (diamine other than compound (III-8) to compound (III-12)) may be mixed and thus used. On the occasion, the compound (III-1) to compound (III-7) are also contained in a selection range of any other diamine.

Examples of compound (III-8) are shown below.

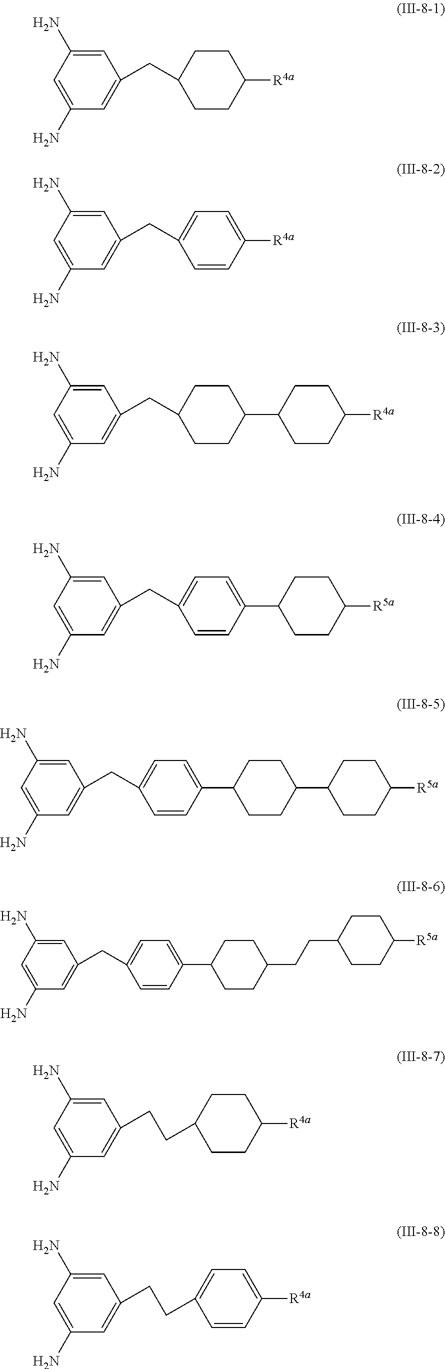

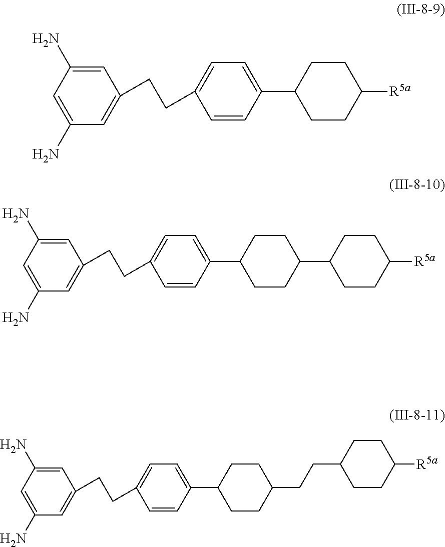

In the formulas, R^{4a} is alkyl having 3 to 20 carbons or alkoxy having 3 to 20 carbons, preferably, alkyl having 5 to 20 carbons or alkoxy having 5 to 20 carbons. R^{5a} is alkyl having 1 to 18 carbons or alkoxy having 1 to 18 carbons, preferably, alkyl having 3 to 18 carbons or alkoxy having 3 to 18 carbons.

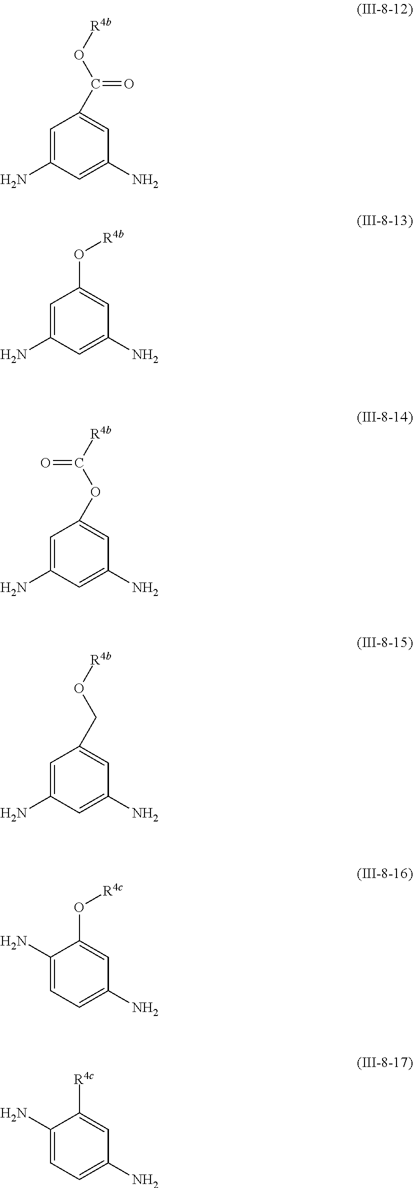

In the formulas, R^{4b} is alkyl having 4 to 16 carbons, preferably, alkyl having 6 to 16 carbons. R^{4c} is alkyl having 6 to 20 carbons, preferably, alkyl having 8 to 20 carbons.

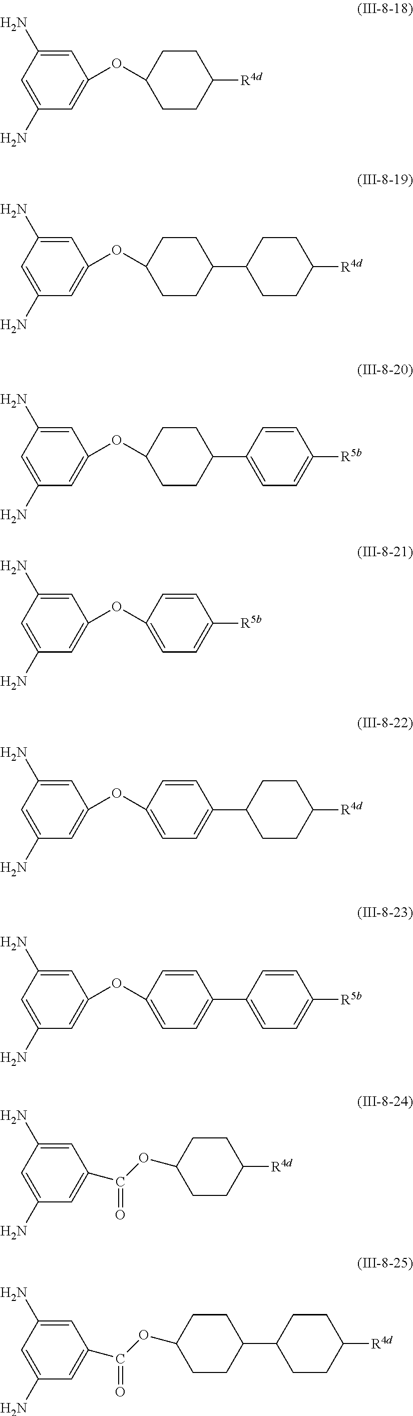

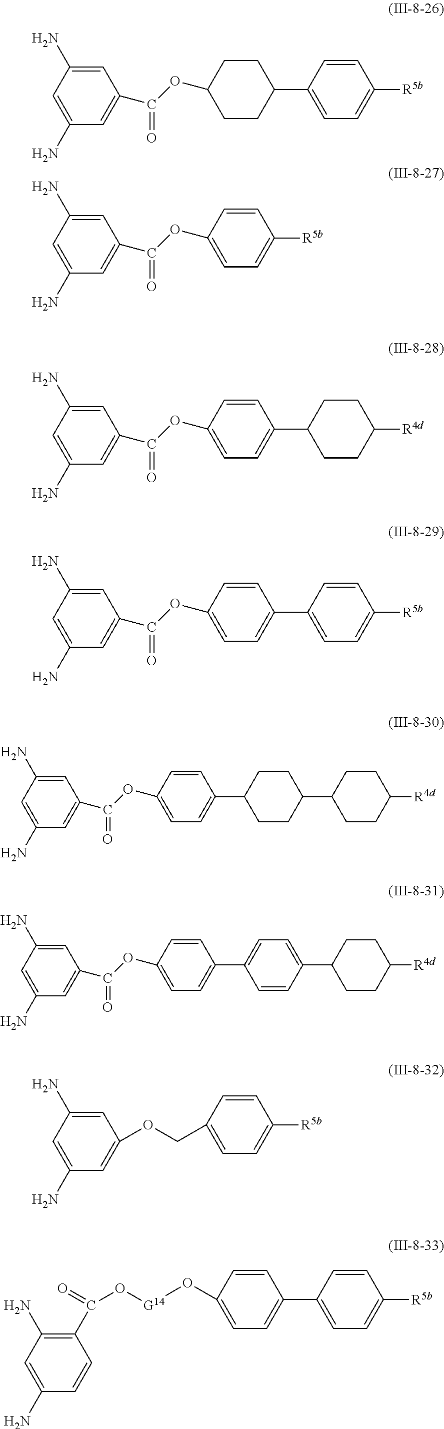

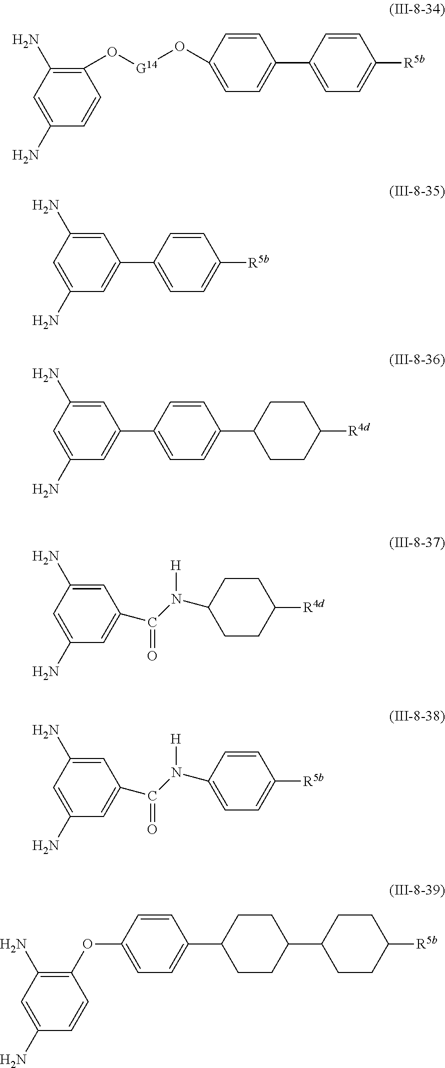

In the formulas, R^{4d} is alkyl having 1 to 20 carbons or alkoxy having 1 to 20 carbons, preferably, alkyl having 3 to 20 carbons or alkoxy having 3 to 20 carbons. R^{5b} is —H, —F, alkyl having 1 to 20 carbons, alkoxy having 1 to 20 carbons, —CN, —OCH₂F, —OCHF₂ or —OCF₃, preferably, alkyl having 3 to 20 carbons or alkoxy having 3 to 20. Then, G¹⁴ is alkylene having 1 to 20 carbons.

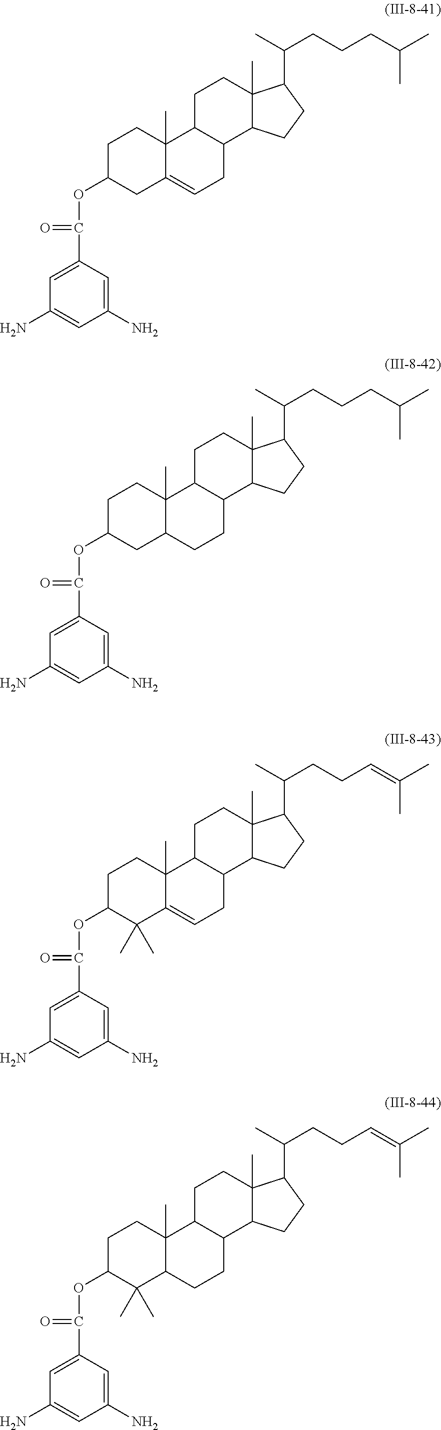 [SMILES: CC(C)CCCC(C)C1CCC2C3CC=C4CC(OC(=O)c5cc(N)cc(N)c5)CCC4(C)C3CCC12C ; CC(C)CCCC(C)C1CCC2C3CCC4CC(OC(=O)c5cc(N)cc(N)c5)CCC4(C)C3CCC12C ; CC(C)=CCCC(C)C1CCC2C3CC=C4C(C)(C)C(OC(=O)c5cc(N)cc(N)c5)CCC4(C)C3CCC12C ; CC(C)=CCCC(C)C1CCC2C3CCC4C(C)(C)C(OC(=O)c5cc(N)cc(N)c5)CCC4(C)C3CCC12C]

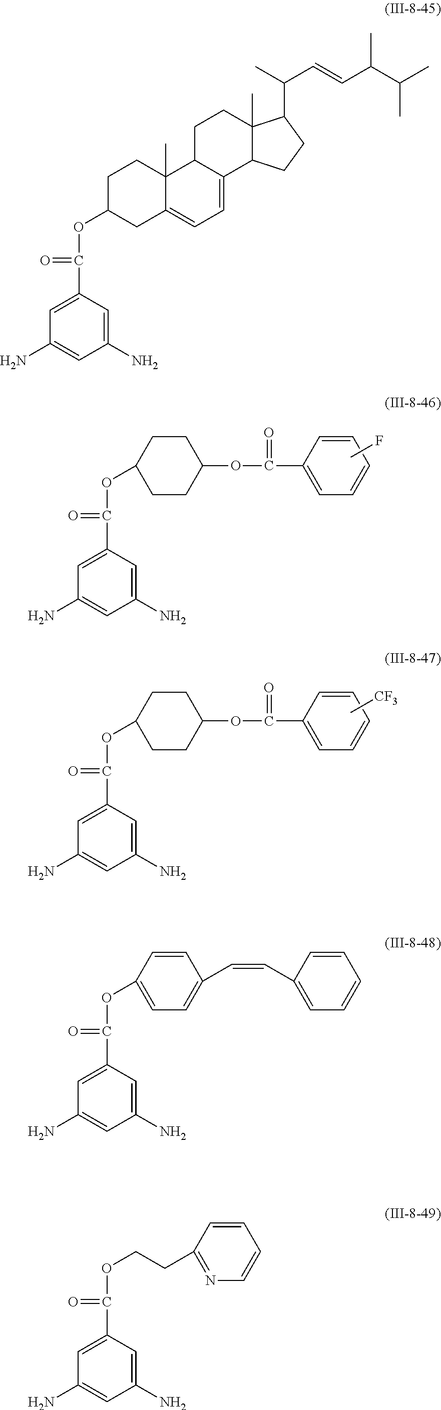

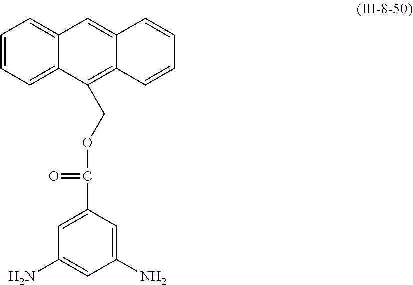 [SMILES: Nc1cc(N)cc(C(=O)OCc2c3ccccc3cc3ccccc23)c1]

Among the specific examples relating to compound (III-8), compound (III-8-1) to compound (III-8-11), compound (III-8-39) and compound (III-8-41) are preferred, and compound (III-8-2), compound (III-8-4), compound (III-8-5), compound (III-8-6), compound (III-8-39) and compound (III-8-41) are further preferred.

Examples of compound (III-9) are shown below.

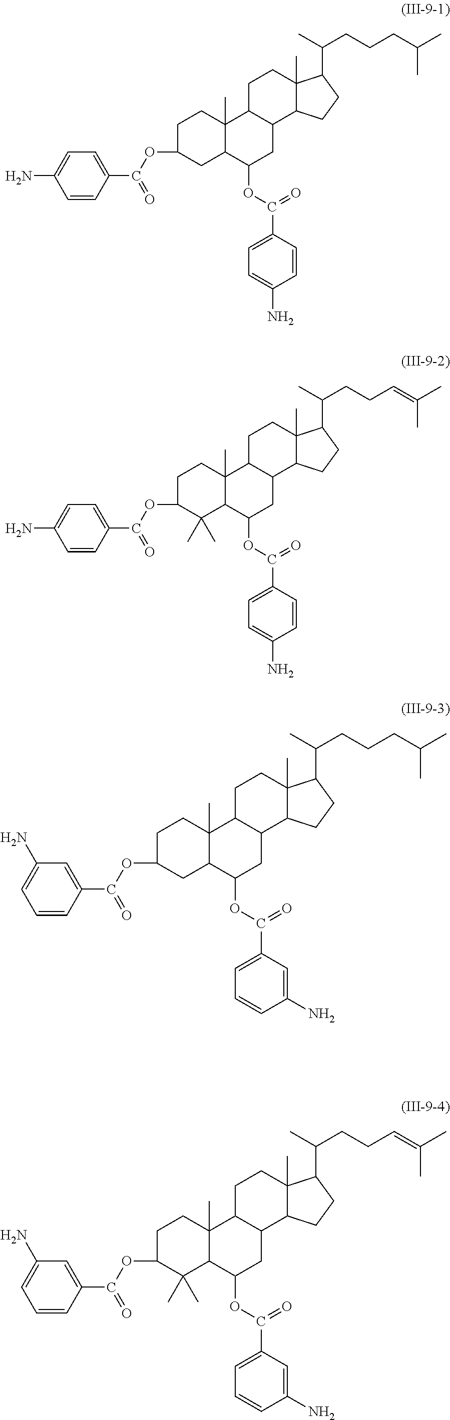 [SMILES: CC(C)CCCC(C)C1CCC2C3CC(OC(=O)c4ccc(N)cc4)C4CC(OC(=O)c5ccc(N)cc5)CCC4(C)C3CCC12C ; CC(C)=CCCC(C)C1CCC2C3CC(OC(=O)c4ccc(N)cc4)C4C(C)(C)C(OC(=O)c5ccc(N)cc5)CCC4(C)C3CCC12C ; CC(C)CCCC(C)C1CCC2C3CC(OC(=O)c4cccc(N)c4)C4CC(OC(=O)c5cccc(N)c5)CCC4(C)C3CCC12C ; CC(C)=CCCC(C)C1CCC2C3CC(OC(=O)c4cccc(N)c4)C4C(C)(C)C(OC(=O)c5cccc(N)c5)CCC4(C)C3CCC12C]

Examples of compound (III-10) are shown below.

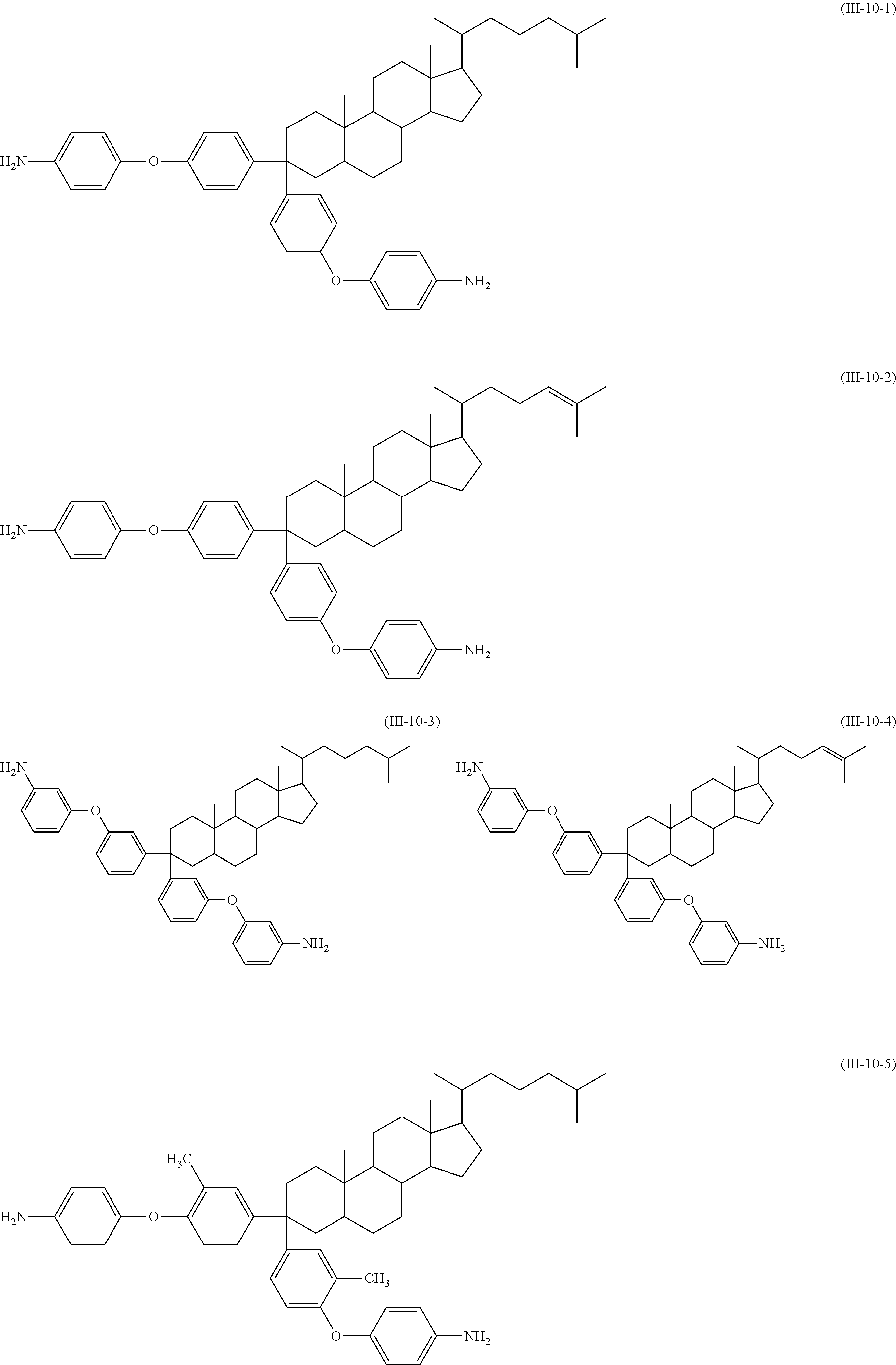 [SMILES: CC(C)CCCC(C)C1CCC2C3CCC4CC(c5ccc(Oc6ccc(N)cc6)cc5)(c5ccc(Oc6ccc(N)cc6)cc5)CCC4(C)C3CCC12C ; CC(C)=CCCC(C)C1CCC2C3CCC4CC(c5ccc(Oc6ccc(N)cc6)cc5)(c5ccc(Oc6ccc(N)cc6)cc5)CCC4(C)C3CCC12C ; CC(C)CCCC(C)C1CCC2C3CCC4CC(c5cccc(Oc6cccc(N)c6)c5)(c5cccc(Oc6cccc(N)c6)c5)CCC4(C)C3CCC12C ; CC(C)=CCCC(C)C1CCC2C3CCC4CC(c5cccc(Oc6cccc(N)c6)c5)(c5cccc(Oc6cccc(N)c6)c5)CCC4(C)C3CCC12C ; Cc1cc(C2(c3ccc(Oc4ccc(N)cc4)c(C)c3)CCC3(C)C(CCC4C3CCC3(C)C(C(C)CCCC(C)C)CCC43)C2)ccc1Oc1ccc(N)cc1]

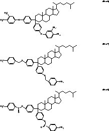 [SMILES: Cc1cc(Oc2ccc(C3(c4ccc(Oc5ccc(N)c(C)c5)cc4)CCC4(C)C(CCC5C4CCC4(C)C(C(C)CCCC(C)C)CCC54)C3)cc2)ccc1N ; CC(C)CCCC(C)C1CCC2C3CCC4CC(c5ccc(OCc6ccc(N)cc6)cc5)(c5ccc(OCc6ccc(N)cc6)cc5)CCC4(C)C3CCC12C ; CC(C)CCCC(C)C1CCC2C3CCC4CC(c5ccc(OC(=O)c6ccc(N)cc6)cc5)(c5ccc(OC(=O)c6ccc(N)cc6)cc5)CCC4(C)C3CCC12C]

Examples of compound (III-11) are shown below.

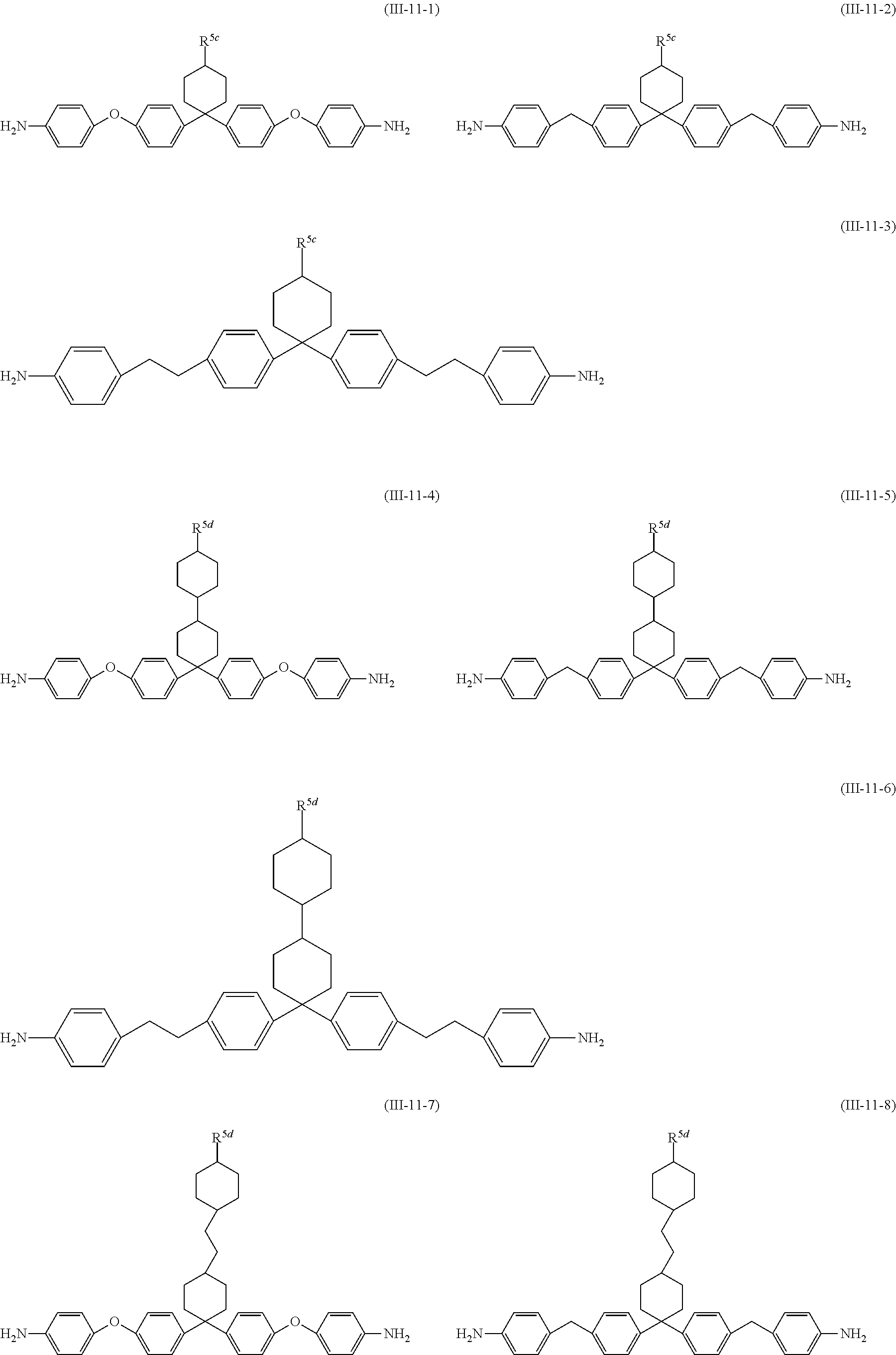

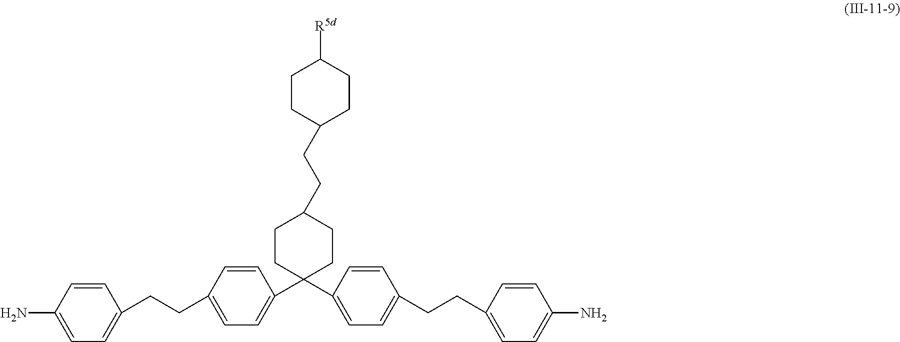

In the formulas, R^{5c} is —H or alkyl having 1 to 20 carbons, preferably, —H or alkyl having 1 to 10 carbons, and R^{5d} is —H or alkyl having 1 to 10 carbons.

Examples of compound (III-12) are shown below.

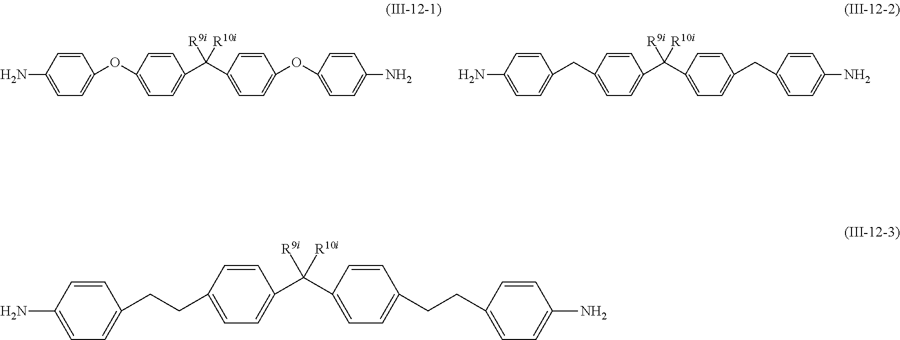

In the formulas, R⁹ⁱ is alkyl having 6 to 20 carbons, and R¹⁰ⁱ is —H or alkyl having 1 to 10 carbons.

More specifically, compound (III-12) includes the following diamines:

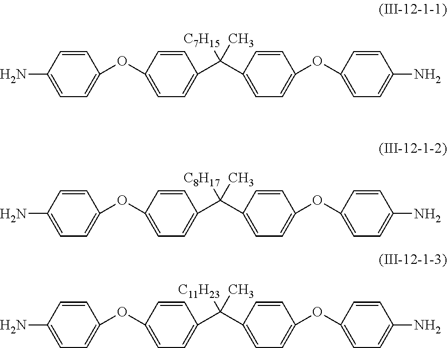

Specific examples of particularly preferred diamines represented by general formula (III-12) include formulas (III-12-1-1), (III-12-1-2) and (III-12-1-3).

When using compound (III-8) to compound (III-12) in the invention, a ratio of compound (III-8) to compound (III-12) based on the total amount of diamines to be used is adjusted according to structure of a diamine having selected side chain structure and a desired pretilt angle. The ratio is in the range of 1 to 100 mol %, preferably, in the range of 5 to 80 mol %.

In the invention, a diamine that is neither compound (III-1) to compound (III-7) nor compound (III-8) to compound (III-12) can be used. Specific examples of such diamines include a naphthalene-based diamine, a diamine having a fluorene ring and a diamine having a siloxane bond, and a diamine having side chain structure, other than compound (III-8) to compound (III-12).

Examples of diamines having a siloxane bond include a diamine represented by the following formula (III-13):

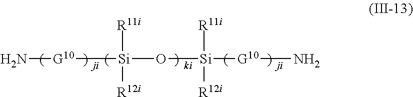

In formula (III-13), R¹¹ⁱ and R¹²ⁱ are independently alkyl having 1 to 3 carbons or phenyl, and G¹⁰ is methylene, phenylene, or alkyl-substituted phenylene. Then, ji represents an integer of 1 to 6 and ki represents an integer of 1 to 10.

An example of compound (III-13) is shown below.

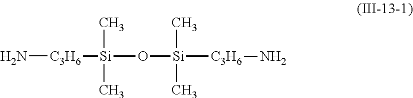

Examples of diamines having side chain structure, other than compound (III-1) to compound (III-13), are shown below.

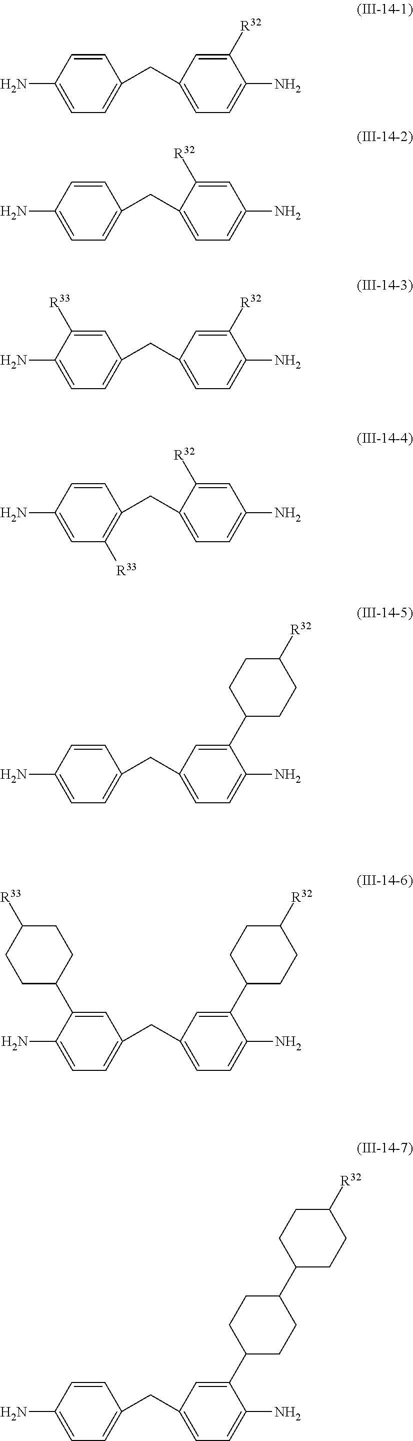

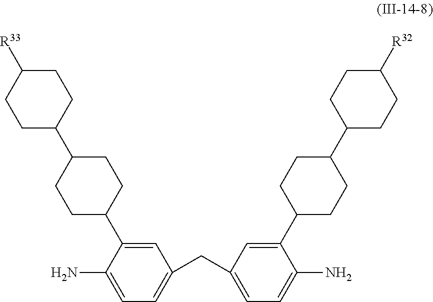

In the formulas above, R³² and R³³ are independently alkyl having 3 to 20 carbons.

1.1.2 Tetracarboxylic dianhydride

Specific examples of tetracarboxylic dianhydrides used for the polyimide resin film of the invention include a tetracarboxylic dianhydrides represented by formula (IV-1) to (IV-13).

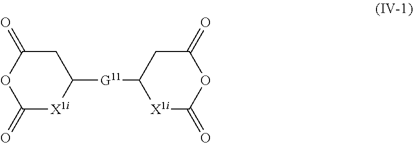

In formula (IV-1), G¹¹ represents a single bond, alkylene having 1 to 12 carbons, a 1,4-phenylene ring or a 1,4-cyclohexylene ring, and X¹ⁱ each independently represents a single bond or CH₂. Specific examples include tetracarboxylic dianhydrides represented by the following structural formulas:

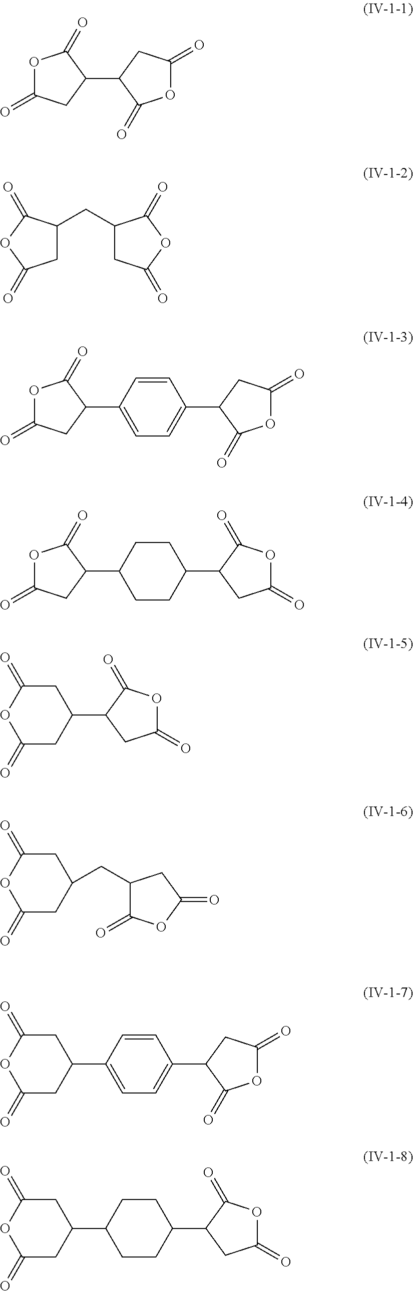

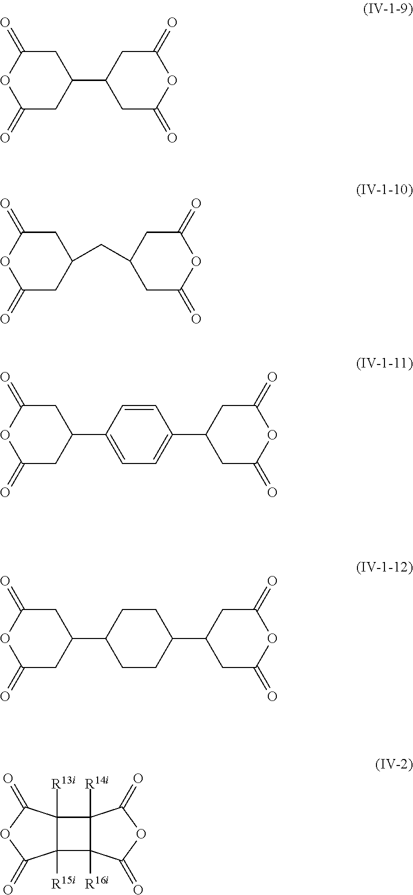

In formula (IV-2), R¹³ⁱ, R¹⁴ⁱ, R¹⁵ⁱ and R¹⁶ⁱ represent —H, —CH₃, —CH₂CH₃ or phenyl. Specific examples include tetracarboxylic dianhydrides represented by the following structural formulas:

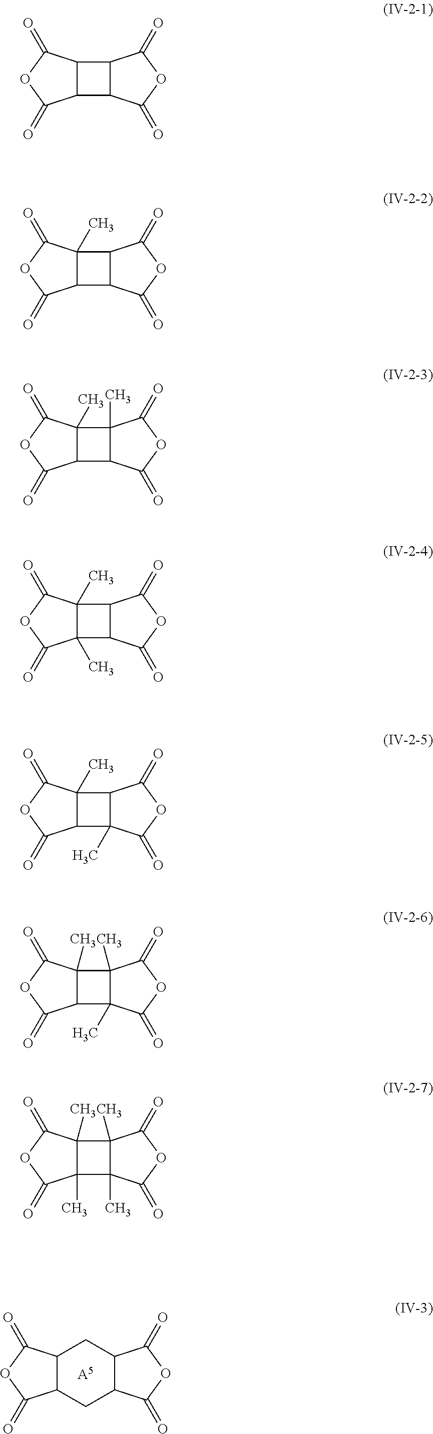

In formula (IV-3), ring A⁵ represents a cyclohexane ring or a benzene ring. Specific examples include tetracarboxylic dianhydrides represented by the following structural formulas:

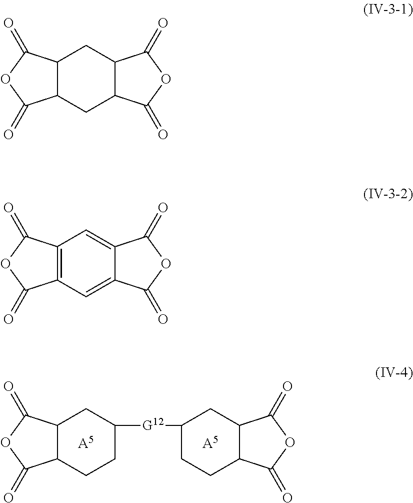

In formula (IV-4), G¹² represents a single bond, —CH₂—, —CH₂CH₂—, —O—, —S—, —C(CH₃)₂—, —SO— or —C(CF₃)₂—, and ring A⁵ each independently represents a cyclohexane ring or a benzene ring. Specific examples include tetracarboxylic dianhydrides represented by the following structural formulas:

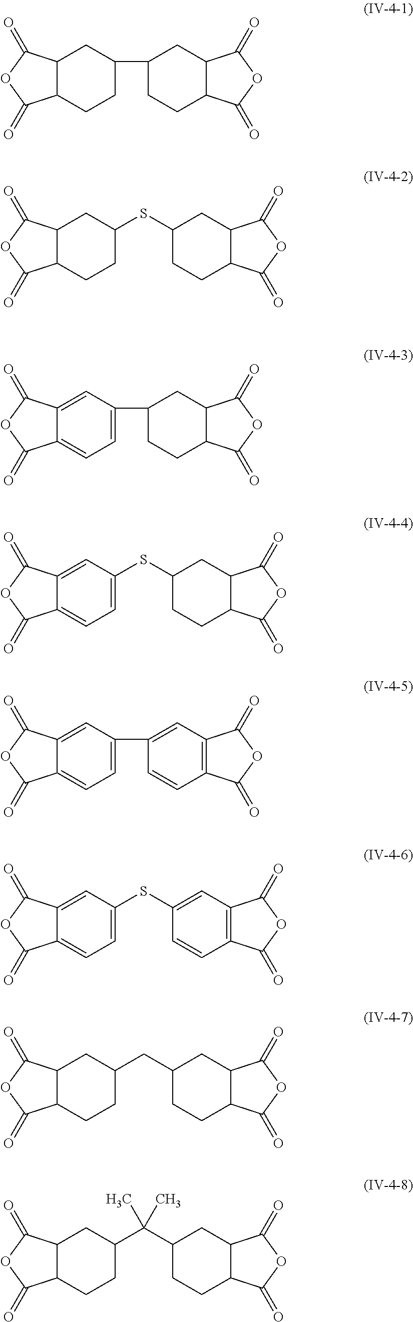

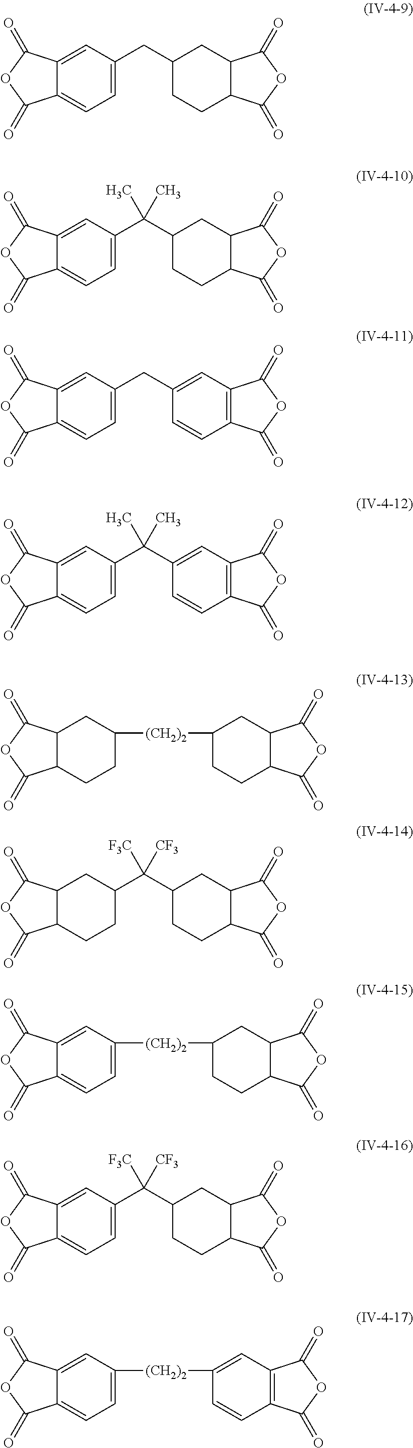

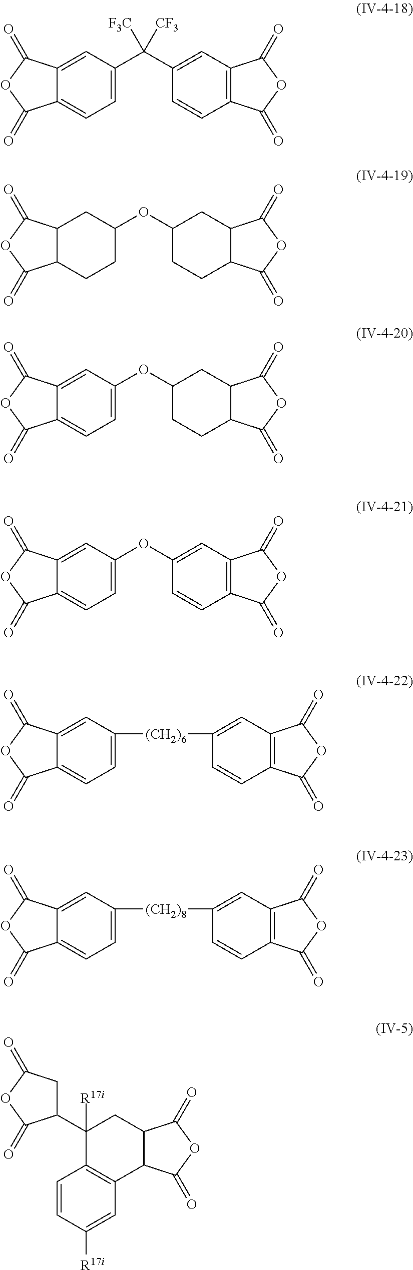

In formula (IV-5), R¹⁷ⁱ independently represents —H or —CH₃. Specific examples include tetracarboxylic dianhydrides represented by the following structural formulas:

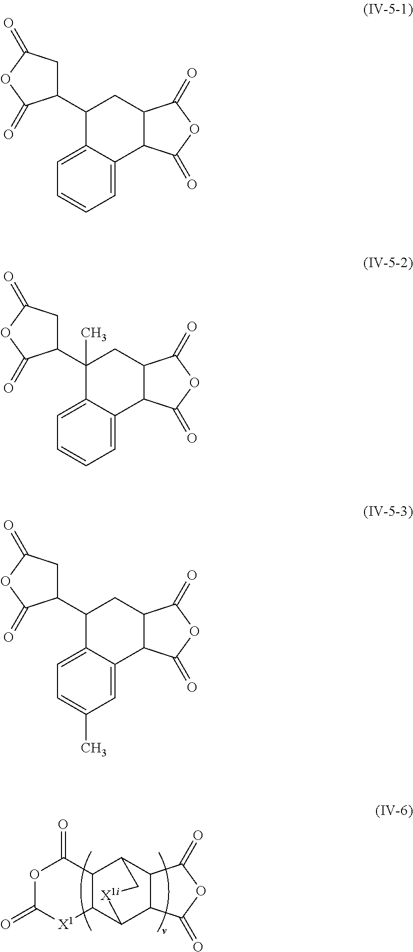

In formula (IV-6), X¹ⁱ each independently represents a single bond or —CH₂—, and v represents 1 or 2. Specific examples include tetracarboxylic dianhydrides represented by the following structural formulas:

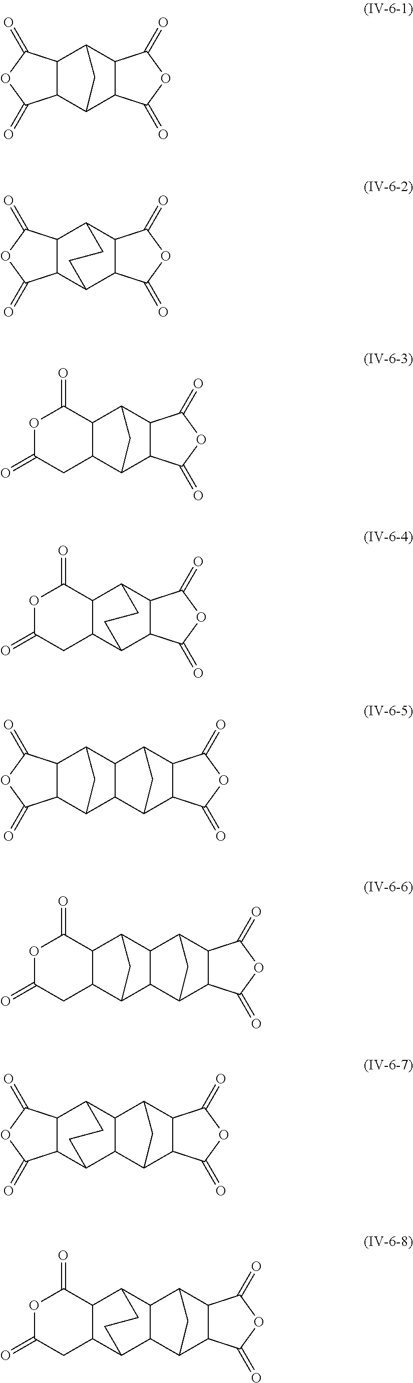

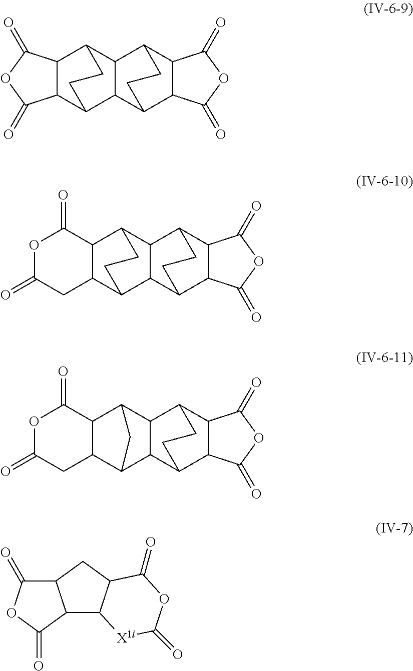

In formula (IV-7), X¹ⁱ represents a single bond or —CH₂—. Specific examples include tetracarboxylic dianhydrides represented by the following structural formulas:

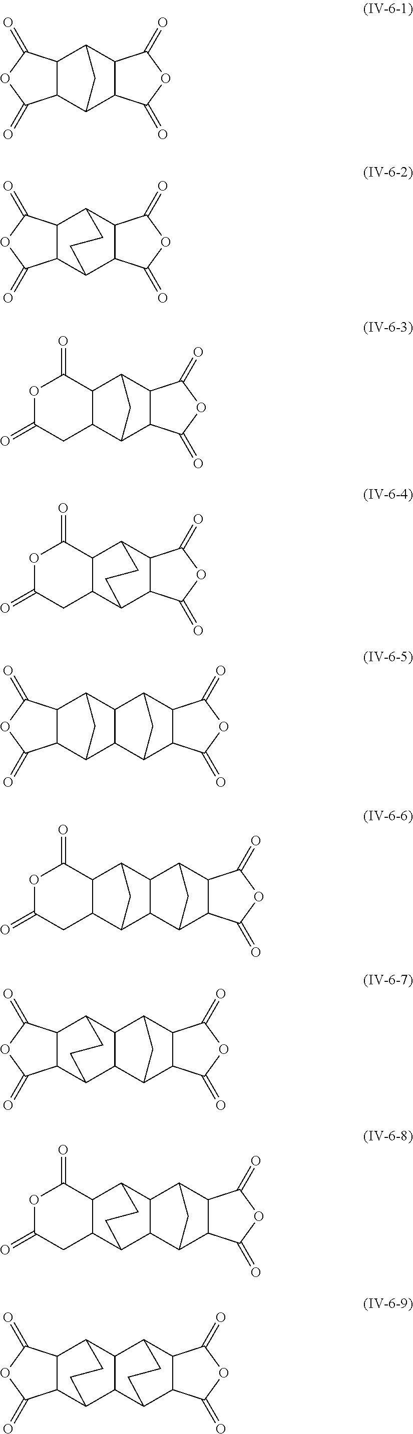

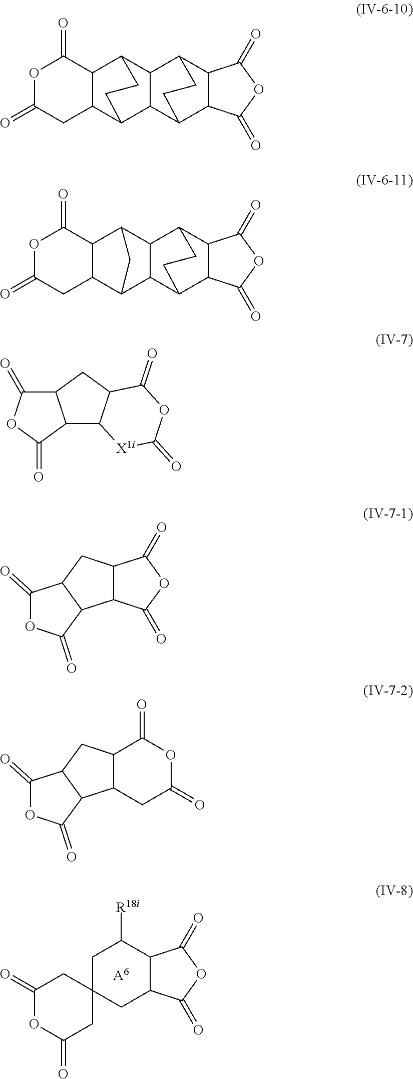

In formula (IV-8), R¹⁸ⁱ represents —H, —CH₃, —CH₂CH₃ or phenyl, and ring A⁶ represents a cyclohexane ring or a cyclohexene ring. Specific examples include tetracarboxylic dianhydrides represented by the following structural formulas:

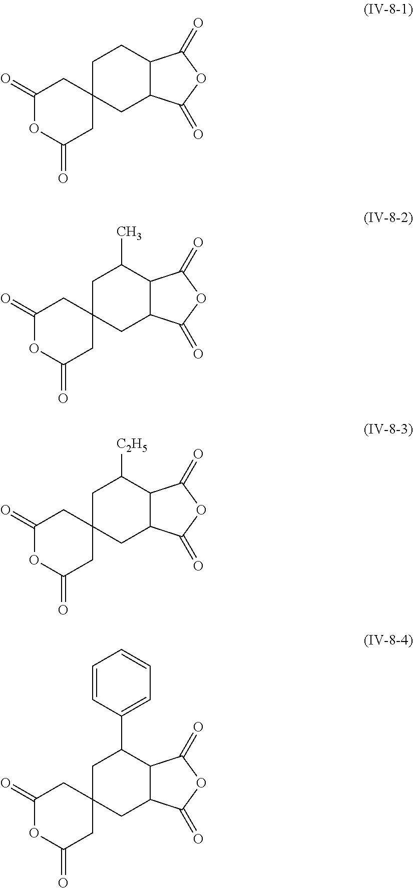

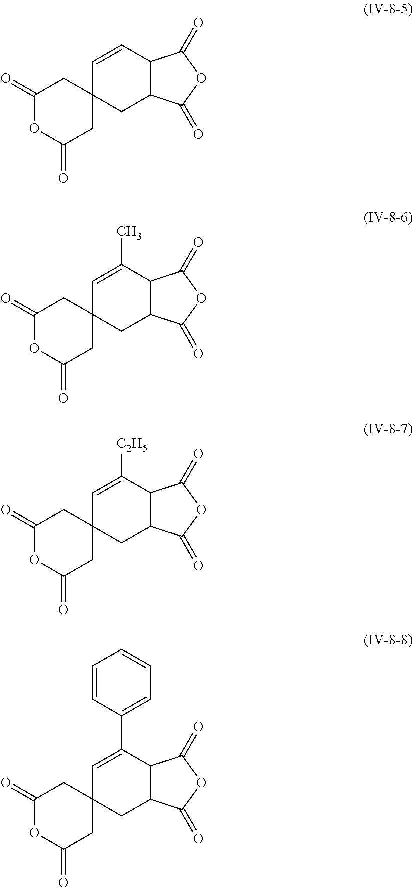

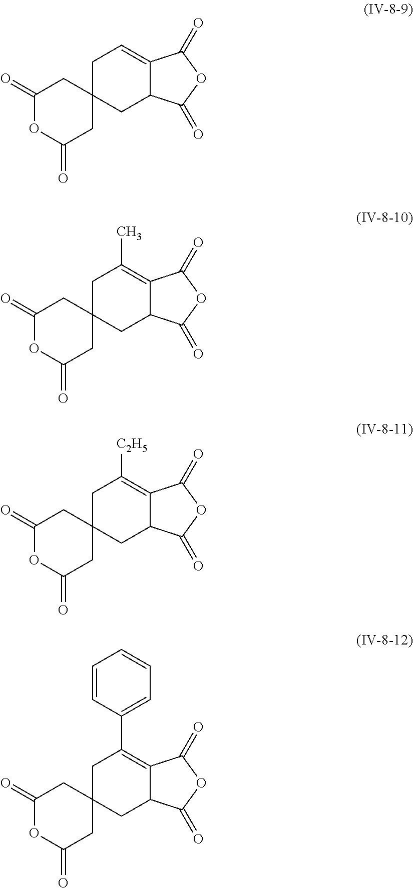

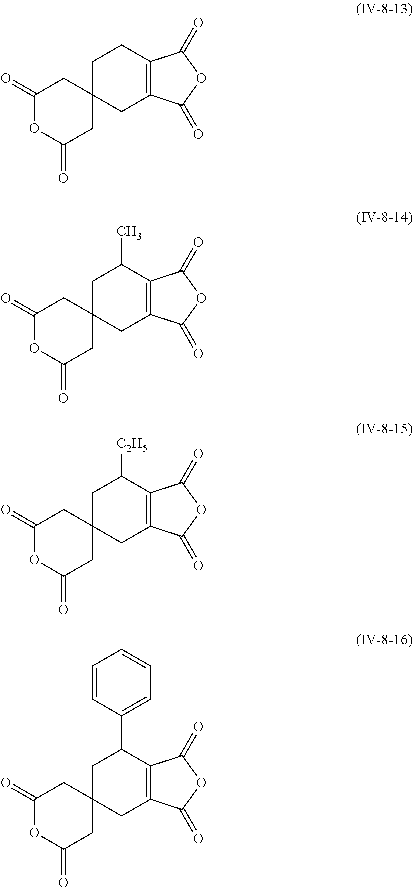

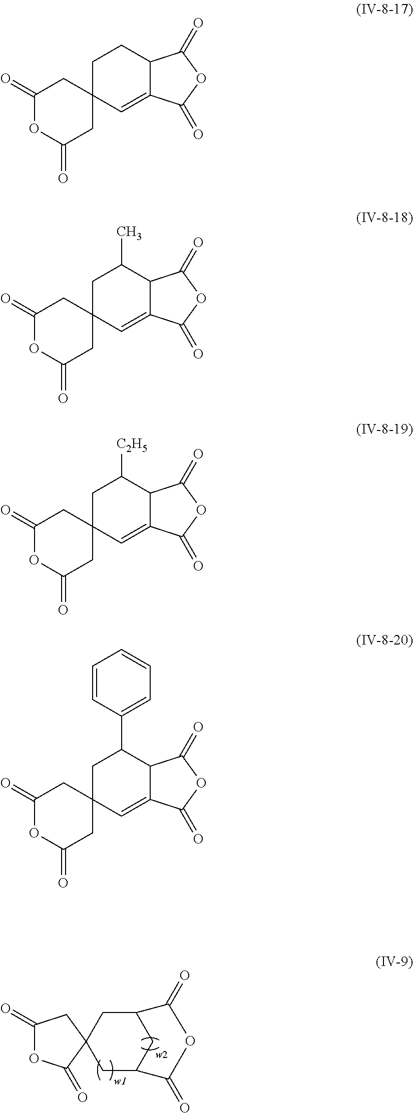

In formula (IV-9), w1 and w2 represent 0 or 1. Specific examples include tetracarboxylic dianhydrides represented by the following structural formulas:

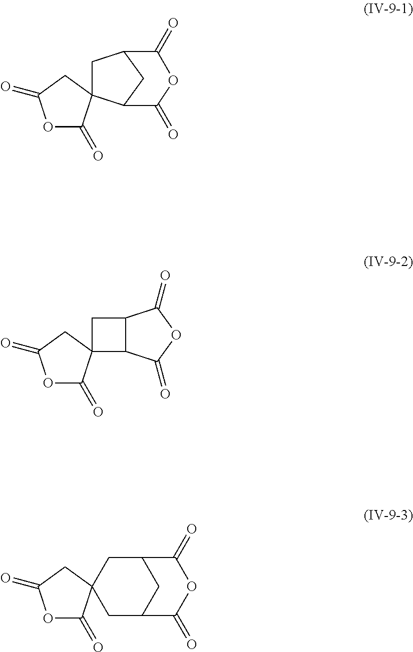 [SMILES: O=C1CC2(CC3CC2C(=O)OC3=O)C(=O)O1 ; O=C1CC2(CC3C(=O)OC(=O)C32)C(=O)O1 ; O=C1CC2(CC3CC(C2)C(=O)OC3=O)C(=O)O1]

Formula (IV-10) includes the following tetracarboxylic dianhydrides:

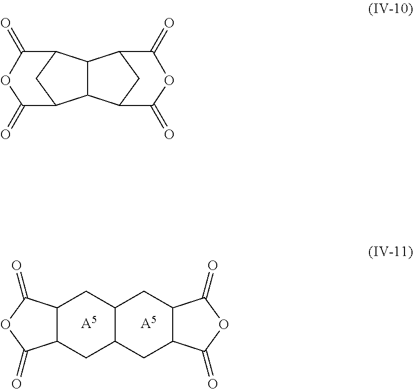

In formula (IV-11), ring A⁵ independently represents a cyclohexane ring or a benzene ring. Specific examples include tetracarboxylic dianhydrides represented by the following structural formulas:

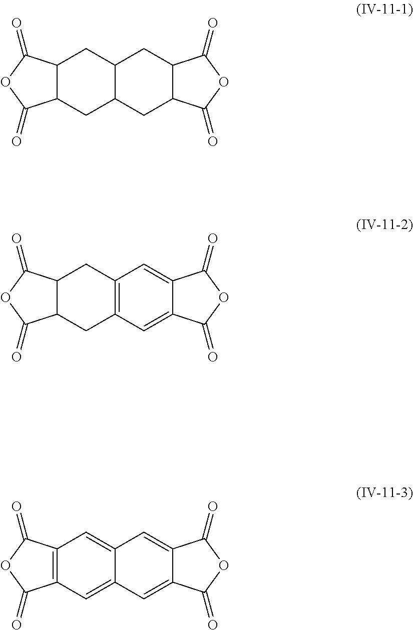

In formula (IV-12), X²ⁱ represents alkylene having 2 t0 6 carbons. Specific examples include tetracarboxylic dianhydrides represented by the following structural formulas:

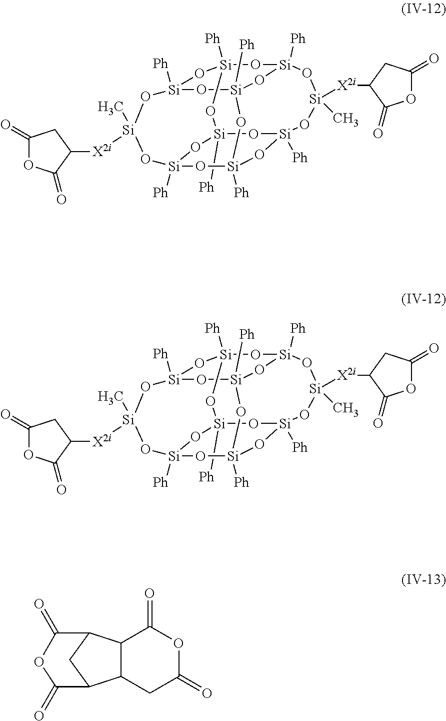

Specific examples of tetracarboxylic dianhydrides other than the above include the following compounds:

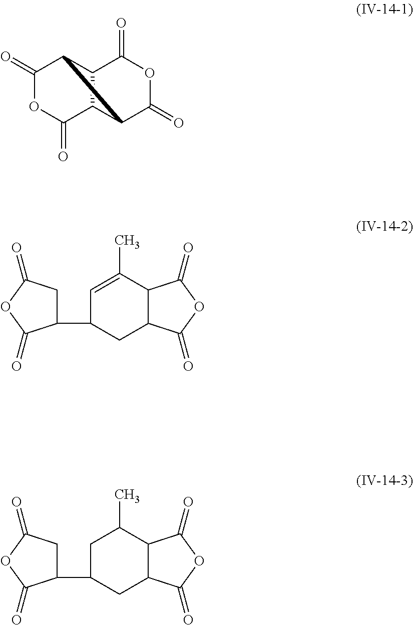 [SMILES: O=C1OC(=O)C2[C@H]3C(=O)OC(=O)[C@H]2C13 ; CC1=CC(C2CC(=O)OC2=O)CC2C(=O)OC(=O)C12 ; CC1CC(C2CC(=O)OC2=O)CC2C(=O)OC(=O)C12]

Specific examples of preferred tetracarboxylic dianhydrides include the following structure:

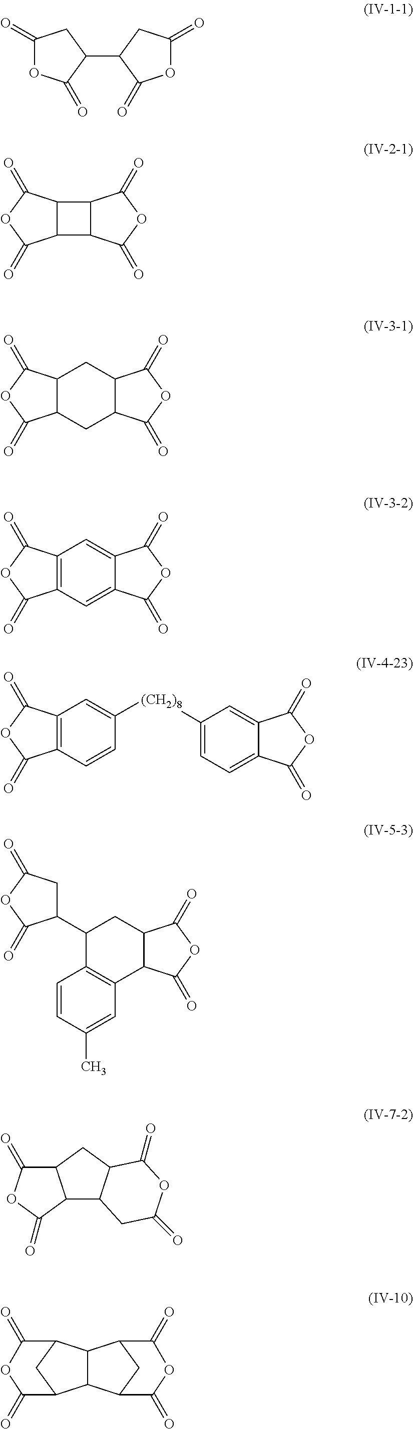

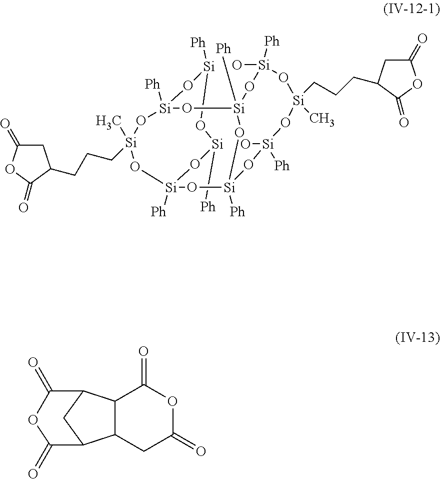

### 1.1.3 Preparation of Polyimide Resin Thin Film

The polyimide resin thin film of the invention can be prepared by hardening a composition (hereinafter also referred to “varnish”) containing the polyamic acid being a reaction product of the tetracarboxylic dianhydride and the diamine or the derivative of the polyamic acid.

The derivative of the polyamic acid means a component that dissolves in a solvent, when prepared into the varnish as described later containing the solvent, and the component that can form a thin film mainly formed of the polyimide when converting the varnish into the polyimide resin thin film as described later.

Specific examples of such derivatives of the polyamic acid include a soluble polyimide, a polyamic acid ester and a polyamic acid amide. More specifically, specific examples include 1) a polyimide in which all of amino and carboxyl of the polyamic acid are subjected to a dehydration ring closure reaction, 2) a partial polyimide partially subjected to the dehydration ring closure reaction, 3) apolyamic acid ester in which carboxyl of the polyamic acid is converted into an ester, 4) a polyamic acid-polyamide copolymer obtained by replacing a part of acid dianhydride contained in a tetracarboxylic dianhydride compound into an organic dicarboxylic acid and allowing the acid to react with the diamine, and also 5) a polyamideimide in which the polyamic acid-polyamide copolymer is partially or wholly subjected to the dehydration ring closure reaction. The polyamic acid or a derivative thereof may be used alone or in combination of a plurality of compounds in the varnish.

The polyamic acid or the derivative thereof of the invention may further contain a monoisocyanate compound in a monomer thereof. An end of the polyamic acid or the derivative thereof obtained is modified by containing the monoisocyanate compound in the monomer, and thus molecular weight is adjusted. Application properties of the varnish can be improved by using an end-modified polyamic acid or the derivative thereof without the advantageous effects of the invention being adversely affected, for example.

Molecular weight of the polyamic acid or the derivative thereof used in the invention is preferably in the range of 10,000 to 500,000, further preferably, in the range of 20,000 to 200,000 in terms of polystyrene-equivalent weight average molecular weight (Mw). The molecular weight of the polyamic acid or the derivative thereof can be determined from measurement according to a gel permeation chromatography (GPC) method.

As for the polyamic acid or the derivative thereof used in the invention, the presence can be confirmed by precipitating solids with a large amount of poor solvent and analyzing the obtained solids by means of IR or NMR. Moreover, the polyamic acid or the derivative thereof of the invention is decomposed with an aqueous solution of a strong alkali such as KOH and NaOH, and then a component extracted from the decomposition product with an organic solvent is analyzed by means of GC, HPLC or GC-MS, and thus the monomer used can be confirmed.

The varnish used in the invention may further contain any component other than the polyamic acid or the derivative thereof. Any other component may include one component, or two or more components.

For example, the varnish used in the invention may further contain an alkenyl-substituted nadimide compound from a viewpoint of stabilizing electric properties of the liquid crystal display element for a long period of time.

For example, the varnish used in the invention may further contain a compound having a radical polymerizable unsaturated double bond from a viewpoint of stabilizing the electric properties of the liquid crystal display element for a long period of time.

For example, the varnish used in the invention may further contain an oxazine compound from a viewpoint of long-term stability of the electric properties of the liquid crystal display element.

For example, the varnish used in the invention may further contain an oxazoline compound from a viewpoint of long-term stability of the electric properties of the liquid crystal display element.

For example, the varnish used in the invention may further contain an epoxy compound from a viewpoint of long-term stability of the electric properties of the liquid crystal display element.

For example, the varnish used in the invention may further contain various kinds of additives. Examples of various kinds of additives include a polymer compound or a low-molecular-weight compound other than the polyamic acid and the derivative thereof. The additives can be selected and used according to each purpose.

For example, the varnish used in the invention may further contain any other polymer component, such as an acrylic acid polymer or an acrylate polymer, and a polyamideimide being a reaction product of a tetracarboxylic dianhydride, a dicarboxylic acid or the derivative thereof with a diamine within the range where the advantageous effects of the invention are not adversely affected (preferably, within 20% by weight of the total amount of the polyamic acid and the derivative thereof).

For example, the varnish used in the invention may further contain a solvent from a viewpoint of applicability of the varnish or adjustment of a concentration of the polyamic acid or the derivative thereof. The solvent can be applied without a particular limitation, if the solvent has a capacity for dissolving a polymer component. The solvent widely includes a solvent ordinarily used in a process for manufacturing the polymer component such as the polyamic acid and the soluble polyimide or in an application side thereof, and can be appropriately selected according to a purpose of use. The solvent can be used in one kind or as a mixed solvent of two or more kinds.

The varnish used in the invention is put to practical use in a solution form by diluting the polymer component containing the polyamic acid or the derivative thereof with the solvent. A concentration of the polymer component on the occasion is not particularly limited, but is preferably in the range of 0.1 to 40% by weight. When applying the varnish to the substrate, an operation for diluting the polymer component contained beforehand with the solvent may be needed for adjusting film thickness. From a viewpoint of adjusting viscosity of the varnish to viscosity suitable for easily mixing the solvent to the varnish on the occasion, the concentration of the polymer component is preferably 40% by weight or less.

The concentration of the polymeric component in the varnish may be adjusted according to a method for applying the varnish. When the method for applying the varnish is a spinner method or a printing method, the concentration of the polymer component is ordinarily adjusted to be 10% by weight or less in many cases to keep the film thickness favorably. According to other application methods, for example, a dipping method or an ink jet method, the concentration may be further decreased. On the other hand, when the concentration of the polymer component is 0.1% by weight or more, the film thickness of the polyimide resin thin film obtained easily becomes optimal. Accordingly, the concentration of the polymer component is 0.1% by weight or more, preferably, in the range of 0.5 to 10% by weight in an ordinary spinner method, printing method or the like. However, the varnish may be used at a lower concentration depending on the method for applying the varnish.

In addition, when the varnish is used for preparation of the polyimide resin thin film, the viscosity of the varnish of the invention can be determined according to a means and a method for forming a film of the varnish. For example, when forming the film of the varnish using a printing machine, the viscosity is preferably 5 mPa·s or more from a viewpoint of obtaining a sufficient film thickness, 100 mPa·s or less from a viewpoint of suppressing printing unevenness, further preferably, in the range of 10 to 80 mPa·s. When applying the varnish and forming the film of the varnish according to spin coating, the viscosity is preferably in the range of 5 to 200 mPa·s, further preferably, in the range of 10 to 100 mPa·s from a similar viewpoint. The viscosity of the varnish can be decreased by dilution with the solvent or curing involving stirring.

The varnish of the invention may be in a form of containing one kind of polyamic acid or the derivative thereof, and in a form of two or more kinds of polyamic acids or the derivative thereof being mixed, namely, a form of a polymer blend.

The polyimide resin thin film of the invention is formed after a coating film of the varnish of the invention as described previously is heated. The polyimide resin thin film of the invention can be obtained according to an ordinary method for preparing a liquid crystal alignment film from a liquid crystal alignment agent. For example, the polyimide resin thin film of the invention can be obtained according to a process for forming the coating film of the varnish of the invention, and a process for heating and calcinating the film. With regard to the polyimide resin thin film of the invention, rubbing treatment of the film obtained in the calcination process may be applied when necessary.

The coating film of the varnish can be formed by applying the varnish of the invention to the substrate in the liquid crystal display element in a manner similar to ordinary preparation of the liquid crystal alignment film. An electrode such as an Indium Tin Oxide (ITO) electrode, a color filter or the like may be provided on the substrate.

As the method for applying the varnish to the substrate, the spinner method, the printing method, the dipping method, a dropping method, the ink jet method or the like is generally known. The methods can be applied in a similar manner also in the invention.

The calcination of the coating film can be performed under conditions required for the polyamic acid or the derivative thereof to cause a dehydration and ring-closure reaction. As for the calcination of the coating film, a method for performing heating treatment in an oven or an infrared furnace, a method for performing heating treatment on a hot plate or the like is generally known. The methods can be applied in a similar manner also in the invention. In general, the calcination is preferably performed at temperature in the range of 150 to 300° C. for 1 minute to 3 hours.

The rubbing treatment can be performed in a manner similar to rubbing treatment for an ordinary alignment treatment of the liquid crystal alignment film, and may be under conditions in which a sufficient retardation is obtained in the polyimide resin thin film of the invention. Particularly preferred conditions include a pile impression in the range of 0.2 to 0.8 millimeter, stage translational speed in the range of 5 to 250 mm/sec, and roller rotational speed in the range of 500 to 2,000 rpm. As a method for alignment treatment of the polyimide resin thin film, an optical alignment method, a transfer method or the like is generally known in addition to a rubbing method. Any of other alignment treatment methods may be used simultaneously with the rubbing treatment within the range where the advantageous effects of the invention are achieved.

The polyimide resin thin film of the invention is suitably obtained according to a method including any process other than the process as described previously. Specific examples of such other processes include a process for drying the coating film and a process for cleaning a film before and after the rubbing treatment with a cleaning solution.

As the drying process, a method for performing heat treatment in an oven or an infrared furnace, a method of performing heat treatment on a hot plate or the like in a manner similar to the calcination process is generally known. The methods can be applied to the drying process in a similar manner. The drying process is preferably performed at temperature within which the solvent can be evaporated, and at temperature comparatively lower than temperature in the calcination process.

Specific examples of the methods for cleaning the polyimide resin thin film with the cleaning solution before and after the alignment treatment include brushing, jet spraying, vapor cleaning and ultrasonic cleaning. These methods may be applied alone or in combination. As the cleaning solution, pure water, various kinds of alcohols such as methyl alcohol, ethyl alcohol and isopropyl alcohol, aromatic hydrocarbons such as benzene, toluene and xylene, halogen solvents such as methylene chloride, ketones such as acetone and methyl ethyl ketone or the like can be used, but the cleaning solvent is not limited thereto. A fully purified cleaning solution containing few impurities is clearly used as the cleaning solutions. Such a cleaning method can be applied also to a cleaning process in formation of the polyimide resin thin film of the invention.

Film thickness of the polyimide resin thin film of the invention is not particularly limited, but is preferably in the range of 10 to 300 nanometers, further preferably, in the range of 30 to 150 nanometers. The film thickness of the polyimide resin thin film of the invention can be measured by means of a publicly known thickness measurement apparatus, such as a profilometer and an ellipsometer.

### 1.2 Organosilane Thin Film

Then organosilane thin film is formed by an organosilane compound having a reactive group that reacts with an inorganic material such as glass, metal and silica stone, for example. As an organic group, the organosilane compound has alkyl, alkoxy, perfluoroalkyl, an aromatic ring, or has a reactive group such as vinyl, epoxy, styryl, methacryloxy, acryloxy, amino, ureido, chloropropyl, mercapto, polysulfide, isocyanate, or the like.

A preferred organosilane compound includes an organosilane compound having alkylsilane, alkoxysilane or chlorosilane as one of the reactive groups with a glass substrate, and having alkyl, alkoxy, perfluoroalkoxy, amino and an aromatic ring as the organic group.

As for the organosilane thin film, the organosilane compound reacts with the substrate surface, and forms polysiloxane structure near the surface further by a condensation reaction. Specifically, surface treatment is performed by a method for (1) dipping the substrate in a 1 to 5% aqueous solution or organic solution of a silane compound, (2) exposing the substrate to a vapor of a silane compound or a vapor of a toluene solution, or (3) applying a silane compound on the substrate surface with a spinner or the like. Heating and cleaning are performed when necessary.

Details of the organosilane thin film used in the invention will be explained below.

The substrate of the organosilane thin film is obtained by chemically immobilizing alkoxysilane containing at least one kind of alkoxysilane represented by the following formula (S1) on the substrate surface:

R¹ₙSi(OR²)₄₋ₙ (S1)

where, in formula (S1), R¹ is a hydrogen atom, a halogen atom or an organic group having 1 to 30 carbon atoms, R² represents a hydrocarbon group having 1 to 5 carbon atoms, and n represents an integer of 1 to 3.

A first organic group of an organic group R¹ in formula (S1) has carbon atoms preferably in the range of 8 to 20, particularly preferably, in the range of 8 to 18. The organosilane thin film has the first organic group, and thus exhibits effects to align liquid crystals in one direction.

For the purpose of improving close contact with the substrate, affinity with liquid crystal molecules, or the like, an alkoxysilane having a second organic group, namely, an organic group different from the first organic group in formula (S1), has an organic group having 1 to 6 carbon atoms, unless the advantageous effects of the invention are adversely affected. Examples of the second organic group include an aliphatic hydrocarbon; ring structure such as an aliphatic ring, an aromatic ring or a hetero ring; an unsaturated bond; or an organic group having 1 to 3 carbon atoms that may contain a hetero atom such as an oxygen atom, a nitrogen atom and a sulfur atom, or may have branching structure. Moreover, the second organic group may have a halogen atom, a vinyl group, an amino group, a glycidoxy group, a mercapto group, an ureido group, a methacryloxy group, an isocyanate group, an acryloxy group or the like. The organosilane thin film used in the invention may have one kind or a plurality of kinds of the second organic groups.

The organosilane thin film of the invention allows to easily improve water repellency, as a result, to provide a lattice plane control substrate having a high compactness, a high hardness, and a favorable liquid crystal alignment of a film, and an excellent applicability and a high reliability.

Specific examples of the first organic groups include an alkyl group, a perfluoroalkyl group, an alkenyl group, an allyloxyalkyl group, a phenetyl group, a perfluorophenylalkyl group, a phenylaminoalkyl group, a styrylalkyl group, a naphthyl group, a benzoyloxyalkyl group, an alkoxyphenoxyalkyl group, a cycloalkylaminoalkyl group, an epoxycycloalkyl group, an N-(aminoalkyl)aminoalkyl group, an N-(aminoalkyl)aminoalkylphenetyl group, a bromoalkyl group, a diphenylphosphino group, an N-(methacryloxyhydroxyalkyl)aminoalkyl group, an N-(acryloxyhydroxyalkyl)aminoalkyl group, a monovalent organic group that may be replaced and has at least one norbornane ring, a monovalent organic group that may be replaced and has at least one steroid skeleton, a monovalent organic group that has a substituent selected from the group of a fluorine atom, a trifluoromethyl group and a trifluoromethoxy group, and has 7 or more carbon atoms, or a photosensitive group being a cinnamoyl group or a chalconyl group. Among the groups, an alkyl group and a perfluoroalkyl group are preferred because the groups can be easily obtained. The organosilane thin film used in the invention may have a plurality of types of such first organic groups.

Specific examples of alkoxysilanes represented by formula (S1) are described, but are not limited thereto.

Specific examples include heptyl trimethoxysilane, heptyl triethoxysilane, octyl trimethoxysilane, octyl triethoxysilane, decyltrimethoxysilane, decyltriethoxysilane, dodecyl trimethoxysilane, dodecyltriethoxysilane, hexadecyl trimethoxysilane, hexadecyl triethoxysilane, heptadecyl trimethoxysilane, heptadecyl triethoxysilane, octadecyl trimethoxysilane, octadecyl triethoxysilane, nonadecyl trimethoxysilane, nonadecyl triethoxysilane, undecyl triethoxysilane, undecyl trimethoxysilane, 21-docosenyl triethoxysilane, allyloxyundecyl triethoxysilane, tridecafluorooctyl trimethoxysilane, tridecafluorooctyl triethoxysilane, isooctyl triethoxysilane, phenethyl triethoxysilane, pentafluorophenyl propyltrimethoxysilane, N-phenylaminopropyl trimethoxysilane, N-(triethoxysilylpropyl)dansylamide, styrylethyl triethoxysilane, (R)—N1-phenylethyl-N′-triethoxysilylpropyl urea, (1-naphthyl)triethoxysilane, (1-naphthyl)trimethoxysilane, m-styrylethyl trimethoxysilane, p-styrylethyl trimethoxysilane, N-[3-(triethoxysilyl)propyl]phthalamic acid, 1-trimethoxysilyl-2-(p-aminomethyl)phenylethane, 1-trimethoxysilyl-2-(m-aminomethyl)phenylethane, benzoyloxypropyl trimethoxysilane, 3-(4-methoxyphenoxyl)propyl trimethoxysilane, N-triethoxysilylpropylquinine urethane, 3-(N-cyclohexylamino)propyl trimethoxysilane, 1-[(2-triethoxysilyl)ethyl]cyclohexane-3,4-epoxide, N-(6-aminohexyl)aminopropyl trimethoxysilane, aminoethylaminomethylphenethyl trimethoxysilane, 11-bromoundecyl trimethoxysilane, 2-(diphenylphosphino)ethyl triethoxysilane, N-(3-methacryloxy-2-hydroxypropyl)-3-aminopropyl triethoxysilane, and N-(3-acryloxy-2-hydroxypropyl)-3-amino-propyl triethoxysilane. As the alkoxysilane represented by formula (S1), dodecyl triethoxysilane, octadecyl triethoxysilane, octyl triethoxysilane, tridecafluorooctyl triethoxysilane, dodecyl trimethoxysilane, octadecyl trimethoxysilane or octyl trimethoxysilane is preferred.

The following specific examples of alkoxysilanes having 1 to 6 carbon atoms as R¹ represented by such formula (S1) are described.

When n=1, specific examples include methyl trimethoxysilane, methyl triethoxysilane, propyl trimethoxysilane, propyl triethoxysilane, methyl tripropoxysilane, 3-aminopropyl trimethoxysilane, 3-aminopropyl triethoxysilane, N-2(aminoethyl)3-aminopropyl triethoxysilane, N-2(aminoethyl)3-aminopropyl trimethoxysilane, 3-(2-aminoethylaminopropyl)trimethoxysilane, 3-(2-aminoethylaminopropyl)triethoxysilane, 2-aminoethylaminomethyl trimethoxysilane, 2-(2-aminoethylthioethyl)triethoxysilane, 3-mercaptopropyl triethoxysilane, 3-mercaptomethyl trimethoxysilane, 3-ureidopropyl triethoxysilane, 3-ureidopropyl trimethoxysilane, vinyl triethoxysilane, vinyl trimethoxysilane, allyl triethoxysilane, 3-methacryloxypropyl trimethoxysilane, 3-methacryloxypropyl triethoxysilane, 3-acryloxypropyl trimethoxysilane, 3-acryloxypropyl triethoxysilane, 3-isocyanatepropyl triethoxysilane, trifluoropropyl trimethoxysilane, chloropropyl triethoxysilane, bromopropyl triethoxysilane, 3-mercaptopropyl trimethoxysilane, phenyl triethoxysilane and phenyl trimethoxysilane.

Moreover, when n=2, specific examples include dimethyl diethoxysilane, dimethyl dimethoxysilane, diphenyl diethoxysilane, diphenyl dimethoxysilane, methyl diethoxysilane, methyl dimethoxysilane, methylphenyl diethoxysilane, methylphenyl dimethoxysilane, 3-aminopropylmethyl diethoxysilane, 3-aminopropylmethyl dimethoxysilane, 3-ureidopropylmethyl diethoxysilane and 3-ureidopropylmethyl dimethoxysilane.

Furthermore, when n=3, specific examples include trimethyl ethoxysilane, trimethyl methoxysilane, dimethylphenyl ethoxysilane, dimethylphenyl methoxysilane, 3-aminopropyldimethyl ethoxysilane, 3-aminopropyldimethyl methoxysilane, 3-ureidopropyldimethyl ethoxysilane and 3-aminopropyldimethyl methoxysilane.

Specific examples of alkoxysilanes when R² is a hydrogen atom or a halogen atom in the alkoxysilane according to formula (S1) include trimethoxysilane, triethoxysilane, tripropoxysilane, tributoxysilane, chlorotrimethoxysilane and chlorotriethoxysilane.

Specific examples of preferred alkoxysilanes include organosilane coupling agents SA to SF as described later.

When using the alkoxysilane represented by the formula (S1) as described above, either one kind or a plurality of kinds thereof may be appropriately used when necessary.

In the invention, a plurality of kinds of the alkoxysilane represented by formula (S1) can also be used in combination. In the invention, an alkoxysilane other than the alkoxysilane represented by formula (S1) can be used in combination.

The alkoxysilane of the invention can be processed into a hardened film by applying the alkoxysilane to the substrate, and then drying and calcinating the resultant substrate. Specific examples of application methods include a spin coating method, a printing method, an ink jet method, a spraying method and a roll coating method. However, a transfer printing method is widely used industrially in view of productivity, and the liquid crystal alignment agent of the invention is also suitably used.

A drying process after applying the alkoxysilane is not always needed. However, when time until calcination after application is not constant for each substrate or when calcination is not performed immediately after application, the drying process is preferably included. As for the drying, the solvent may be removed at a degree in which a coating film shape is not deformed by conveyance of the substrate, or the like, and the drying means is not particularly limited. Specific examples include a method for drying on a hot plate at temperature in the range of 40° C. to 150° C., preferably, in the range of 60° C. to 100° C. for 0.5 to 30 minutes, preferably, for 1 to 5 minutes.

The coating film formed by applying the alkoxysilane according to the method as described above can be processed into the hardened film by performing calcination. On the occasion, as for calcination temperature, calcination can be made at an arbitrary temperature in the range of 100° C. to 350° C., preferably, in the range of 140° C. to 300° C., further preferably, in the range of 150° C. to 230° C., still further preferably, in the range of 160° C. to 220° C. As for calcination time, calcination can be performed for an arbitrary period of time in the range of 5 minutes to 240 minutes. The calcination time is preferably in the range of 10 to 90 minutes, further preferably, in the range of 20 to 90 minutes. As for heating, an ordinary known method, such as a hot plate, a hot-air circulatory oven, an infrared oven, a belt furnace or the like can be used.

The organosilane thin film of the invention is preferably a monolayer film, particularly preferably, a self-assembled monolayer film (SAM). The organosilane thin film can be processed by self-assembly into a dry ultra-thin film having a film thickness in the range of 1 to 2 nanometers without any defect.

As caused by interaction of adsorbed molecules to each other in the course of adsorption, the adsorbed molecules may spontaneously form an assembly, and a molecular film may be formed in which the adsorbed molecules are densely assembled and alignment is uniform. When an adsorbed molecule layer is one layer, more specifically, when the monolayer film is formed, the film is named as Self-Assembled Monolayer (SAM). The film is referred to as the self-assembled monolayer film or a self-organized monolayer film in many cases. An expression of self-organization is applicable from a viewpoint of molecule alignment structure of a completed monolayer film, and wording of self-assembly is applicable when a process for molecules assembling is focused.

Although such a hardened film can be used directly as the liquid crystal alignment film, the hardened film can be also processed into the liquid crystal alignment film by rubbing the hardened film, irradiating the film with polarized light or light having a specific wavelength or the like, or performing treatment with an ion beam or the like.

The organosilane thin film of the invention can be considered to have structure in which a specific organic group is immobilized near a substrate surface layer. The consideration can be confirmed by measuring a water contact angle of the liquid crystal alignment film of the invention.

A method for injecting the liquid crystals is not particularly limited, but specific examples include a vacuum method for decreasing pressure inside a prepared liquid crystal cell and then injecting the liquid crystals and a dropping method for dropping the liquid crystals and then sealing the liquid crystals.

### 1.3 Structure of a Substrate

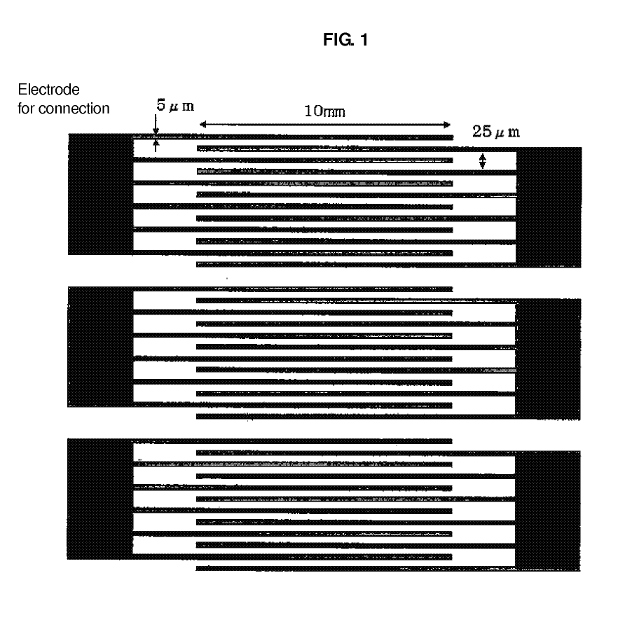

In two substrates arranged oppositely to each other, electrodes may be arranged on both of two substrates, respectively, or a set (two pieces) of electrodes may be arranged on one substrate. A specific example of an embodiment in which a set of electrodes are arranged on one substrate includes a comb electrode as shown in FIG. 1.

The substrates subjected to surface treatment are laminated through a spacer, and thus a blank cell is prepared. The liquid crystals are sandwiched and held in the cell, temperature is controlled, and thus blue phase I is exhibited.

A history of a previous phase influences formation of a three-dimensional lattice structure of blue phase I, and therefore blue phase I is exhibited in the course of falling temperature from the isotropic phase, and thus a lattice plane control is performed. A blue phase exhibited in the liquid crystal composition having a particularly high chirality goes through blue phase II in a high temperature side, and therefore the lattice plane of blue phase I is easily controlled uniformly.

The blue phase strongly reflects a history of chiral nematic liquid crystals, and therefore the blue phase is preferably exhibited in the course of falling temperature, but also in the course of rising temperature, the lattice plane of blue phase I can be uniformly controlled in a cell in which the chiral nematic liquid crystals form a planar alignment.

As for the liquid crystals sandwiched and held between the substrates in the cell constituted of the substrates subjected to rubbing treatment and the spacer, the blue phase subjected to the lattice plane control can be easily obtained in the course of rising and falling temperature.

### 2 Liquid Crystal Material Used for a Liquid Crystal Display Element of the Invention

The liquid crystal material used for the liquid crystal display element of the invention is optically isotropic. Herein, an expression “the liquid crystal material has an optical isotropy” means that, macroscopically, the liquid crystal material shows an optical isotropy because liquid crystal molecule alignment is isotropic, but microscopically, a liquid crystalline order exists.

Then, in the specification, “optically isotropic liquid crystal phase” expresses a phase exhibiting an isotropic liquid crystal phase optically without being caused by fluctuation. One example includes a phase exhibiting a platelet texture (blue phase in a narrow sense).

In the liquid crystal material used for the liquid crystal display element of the invention, a phase is the optically isotropic liquid crystal phase, but the platelet texture typical to the blue phase is not observed sometimes under observation using a polarizing microscope. Thus, according to the specification, a phase exhibiting the platelet texture is referred to as the blue phase, and an optically isotropic liquid crystal phase including the blue phase is referred to as the optically isotropic liquid crystal phase. More specifically, according to the specification, the blue phase is covered by the optically isotropic liquid crystal phase.

Generally, the blue phase is classified into three types (blue phase I, blue phase II and blue phase III), and all of the three types of blue phases are optically active and isotropic. In the blue phase including blue phase I or blue phase II, two or more kinds of diffracted light resulting from Bragg reflection from different lattice planes are observed. However, as described above, the liquid crystal material can be processed into an element showing single diffracted light by the substrate of the invention.

A pitch based on the liquid crystalline order that the liquid crystal material used for the liquid crystal display element of the invention has microscopically (hereinafter, referred to simply as “pitch” sometimes) is preferably in the range of 280 nanometers to 700 nanometers or less, or diffracted light from a (110) plane in blue phase I is preferably in the range of 400 nanometers to 1,000 nanometers.

Electric induced birefringence in the optically isotropic liquid crystal phase becomes larger as the pitch becomes longer, the electric induced birefringence can be increased by setting a longer pitch by adjusting a kind or content of a chiral agent, as long as desired optical properties (transmittance, diffraction wavelength or the like) are provided.

Blue phase I or blue phase II having a single color is prepared using the substrate of the invention, and the diffracted light is adjusted in the range of 700 nanometers or more, and thus a liquid crystal display element containing a colorless blue phase can be prepared, and the element has a high contrast and is driven at a low voltage. In the display element, further preferably, the diffracted light from only the (110) plane of blue phase I is observed, and a wavelength of the diffracted light is in the range of 700 nanometers or more.

In addition, according to the liquid crystal material used for the liquid crystal display element of the invention, a temperature range showing optically isotropic properties can be extended by adding the chiral agent to the liquid crystal composition having a wide temperature range in which the isotropic phase coexist with a nematic phase or a chiral nematic phase, and allowing the liquid crystal composition to exhibit the optically isotropic liquid crystal phase. For example, a composition exhibiting the optically isotropic liquid crystal phase in a wide temperature range can be prepared by mixing a liquid crystal compound having a low clearing point with a liquid crystal compound having a high clearing point, preparing the liquid crystal composition having the wide temperature range in which the nematic phase and the isotropic phase coexist, and adding the chiral agent to the mixture.

Moreover, according to the specification, “non-liquid crystal isotropic phase” means a generally defined isotropic phase, namely, a disordered phase, and an isotropic phase caused by the fluctuation even when a region where a local order parameter is not zero is generated. For example, the isotropic phase exhibited in a high temperature side of the nematic phase corresponds to the non-liquid crystal isotropic phase in the specification. A same definition is to apply also to a chiral liquid crystal in the specification.

The liquid crystal material used for the liquid crystal display element of the invention is preferably optically active. An optically active liquid crystal material is a mixture of at least one kind of optically active compound in the range of 1 to 40% by weight in total and an optically non-active liquid crystal compound in the range of 60 to 99% by weight in total.

### 3 Liquid Crystal Compound

An optically non-active liquid crystal compound is selected, for example, from compounds according to the following formula (1), further preferably, from liquid crystal compounds according to formula (2) to formula (20):

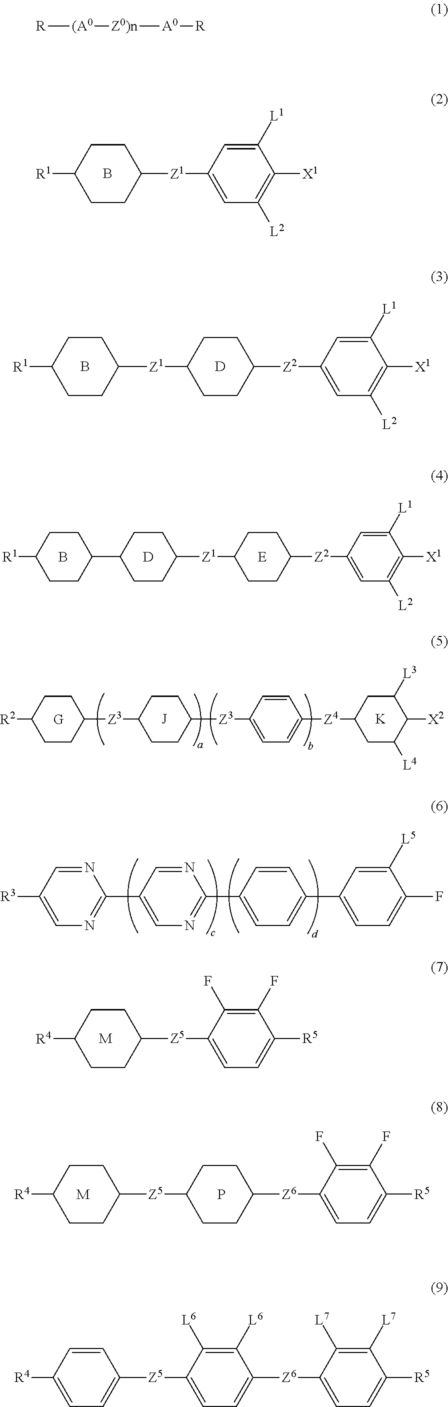

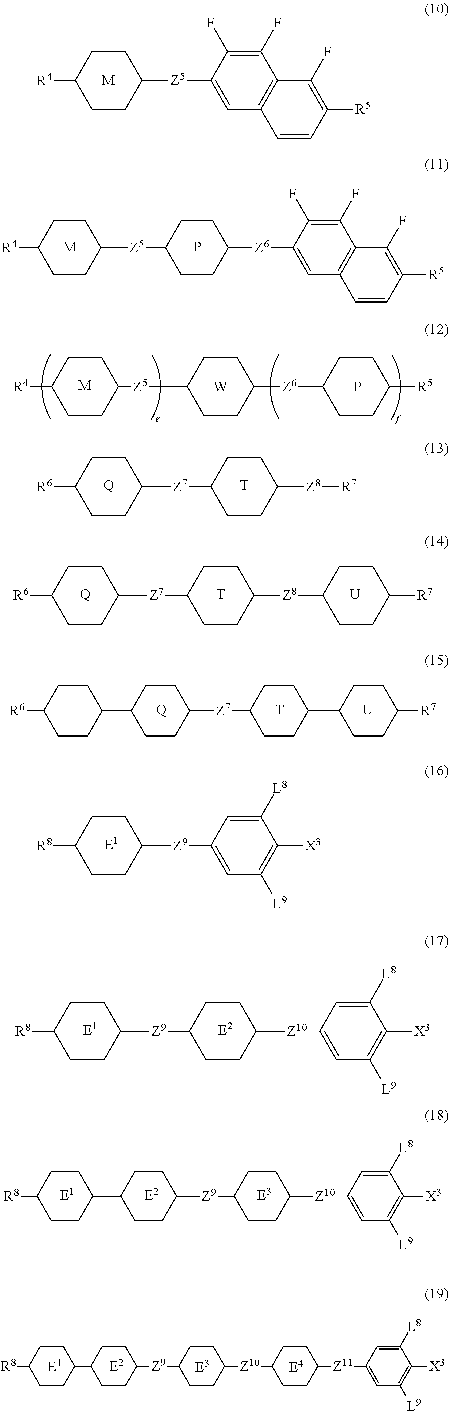

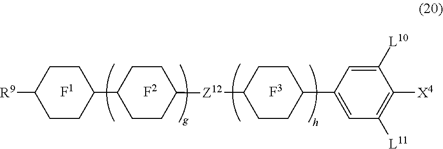

In the following, examples of liquid crystal compounds contained in the liquid crystal material used for the liquid crystal display element of the invention (compounds represented by formula (1) to formula (20)) will be explained. In the following, the compounds represented by formula (2) to formula (20) being further preferred compounds are classified according to each characteristic, and may be referred to as component A to component F.

### 3.1 Compounds Represented by Formula (1)

In formula (1), R is independently hydrogen, halogen, —CN, —N═C═O, —N═C═S or alkyl having 1 to 20 carbons, and in the alkyl, arbitrary —CH₂— may be replaced by—O—, —S—, —COO—, —OCO—, —CH═CH—, —CF═CF— or —C≡C—, and arbitrary hydrogen may be replaced by halogen. Examples of preferred R include hydrogen, fluorine, chlorine or alkyl, alkoxy, halogenated alkyl, halogenated alkoxy having 1 to 10 carbons, —CN, —N═C═O and —N═C═S, and at least one end substituent of molecules is preferably a non-polar group in order to obtain a high liquid crystallinity. A large value of Δ∈ and Δn is obtained, and therefore the other is preferably —CN, —N═C═O, —N═C═S, halogenated alkyl, and halogenated alkoxy.

In formula (1), A⁰ is independently an aromatic or non-aromatic 3-membered ring to 8-membered ring or a condensed ring having 9 or more carbons, and at least one hydrogen in the rings may be replaced by halogen, or alkyl or haloalkyl having 1 to 3 carbons, —CH₂— may be replaced by —O—, —S—, or —NH—, and —CH═ may be replaced by —N═. A⁰ is preferably an aromatic or non-aromatic 5-membered ring or 6-membered ring, naphthalene-2,6-diyl or fluorene-2,7-diyl, and at least one hydrogen in the rings may be replaced by halogen, or alkyl or fluoroalkyl having 1 to 3 carbons.

In each formula, the rings may be bonded in a reversed right-left direction. A configuration of 1,4-cyclohexylene and 1,3-dioxane-2,5-diyl is preferably a trans form. If each element of the compound of the invention contains an isotopic element at a ratio higher than a naturally occurring ratio, physical properties have no large difference.

In formula (1), Z⁰ is independently a single bond and alkylene having 1 to 8 carbons, and in a bonding group, arbitrary —CH₂— may be replaced by —O—, —S—, —COO—, —OCO—, —CSO—, —OCS—, —N═N—, —CH═N—, —N═CH—, —N(O)═N—, —N═N(O)—, —CH═CH—, —CF═CF— or —C≡C—, and arbitrary hydrogen may be replaced by halogen. Z⁰ preferably contains an unsaturated bond because the unsaturated bond tends to increase a value of Δn and Δ∈ to conform with an object of the invention, but any bonding group may be used if a required anisotropic value is obtained.

### 3.2 Compounds Represented by Formula (2) to Formula (4) (Component A)

In formula (2) to formula (4), R¹ is alkyl having 1 to 10 carbons, and in the alkyl, arbitrary —CH₂— may be replaced by —O— or —CH═CH—, and arbitrary hydrogen may be replaced by fluorine. R¹ is preferably alkyl or alkoxy having 1 to 10 carbons, or alkenyl or alkynyl having 2 to 10 carbons.

In formula (2) to formula (4), X¹ is fluorine, chlorine, —OCF₃, —OCHF₂, —CF₃, —CHF₂, —CH₂F, —OCF₂CHF₂, —OCHF₃ or —OCF₂CHFCF₃. Any group is preferred because a large value of Δ∈ is induced, but a larger number of fluorine is preferred in order to obtain a large value of Δ∈.

In formula (2) to formula (4), ring B and ring D are independently 1,4-cyclohexylene, 1,3-dioxane-2,5-diyl, or 1,4-phenylene in which arbitrary hydrogen may be replaced by fluorine, and ring E is 1,4-cyclohexylene, or 1,4-phenylene in which arbitrary hydrogen may be replaced by fluorine. Component A preferably contains a large amount of aromatic rings because a value of Δn and Δ∈ can be increased to conform with an object of the invention.

In formula (2) to formula (4), Z¹ and Z² are independently —(CH₂)₂—, —(CH₂)₄—, —COO—, —(C≡C)_{1,2,3}—, —CF₂O—, —OCF₂—, —CH═CH—, —CH₂O— or a single bond, and —COO—, —(C≡C)_{1,2,3}—, —CF₂O— and —CH═CH— are preferred because a value of Δn and Δ∈ is increased.

In formula (2) to formula (4), L¹ and L² are independently hydrogen or fluorine, and preferably fluorine within the range where liquid crystallinity is not adversely affected because a value of Δ∈ is increased.

The compounds represented by any of formula (2) to formula (4), more specifically, formula (2-1) to formula (2-16), formula (3-1) to formula (3-101), and formula (4-1) to formula (4-36) can be suitably used in the invention. In the formulas, R¹ and X¹ are identically defined as represented above.

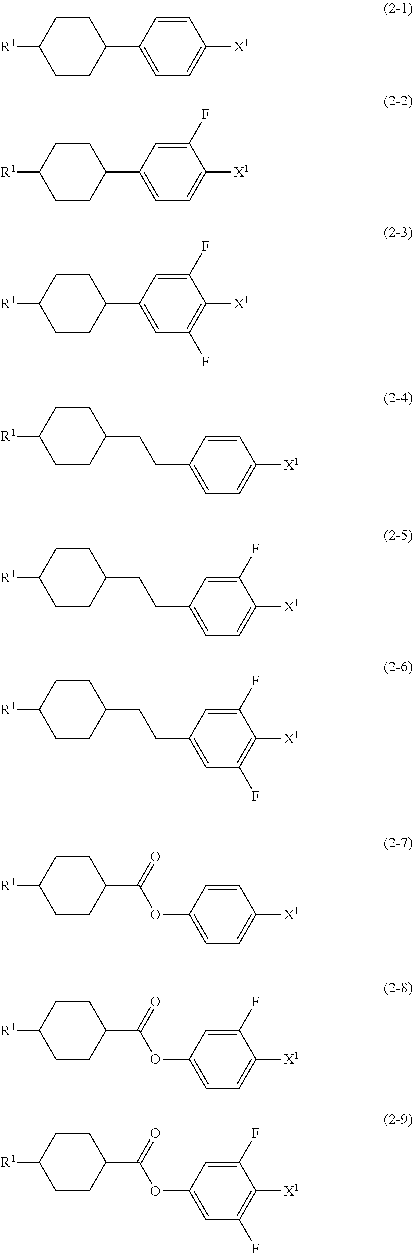

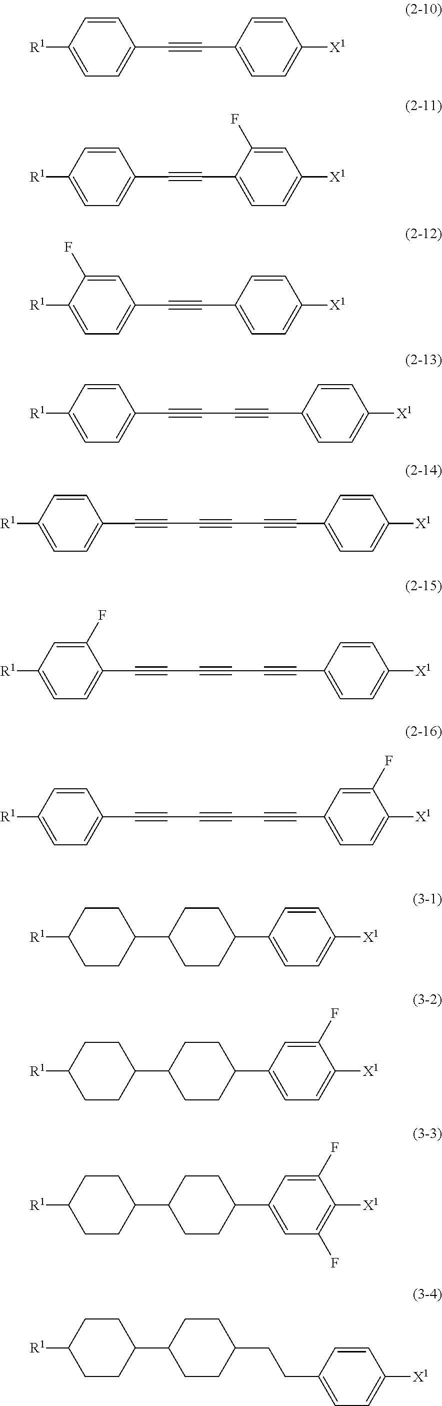

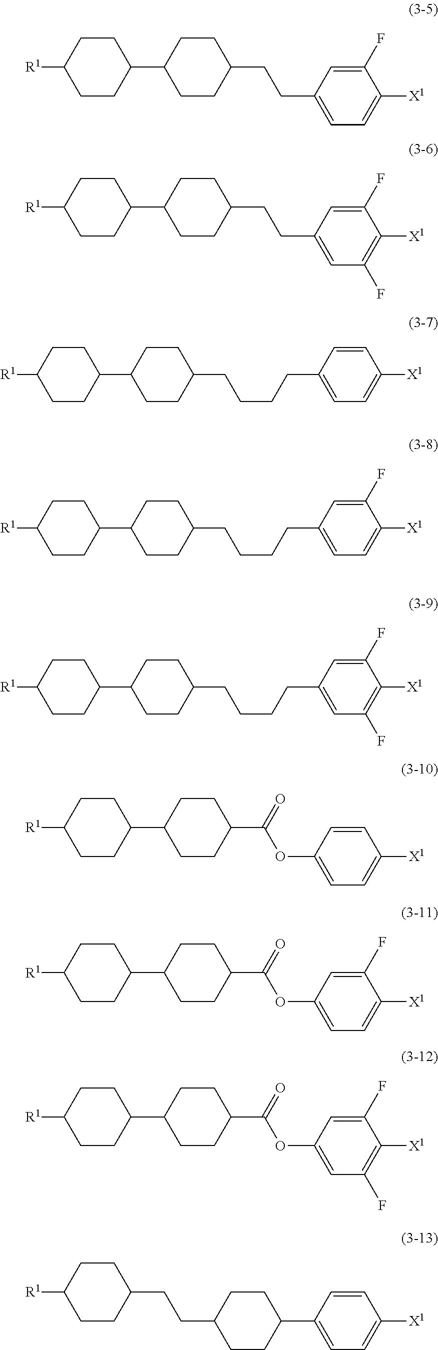

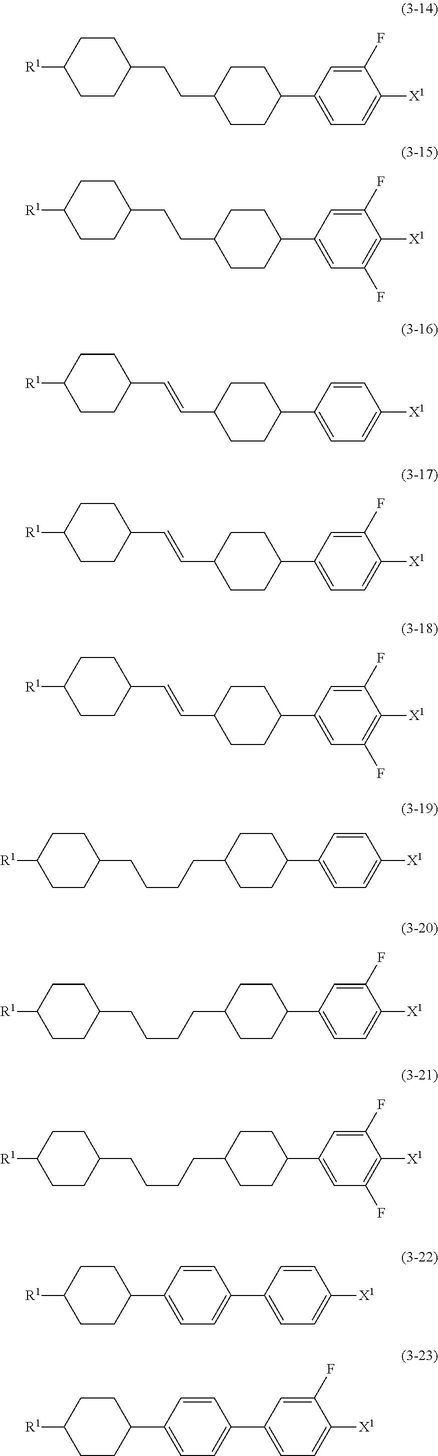

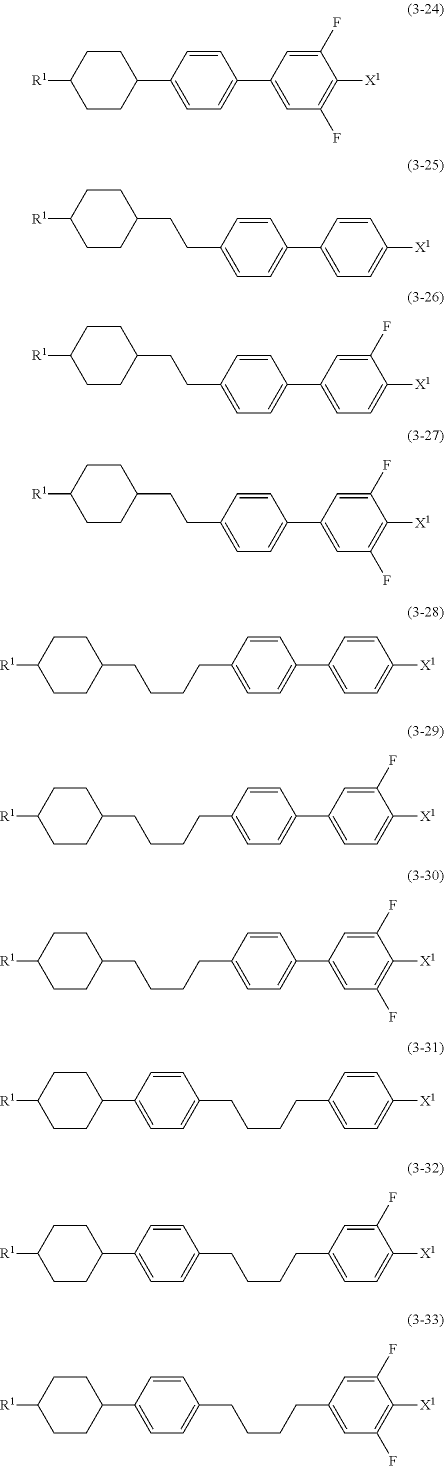

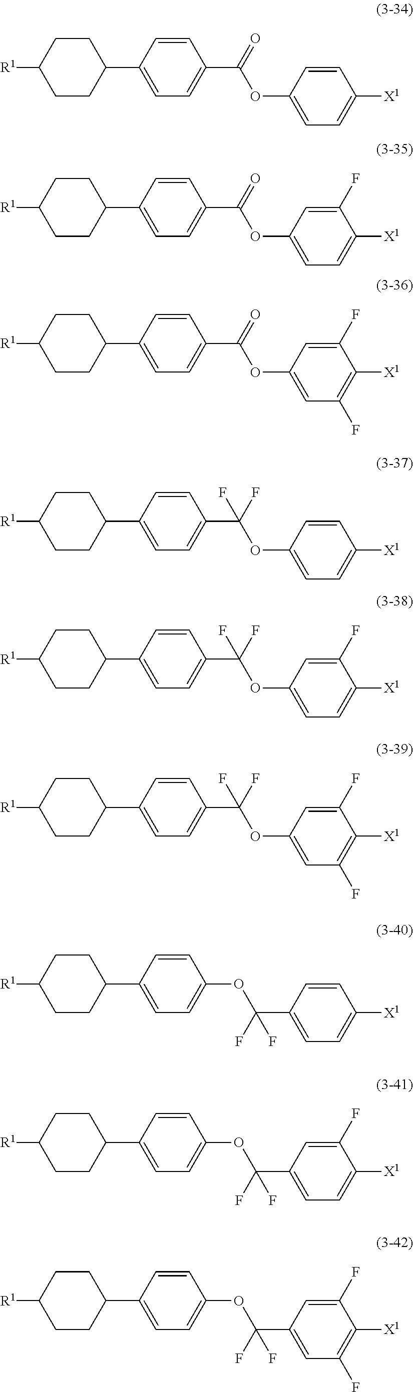

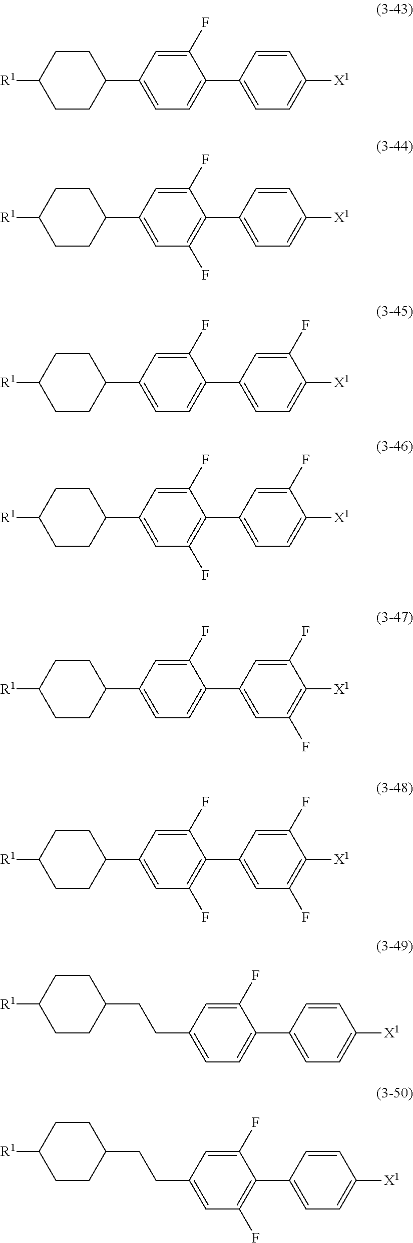

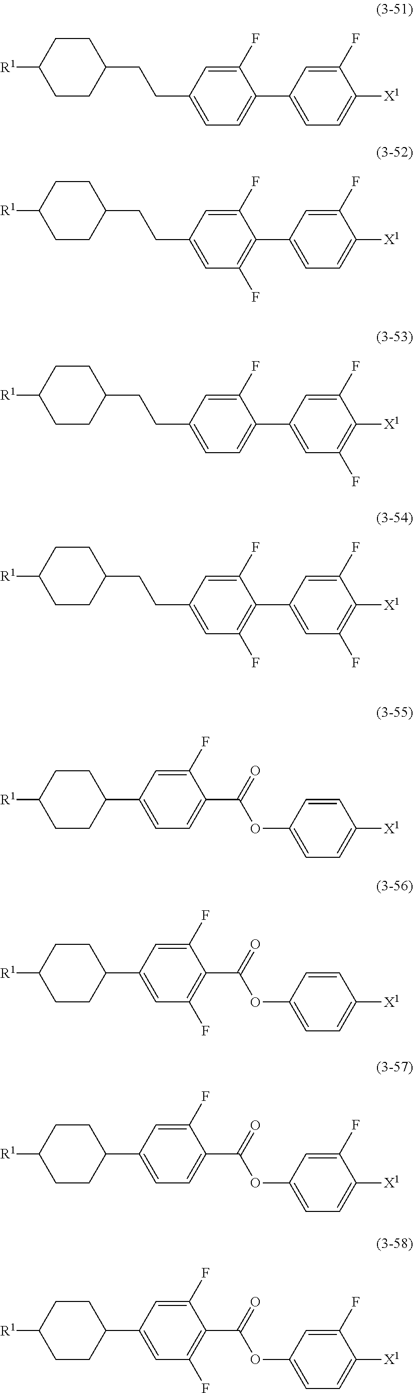

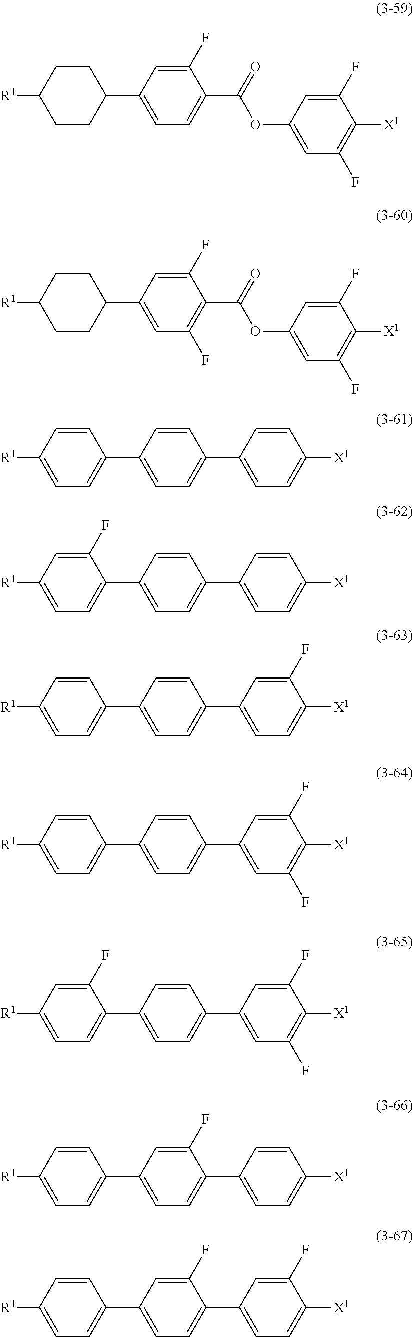

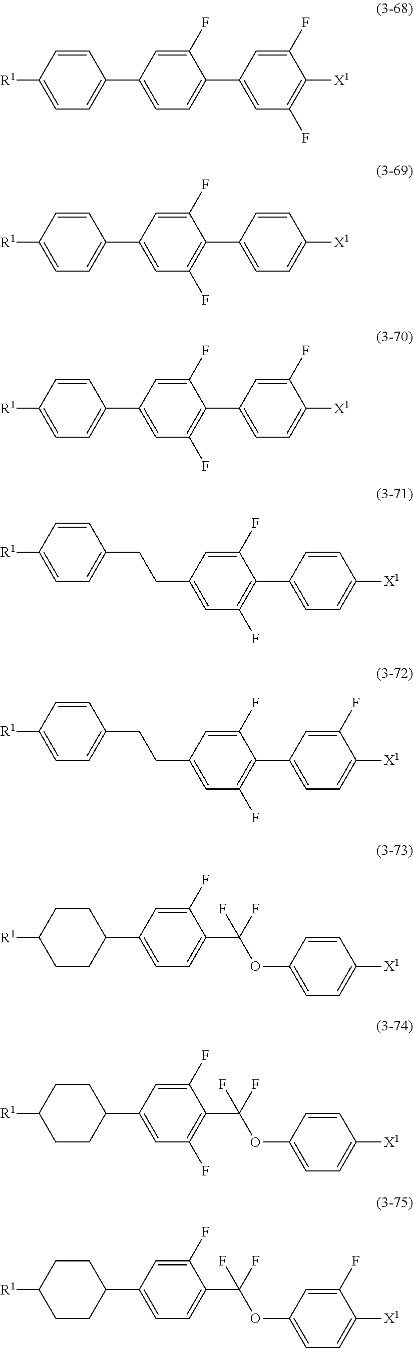

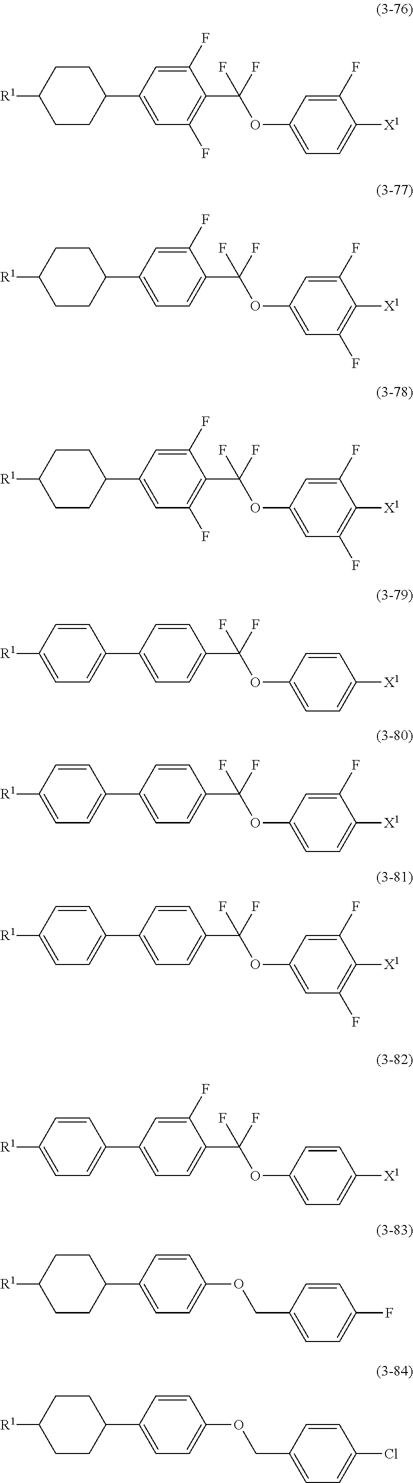

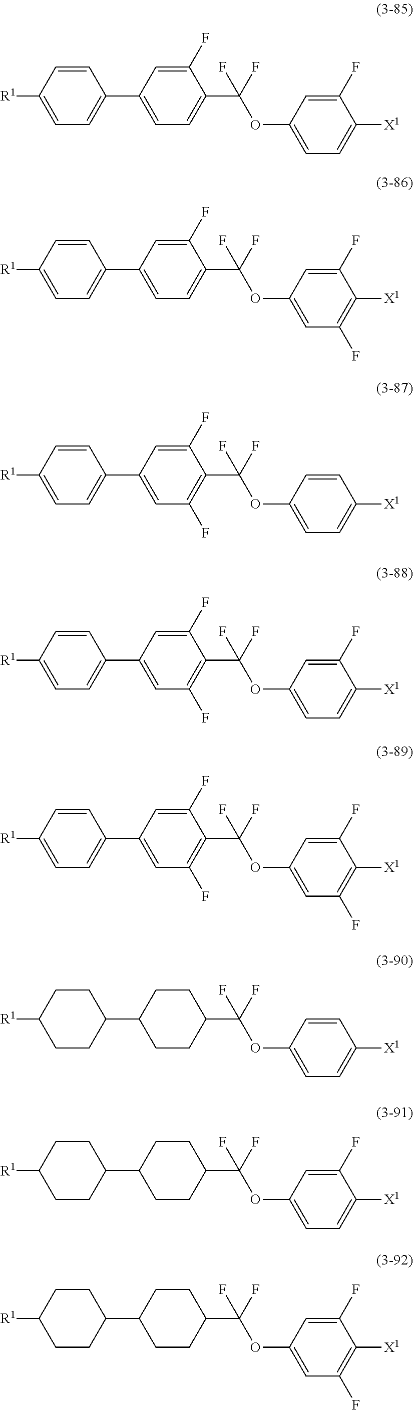

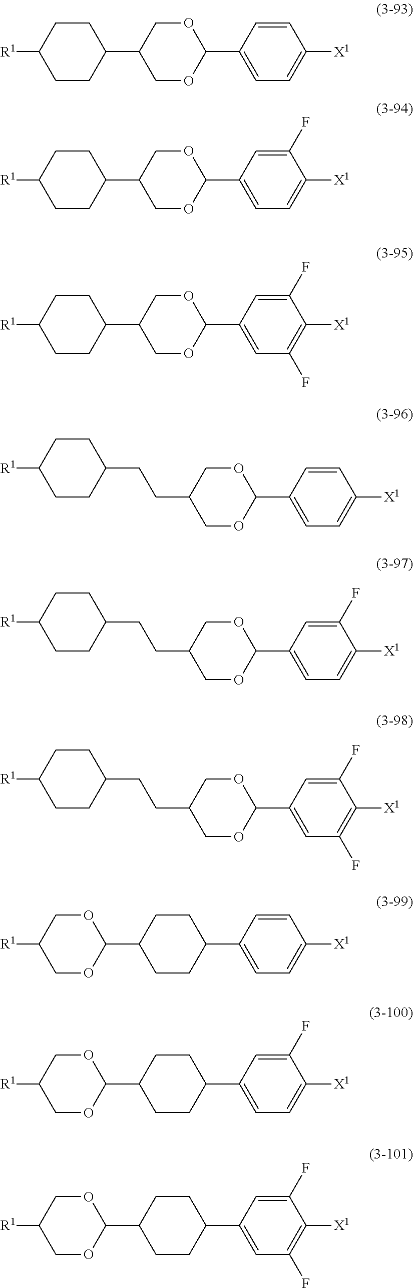

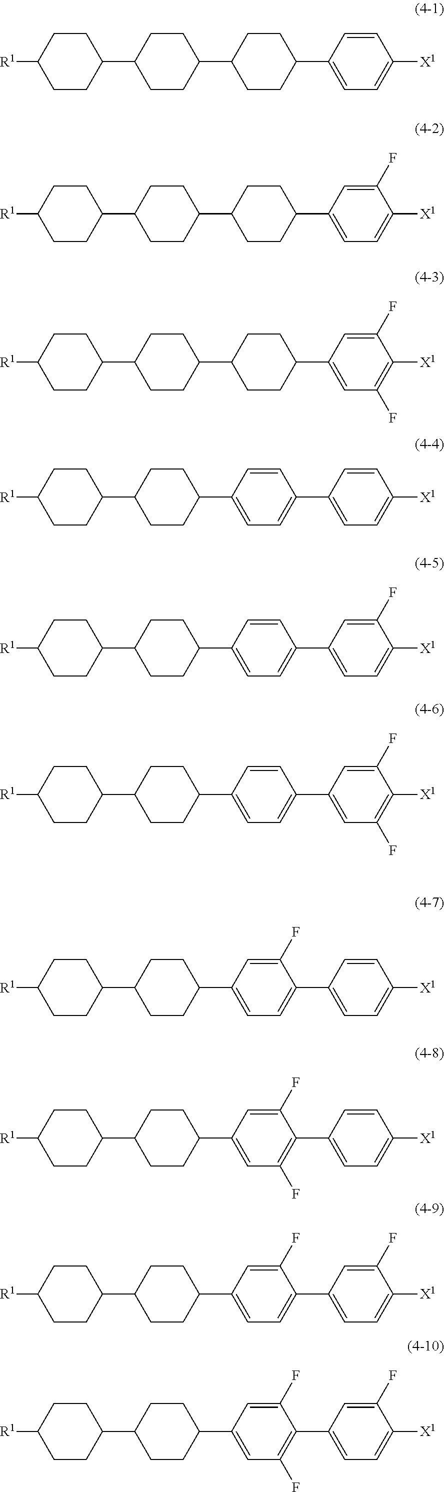

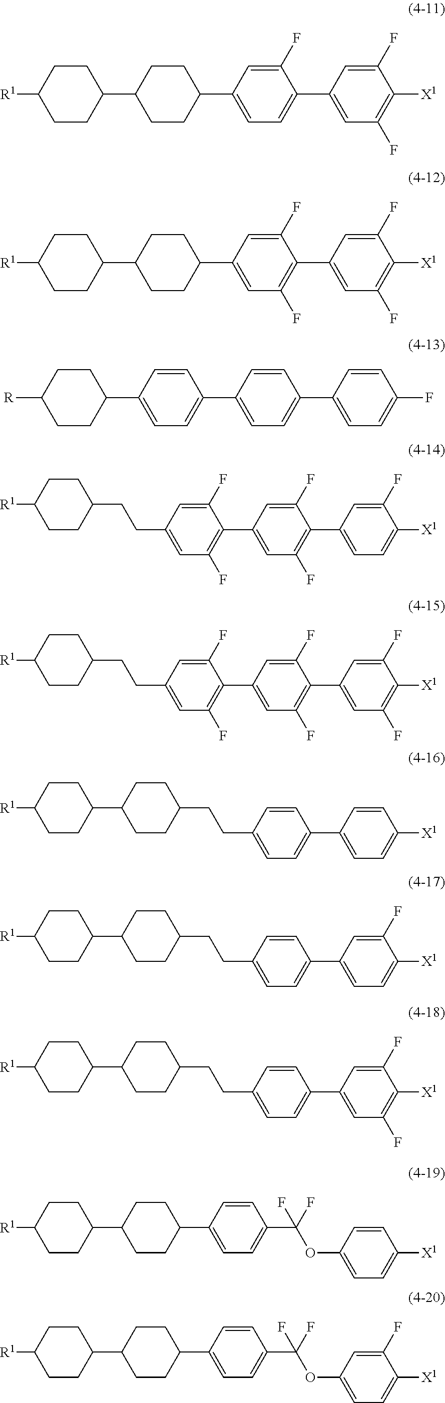

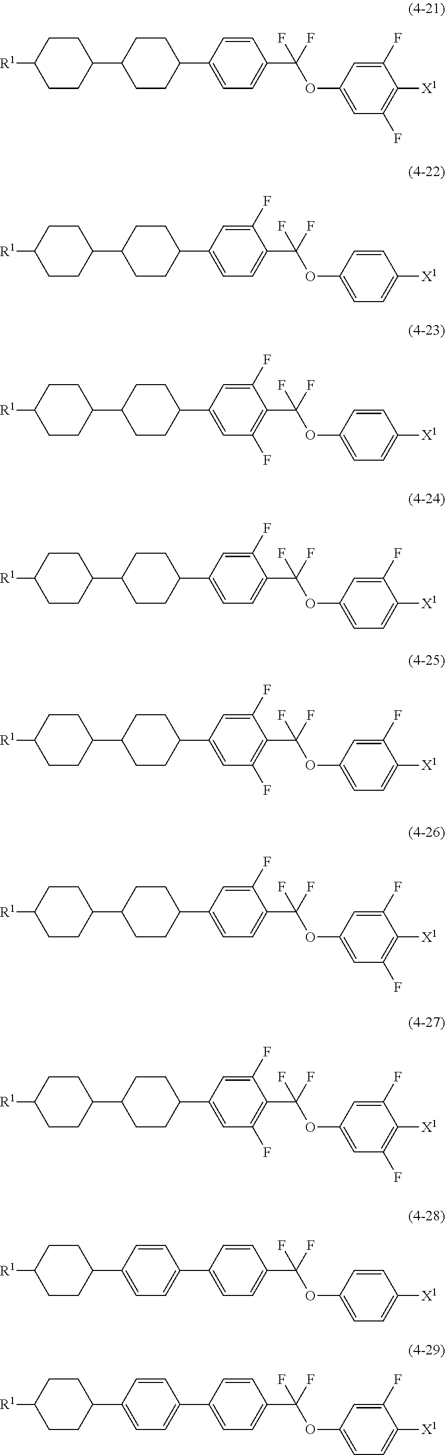

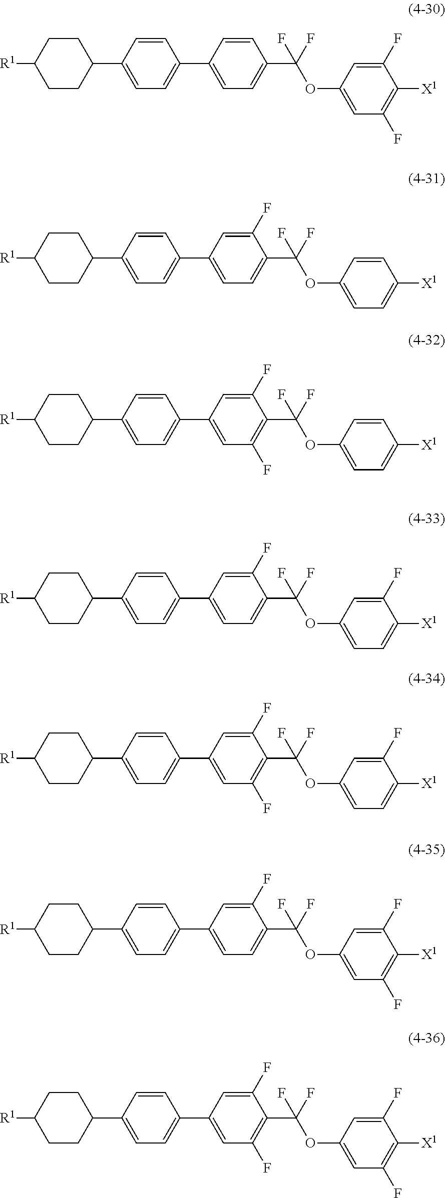

Component A has a positive value of dielectric anisotropy and an exceptional thermal stability or chemical stability, and therefore is used when the liquid crystal composition for TFT is prepared. Content of component B in the liquid crystal composition of the invention is appropriately in the range of 1 to 99% by weight, preferably, in the range of 10 to 97% by weight, further preferably, in the range of 40 to 95% by weight based on the total weight of the liquid crystal composition.

### 3.3 Compounds Represented by Formula (5) and Formula (6) (Component B)

In formula (5) and formula (6), R² and R³ are independently alkyl having 1 to 10 carbons, and in the alkyl, arbitrary —CH₂— may be replaced by —O— or —CH═CH—, and arbitrary hydrogen may be replaced by fluorine. R² and R³ are preferably alkyl or alkoxy having 1 to 10 carbons, or alkenyl or alkynyl having 2 to 10 carbons.

In formula (5) and formula (6), X² is —CN or —C≡C—CN. Ring G is 1,4-cyclohexylene, 1,4-phenylene, 1,3-dioxane-2,5-diyl or pyrimidine-2,5-diyl, ring J is 1,4-cyclohexylene, pyrimidine-2,5-diyl, or 1,4-phenylene in which arbitrary hydrogen may be replaced by fluorine, and ring K is 1,4-cyclohexylene, pyrimidine-2,5-diyl, pyridine-2,5-diyl, or 1,4-phenylene. Component B preferably contains a large mount of aromatic rings within the range where liquid crystallinity is not adversely affected because a value of Δn and Δ∈ can be increased by increasing polarizability anisotropy to conform with an object of the invention.

In formula (5) and formula (6), Z³ and Z⁴ are —(CH₂)₂—, —COO—, —CF₂O—, —OCF₂—, —C≡C—, —(C≡C)₂—, —(C≡C)₃—, —CH═CH—, —CH₂O—, —CH═CH—COO— or a single bond. Component B preferably contains —COO—, —CF₂O—, —C≡C—, —(C≡C)₂—, —(C≡C)₃—, —(CH═CH)₂— or —CH═CH—COO— in view of increasing polarizability anisotropy.

In formula (5) and formula (6), L³, L⁴ and L⁵ are independently hydrogen or fluorine; and a, b, c and d are independently 0 or 1.

The compounds represented by formula (5) and formula (6), more specifically, formula (5-1) to formula (5-101) and formula (6-1) to formula (6-6) can be suitably used in the invention. In the formulas, R², R³ and X² are identically defined as described above, and R′ represents alkyl having 1 to 7 carbons.

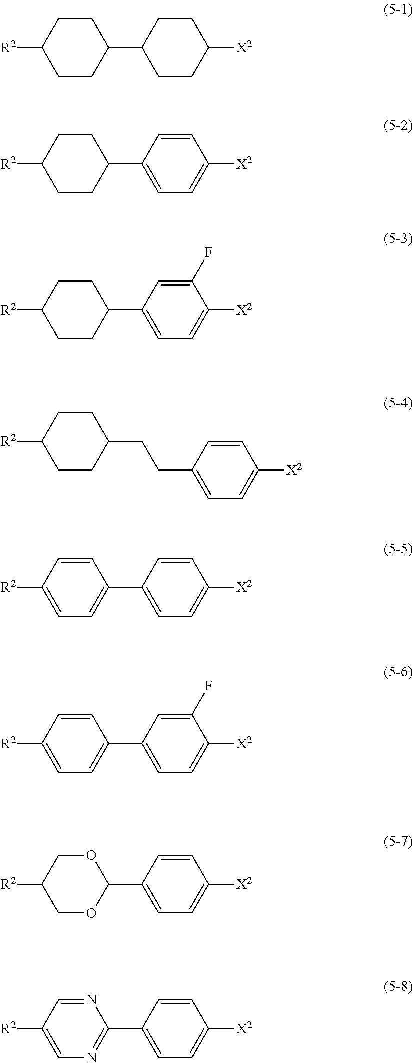

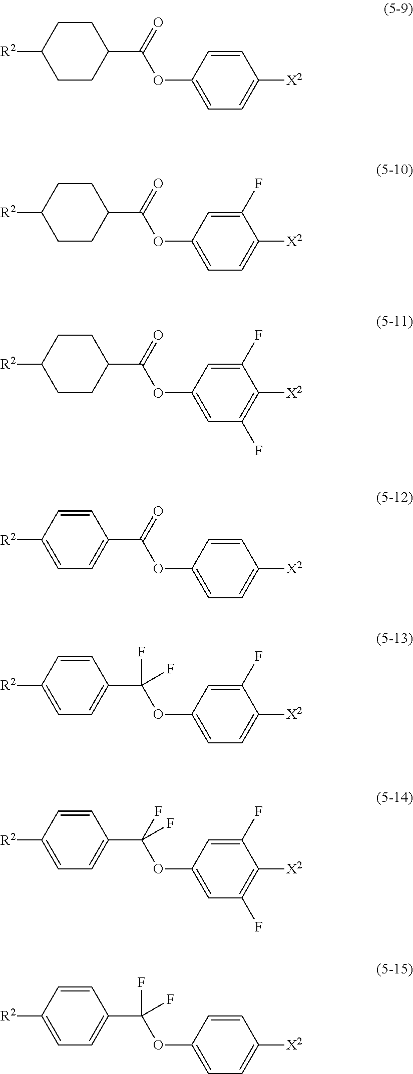

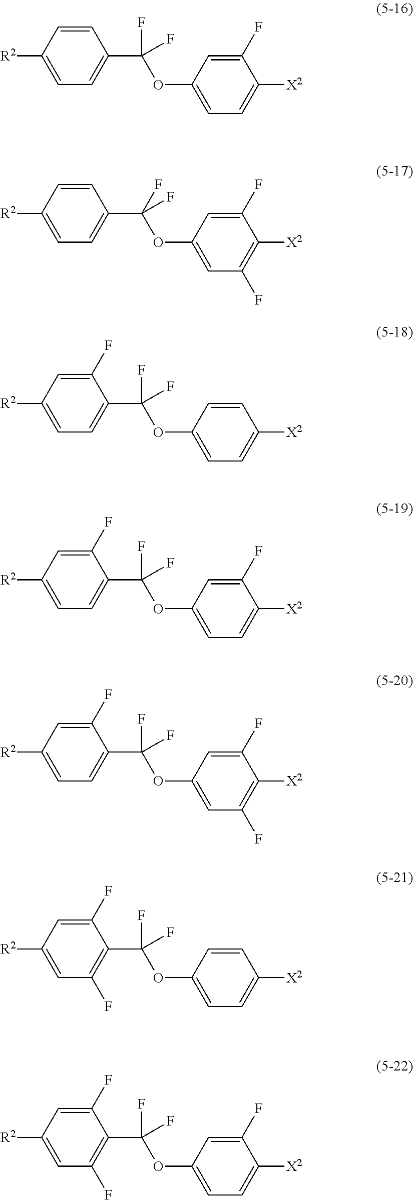

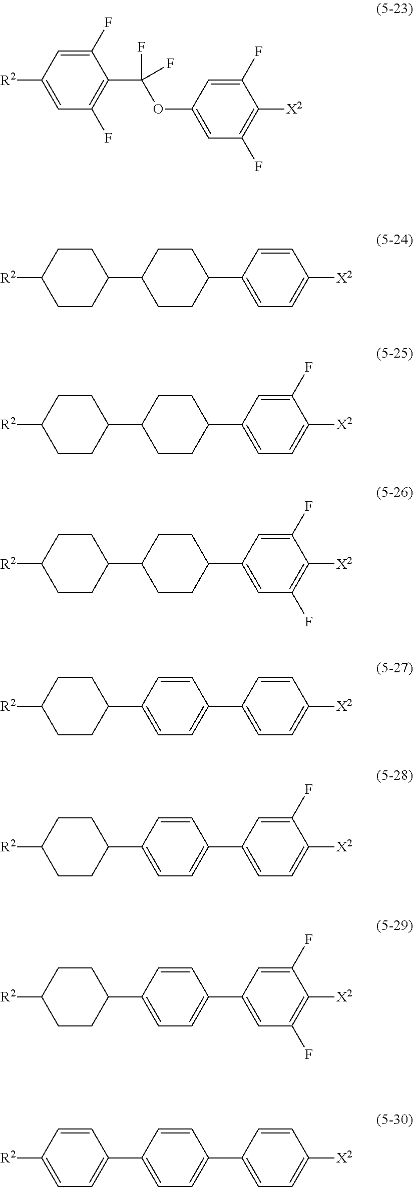

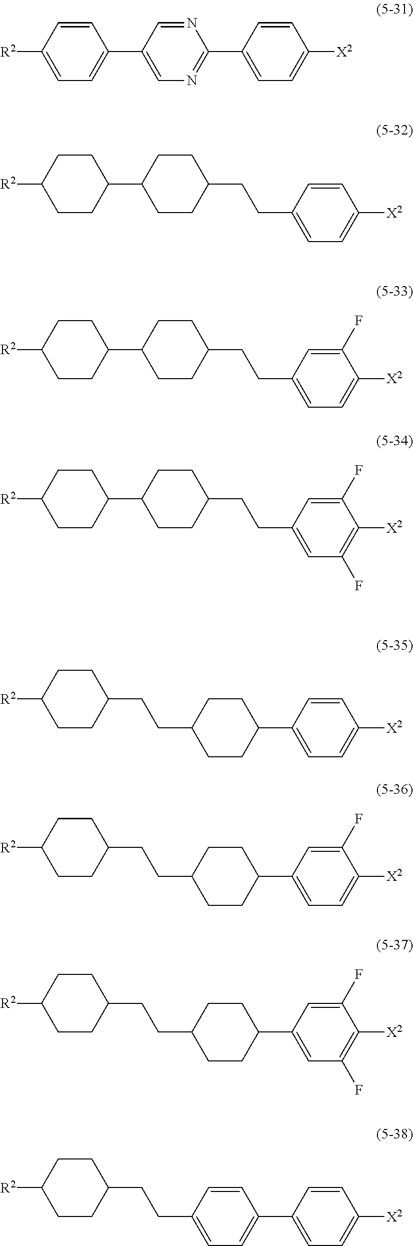

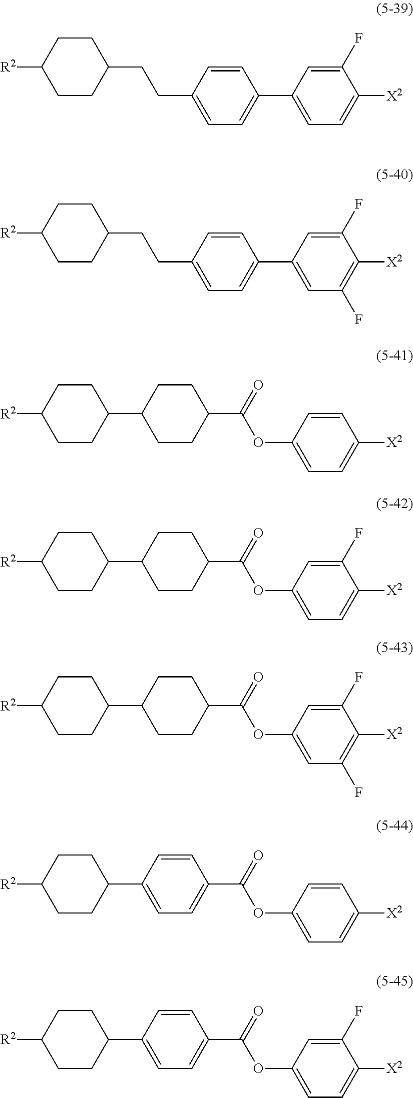

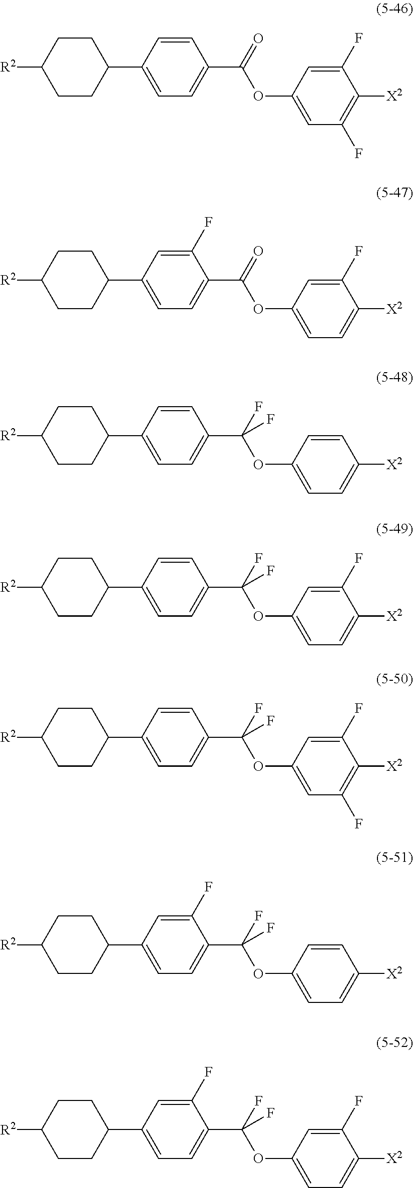

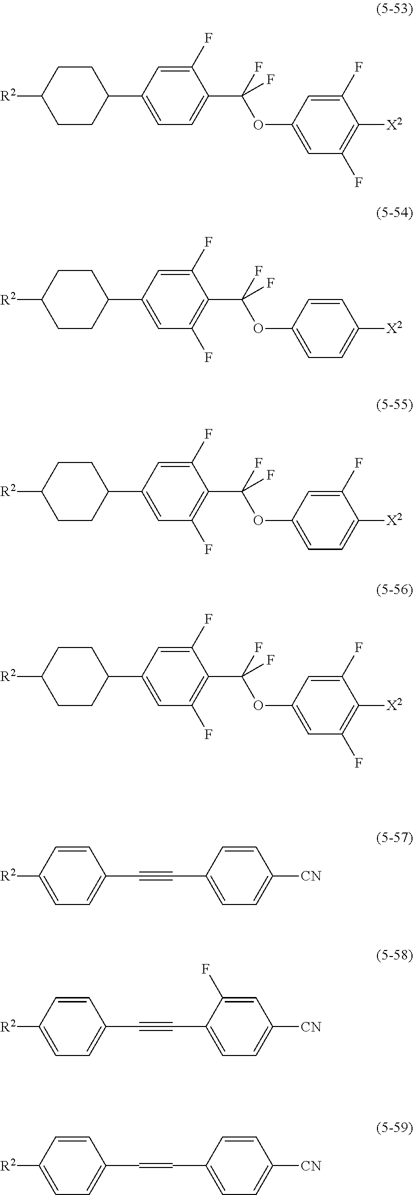

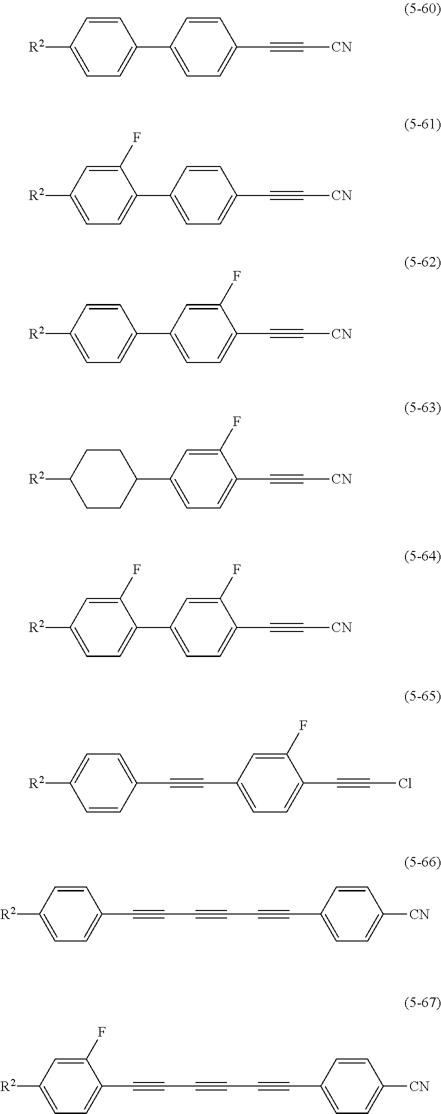

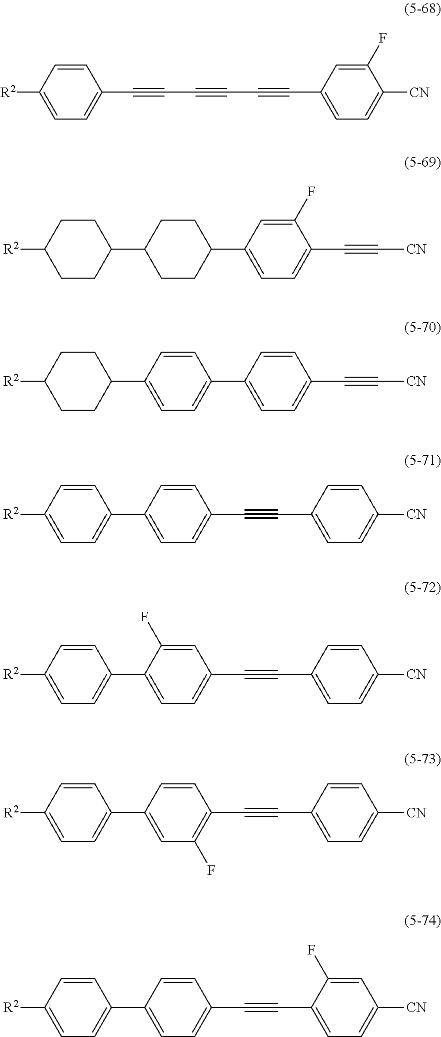

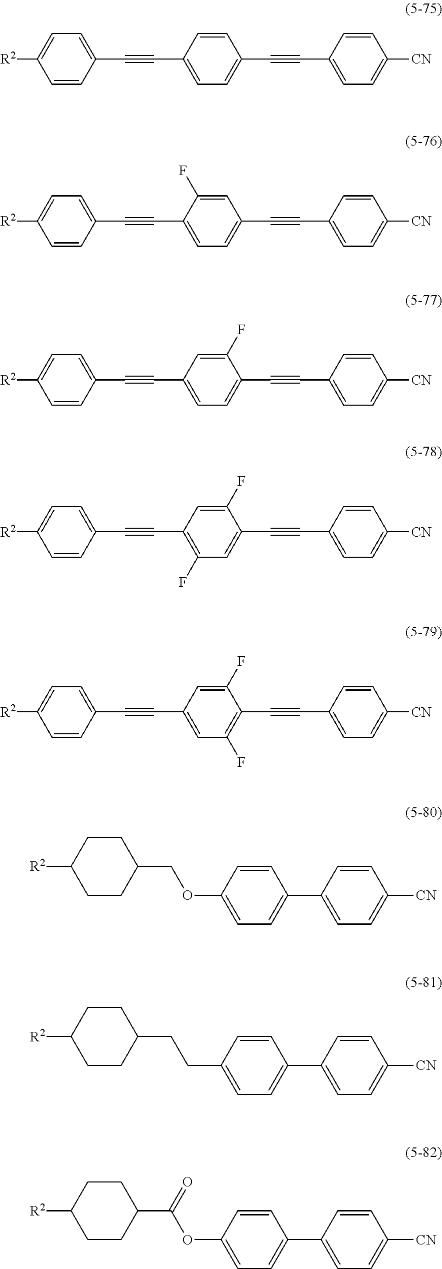

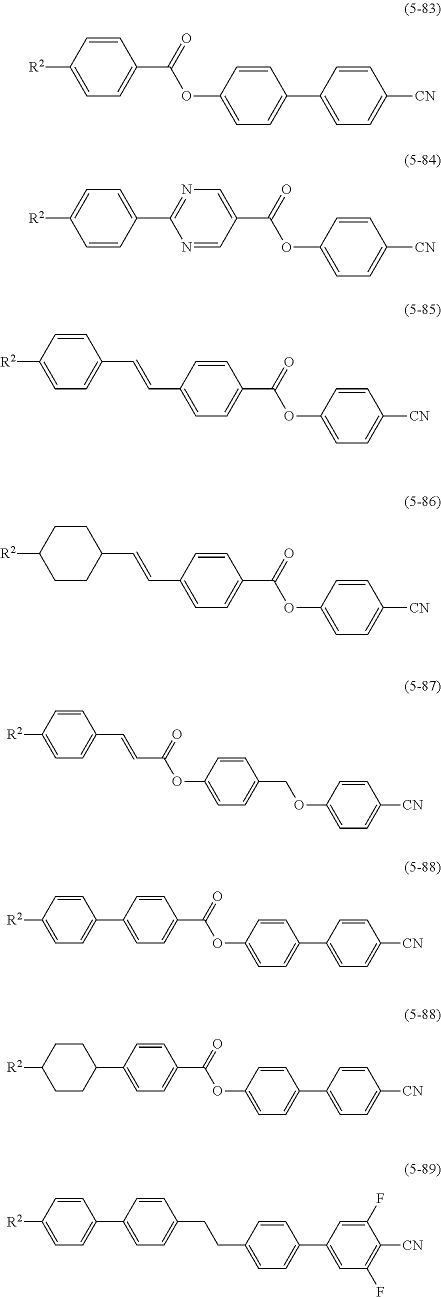

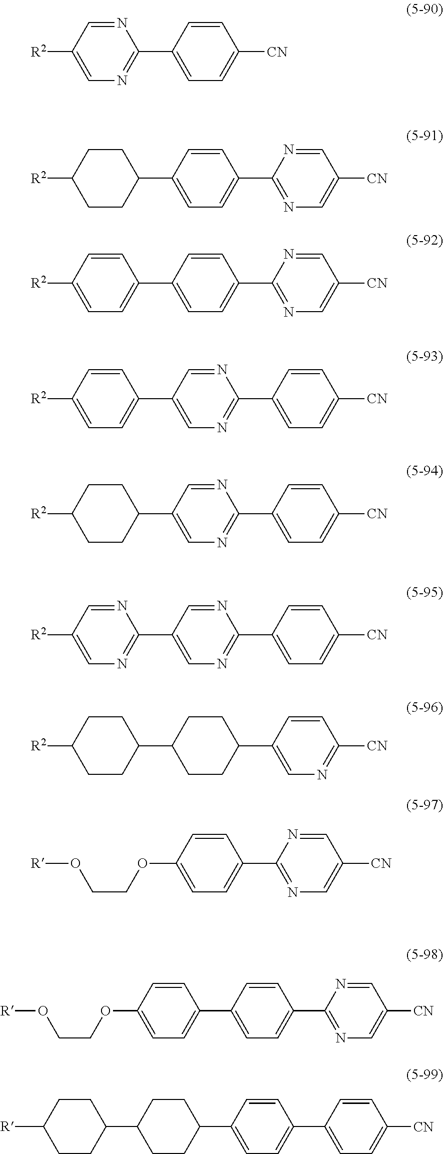

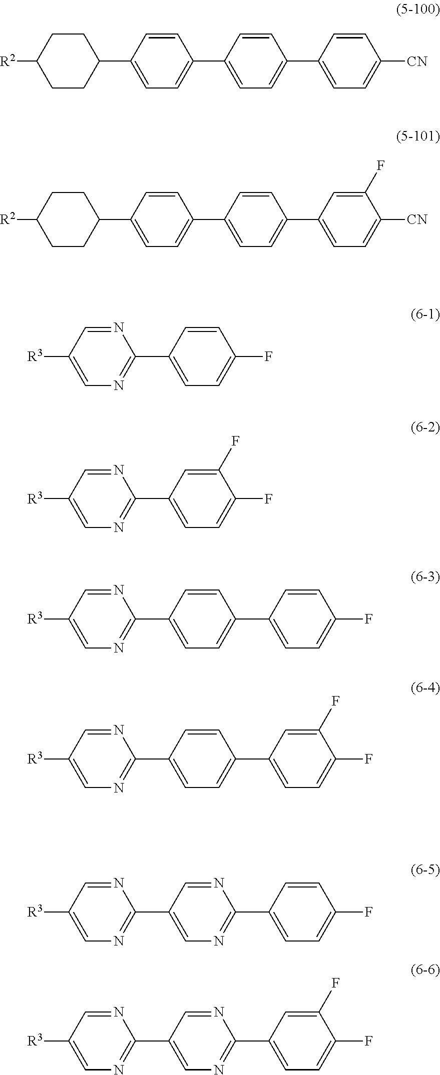

Component B has a positive value of dielectric anisotropy with a very large absolute value. Composition drive voltage can be decreased by allowing the component B to contain in the composition. Moreover, a range of adjusting viscosity and a value of refractive index anisotropy, and a temperature range of a liquid crystal phase can be extended.

Content of component B is preferably in the range of 0.1 to 99.9% by weight, further preferably, in the range of 10 to 97% by weight, still further preferably, in the range of 40 to 95% by weight based on the total weight of the liquid crystal composition. Moreover, threshold voltage, the temperature range of the liquid crystal phase, a value of refractive index anisotropy, a value of dielectric anisotropy, viscosity or the like can be adjusted by mixing the component as described later.

### 3.4 Compounds Represented by Formula (7) to Formula (12) (Component C)

In formula (7) to formula (12), R⁴ and R⁵ are independently alkyl having 1 to 10 carbons, and in the alkyl, arbitrary —CH₂— may be replaced by —O— or —CH═CH—, and arbitrary hydrogen may be replaced by fluorine, or R⁵ may be fluorine, but preferably alkyl or alkoxy having 1 to 10 carbons, or alkenyl or alkynyl having 2 to 10 carbons.

In formula (7) to formula (12), ring M and ring P are independently 1,4-cyclohexylene, 1,4-phenylene, naphthalene-2,6-diyl or octahydronaphthalene-2,6-diyl. Component C preferably contains a large amount of aromatic rings within the range where liquid crystallinity is not adversely affected because a value of Δn and Δ∈ can be increased. Ring W is independently W1 to W15, and W2 to W8, W10, and W12 to W15 are chemically more stable and thus preferred.

In formula (7) to formula (12), Z⁵ and Z⁶ are independently —(CH₂)₂—, —COO—, —CH═CH—, —C≡C—, —(C≡C)₂—, —(C≡C)₃—, —S—CH₂CH₂—, —SCO— or a single bond. Component C preferably contains —CH═CH—, —C≡C—, —(C≡C)₂— and —(C≡C)₃— in view of increasing a value of Δn and Δ∈.

In formula (7) to formula (12), L⁶ and L⁷ are independently hydrogen or fluorine, and at least one of L⁶ and L⁷ is fluorine. Component C preferably contains much of fluorine within the range where liquid crystallinity is not adversely affected because a value of Δ∈ can be increased.

The compounds represented by any of formula (7) to formula (12), more specifically, formula (7-1) to formula (7-4), formula (8-1) to formula (8-6), formula (9-1) to formula (9-4), formula (10-1), formula (11-1), and formula (12-1) to formula (12-26) can be suitably used in the invention. In the formulas, R⁴ and R⁵ are identically defined as represented above.

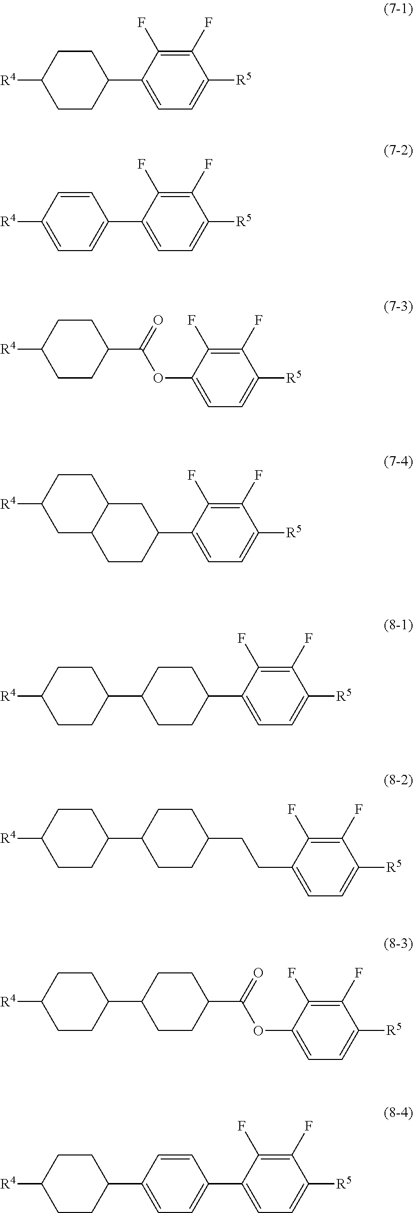

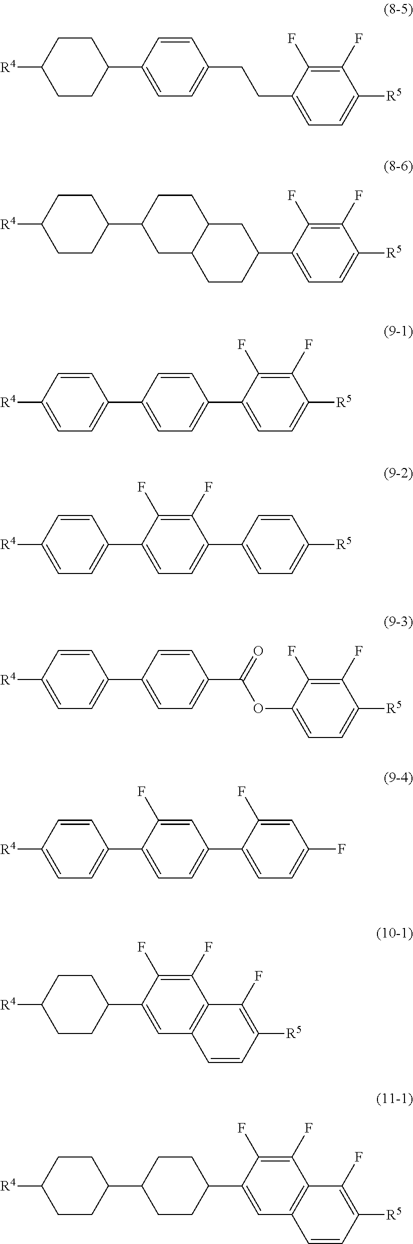

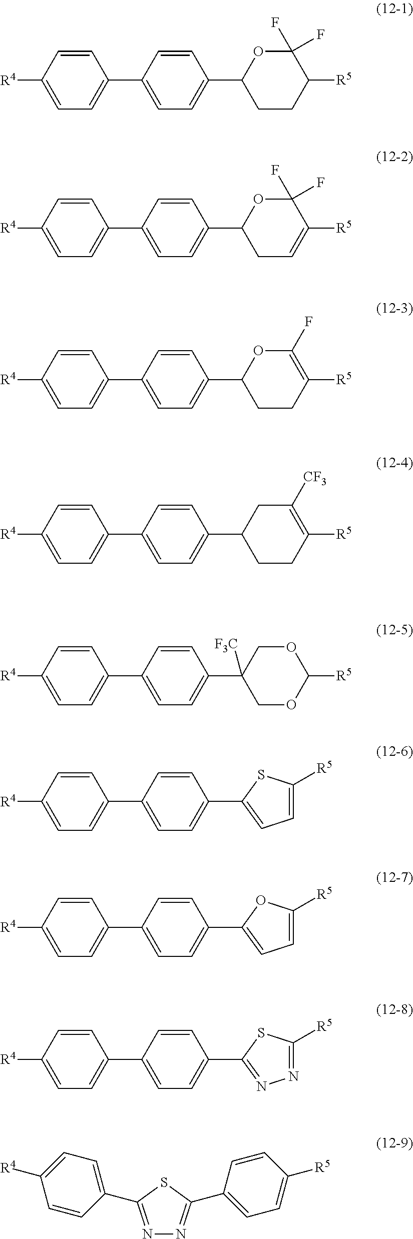

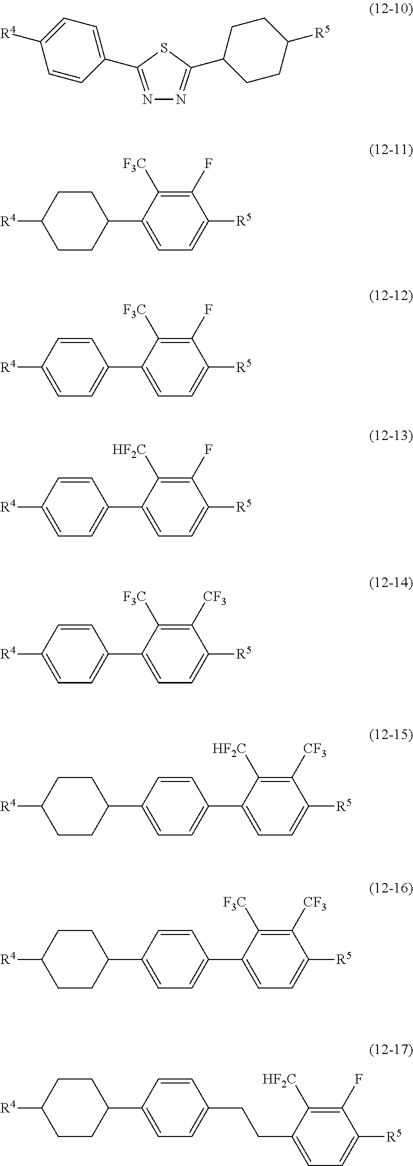

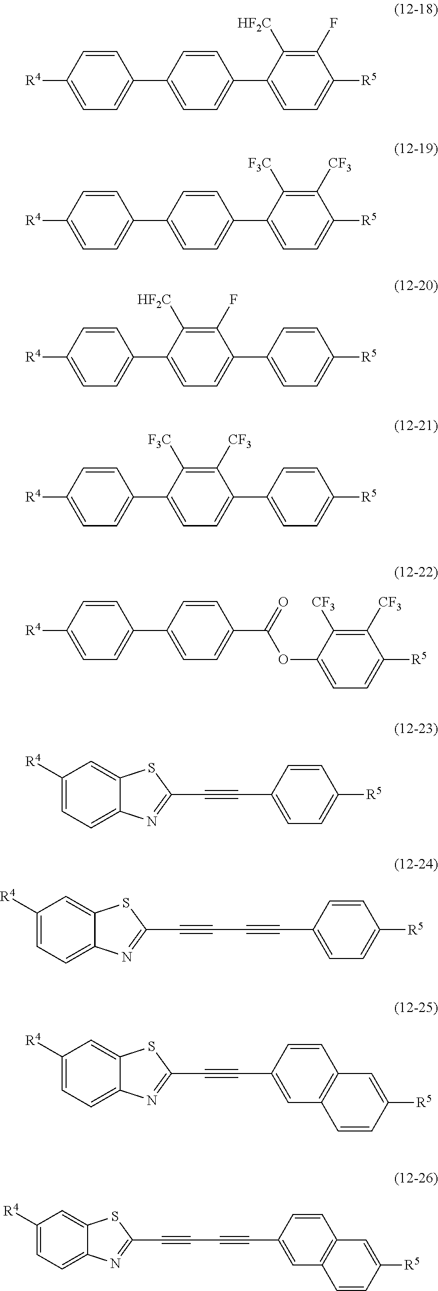

Component C has a negative value of dielectric anisotropy with a very large absolute value. Composition drive voltage can be decreased by allowing the component C to contain in the composition. Moreover, a range of adjusting viscosity and a value of refractive index anisotropy, and a temperature range of the liquid crystal phase can be extended.

Content of component C is preferably in the range of 0.1 to 99.9% by weight, further preferably, in the range of 10 to 97% by weight, still further preferably, in the range of 40 to 95% by weight based on the total weight of the liquid crystal composition. Moreover, threshold voltage, the temperature range of the liquid crystal phase, a value of refractive index anisotropy, a value of dielectric anisotropy, viscosity or the like can be adjusted by mixing the component as described later.

### 3.5 Compounds Represented by Formula (13) to Formula (15) (Component D)

In formula (13) to formula (15), R⁶ and R⁷ are independently hydrogen or alkyl having 1 to 10 carbons, and in the alkyl, arbitrary —CH₂— may be replaced by —O—, —CH═CH— or —C≡C—, and arbitrary hydrogen may be replaced by fluorine, but preferably alkyl or alkoxy having 1 to 10 carbons, or alkenyl or alkynyl having 2 to 10 carbons.

In formula (13) to formula (15), ring Q, ring T and ring U are independently 1,4-cyclohexylene, pyridine-2,5-diyl or pyrimidine-2,5-diyl, or 1,4-phenylene in which arbitrary hydrogen may be replaced by fluorine. Compound D preferably contains a large mount of aromatic rings within the range where liquid crystallinity is not adversely affected because a value of Δn and Δ∈ can be increased.

In formula (13) to formula (15), Z⁷ and Z⁸ are independently —C≡C—, —(C≡C)₂—, —(C≡C)₃—, —CH═CH—C≡C—, —C≡C—CH═CH—C≡C—, —C≡C—(CH₂)₂—C≡C—, —CH₂O—, —COO—, —(CH₂)₂—, —CH═CH— or a single bond. Compound D preferably contains —CH═CH—, —C≡C—, —(C≡C)₂— or —(C≡C)₃— in view of increasing polarizability anisotropy.

The compounds represented by any of formula (13) to formula (15), more specifically, formula (13-1) to formula (13-23), formula (14-1) to formula (14-44), and formula (15-1) to formula (15-18) can be suitably used in the invention. In the formulas, R⁶, R⁷ and R′ are identically defined as represented above. L independently represents hydrogen or fluorine.

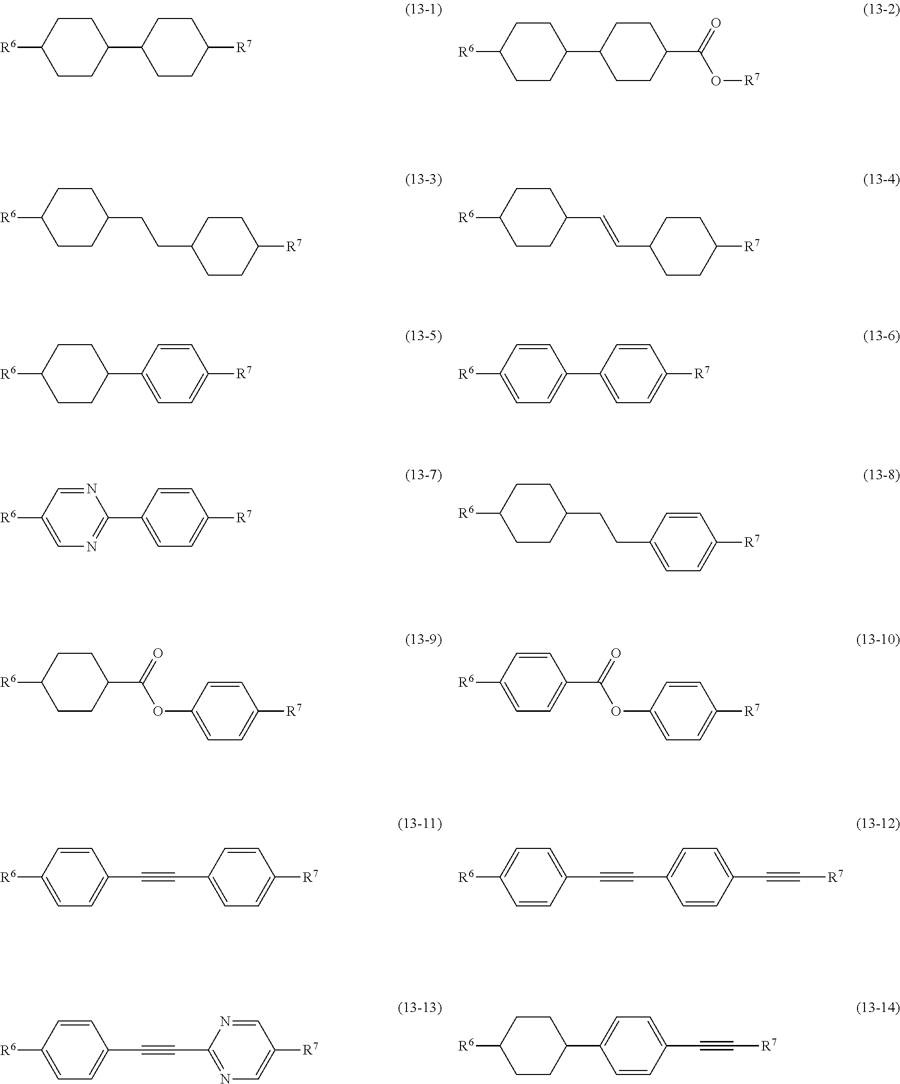

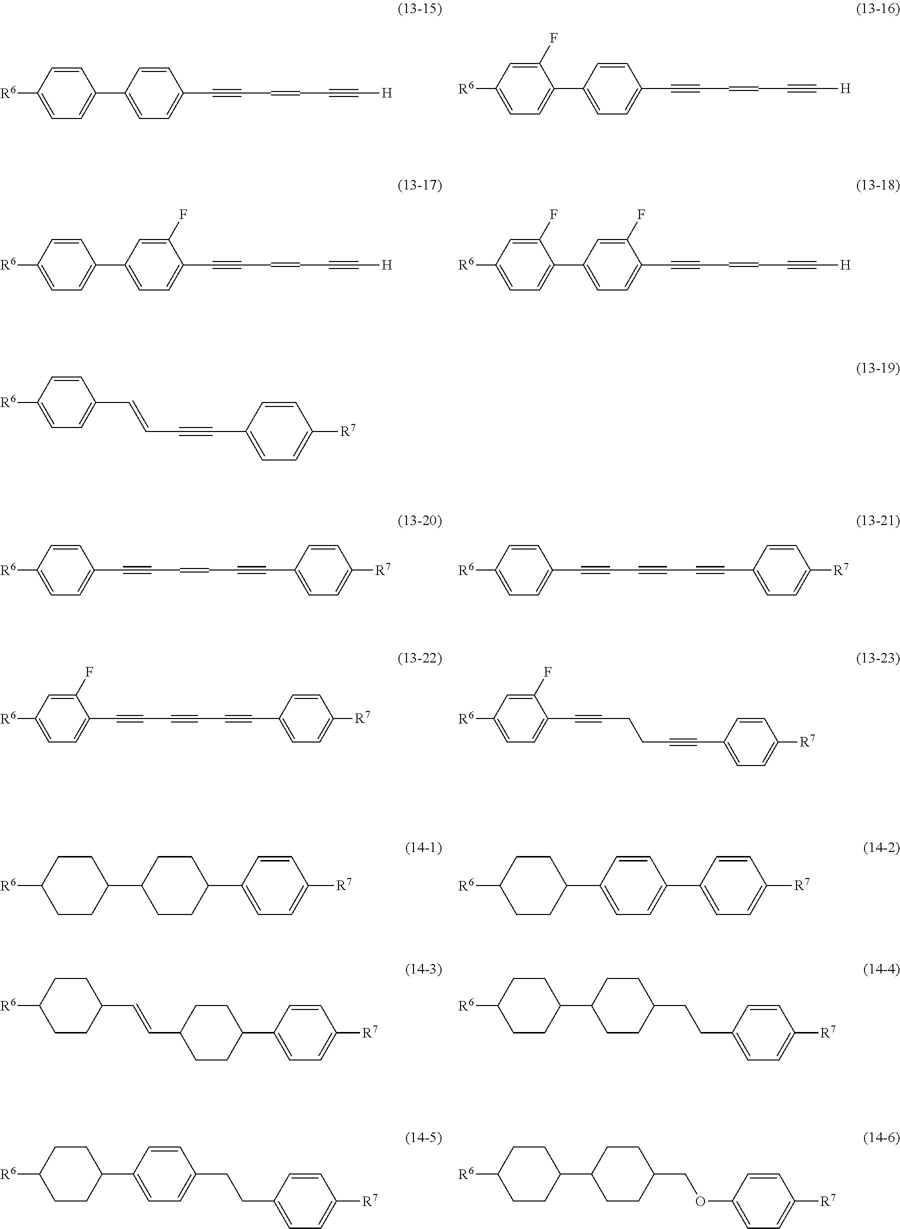

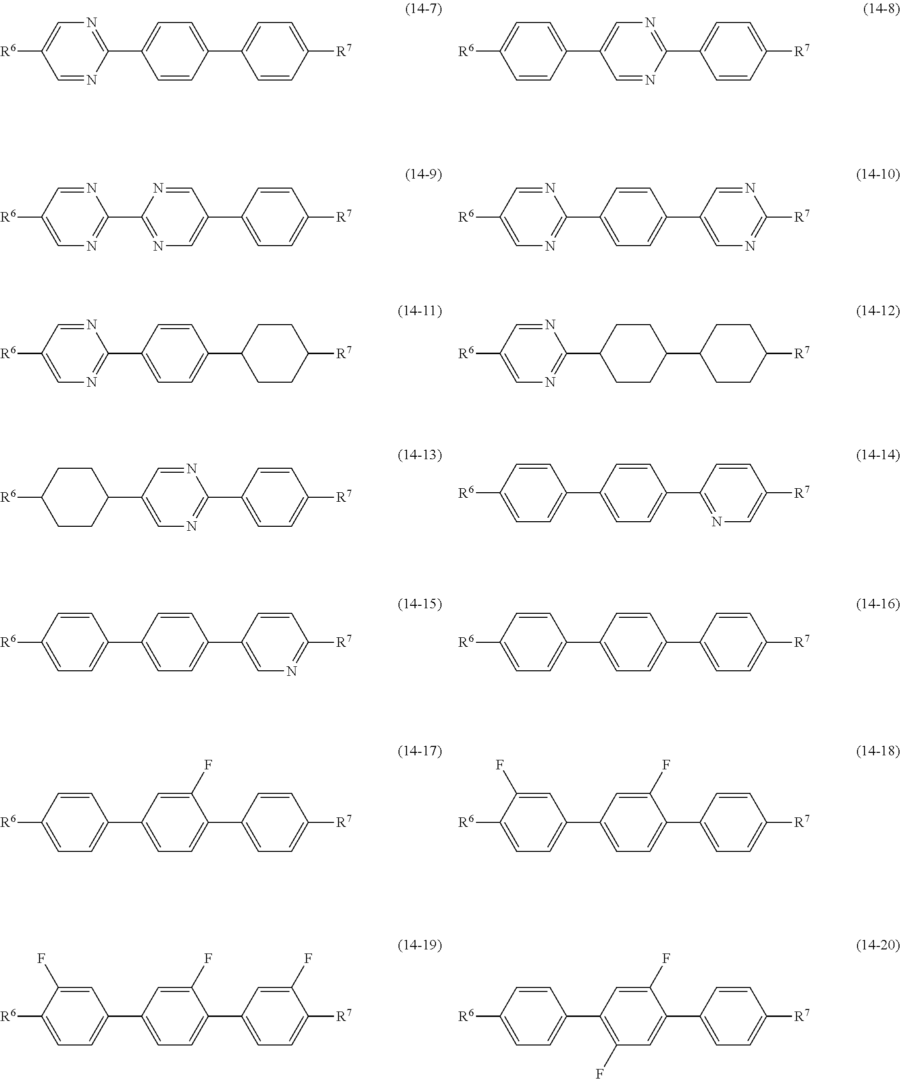

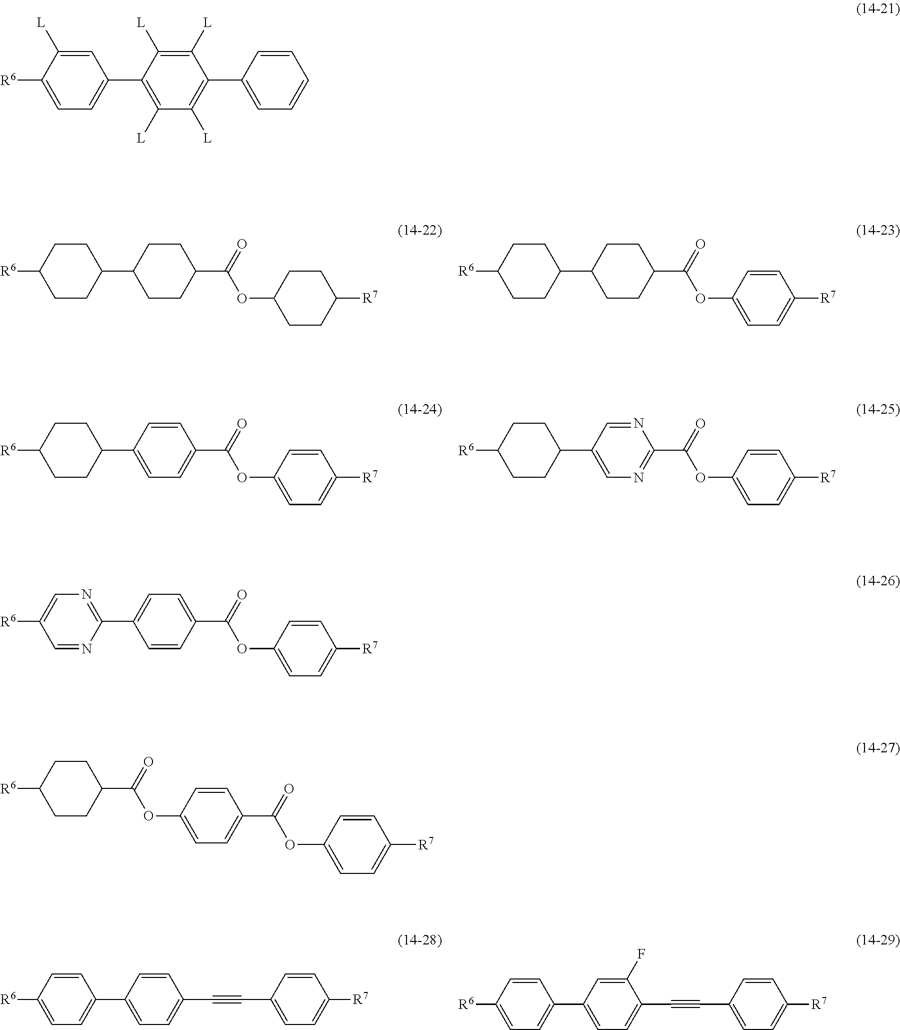

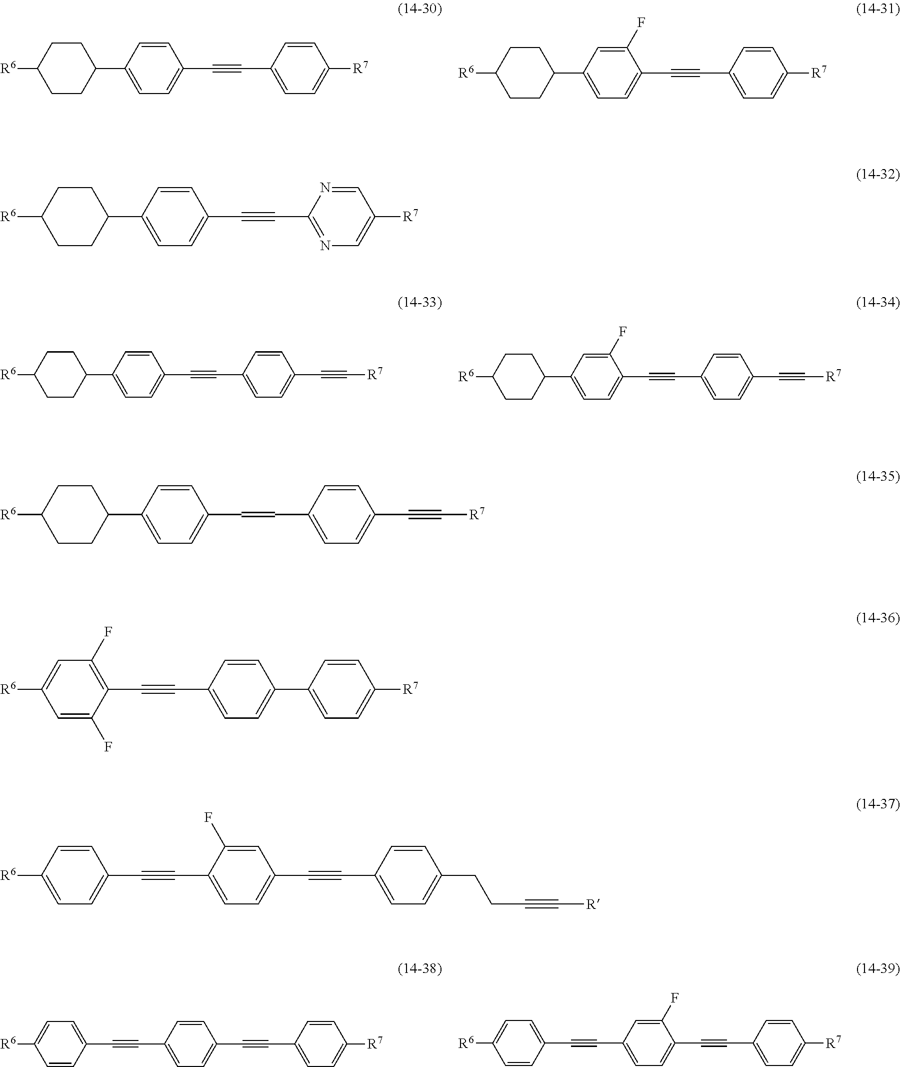

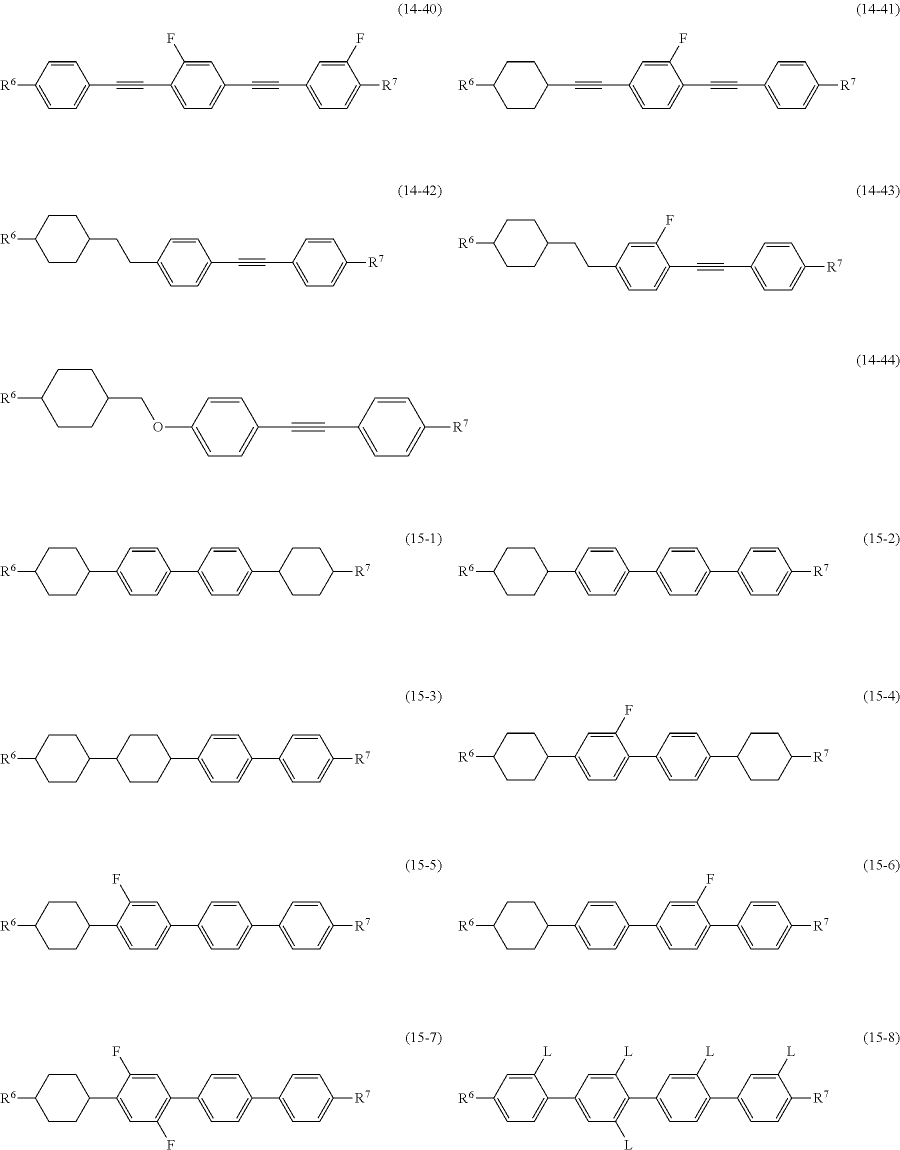

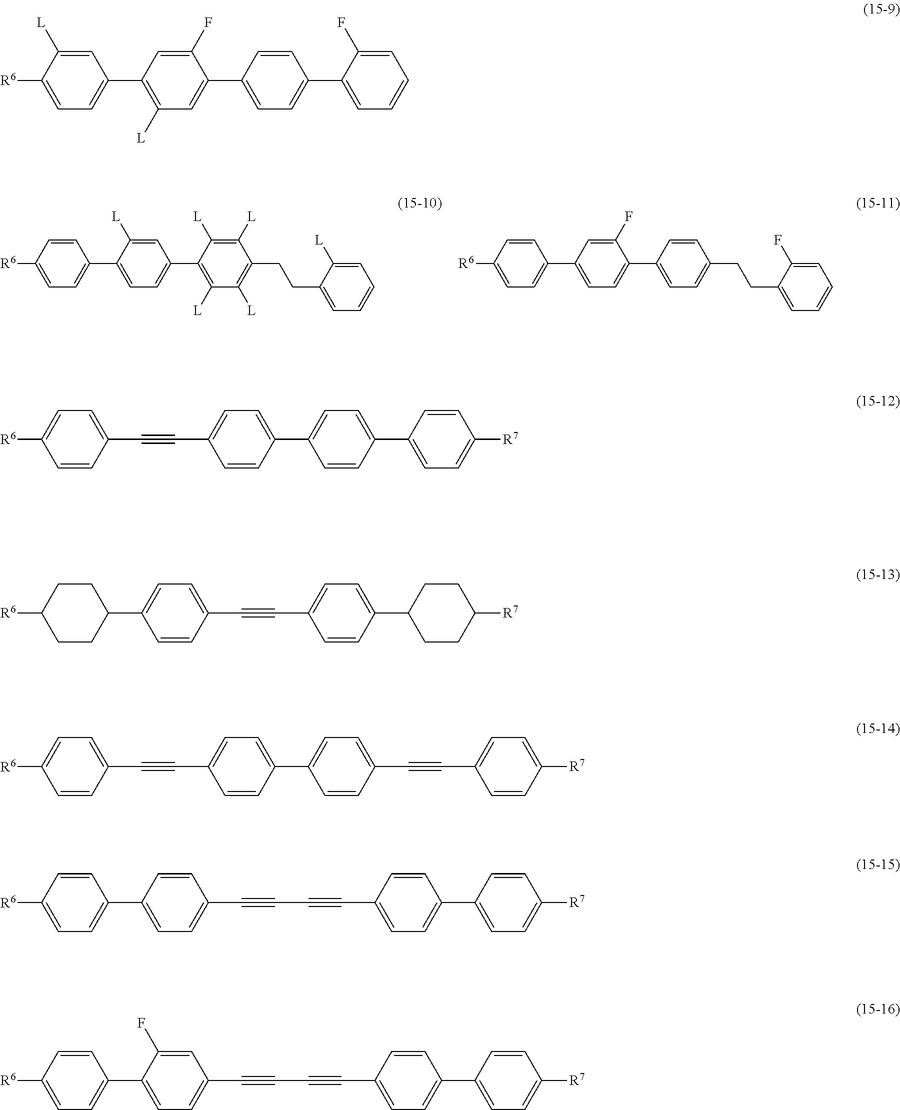

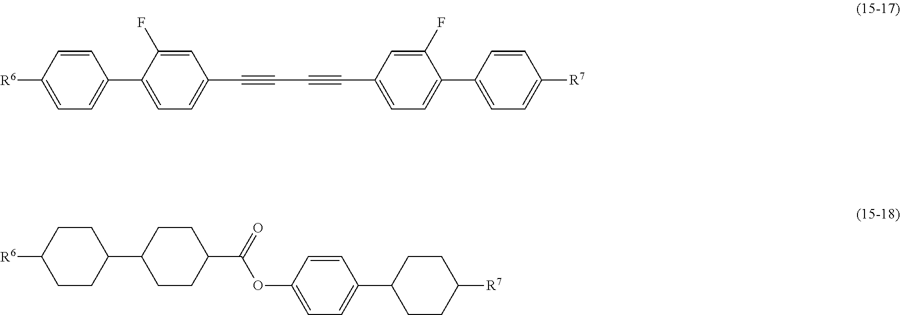

Compounds represented by formula (12) to formula (15) (component D) have a small absolute value of dielectric anisotropy, and are close to neutrality. Component D has an effect for extending a temperature range of an optically isotropic liquid crystal phase such as increasing a clearing point, or an effect on adjusting a value of refractive index anisotropy.

As content of component D is increased, drive voltage of the liquid crystal composition is increased and viscosity is decreased, and therefore the content is desirably higher as long as a required value of the drive voltage of the liquid crystal composition is provided. When preparing the liquid crystal composition for TFT, the content of component D is preferably 60% by weight or less, further preferably, 40% by weight or less based on the total weight of the liquid crystal composition.

### 3.6 Compounds Represented by Formula (16) to Formula (19) (Component E)

In formula (16) to formula (19), R⁸ is alkyl having 1 to 10 carbons, alkenyl having 2 to 10 carbons or alkynyl 2 to 10 carbons, and in the alkyl, the alkenyl and the alkynyl, arbitrary hydrogen may be replaced by fluorine, and arbitrary —CH₂— may be replaced by —O—.

In formula (16) to formula (19), X³ is fluorine, chlorine, —SF₅, —OCF₃, —OCHF₂, —CF₃, —CHF₂, —CH₂F, —OCF₂CHF₂ or —OCF₂CHFCF₃.

In formula (16) to formula (19), ring E¹, ring E², ring E³ and ring E⁴ are independently 1,4-cyclohexylene, 1,3-dioxane-2,5-diyl, pyrimidine-2,5-diyl, tetrahydropyran-2,5-diyl, 1,4-phenylene, naphthalene-2,6-diyl, or 1,4-phenylene in which arbitrary hydrogen is replaced by fluorine or chlorine, or naphthalene-2,6-diyl in which arbitrary hydrogen is replaced by fluorine or chlorine.

In formula (16) to formula (19), Z⁹, Z¹⁰ and Z¹¹ are independently —(CH₂)₂— —(CH₂)₄—, —COO—, —CF₂O—, —OCF₂—, —CH═CH—, —C≡C—, —CH₂O— or a single bond. However, when any one of ring E, ring E², ring E³ and ring E⁴ is 3-chloro-5-fluoro-1,4-phenylene, Z⁹, Z¹⁰ and Z¹¹ are not —CF₂O—.

In formula (16) to formula (19), L⁸ and L⁹ are independently hydrogen or fluorine.

Specific examples of suitable compounds represented by formula (16) to formula (19) include compounds represented by formula (16-1) to formula (16-8), formula (17-1) to formula (17-26), formula (18-1) to formula (18-22), and formula (19-1) to formula (19-5). In the formulas, R⁸ and X³ are identically defined as described above, (F) represents hydrogen or fluorine, and (F, Cl) represents hydrogen, fluorine or chlorine.

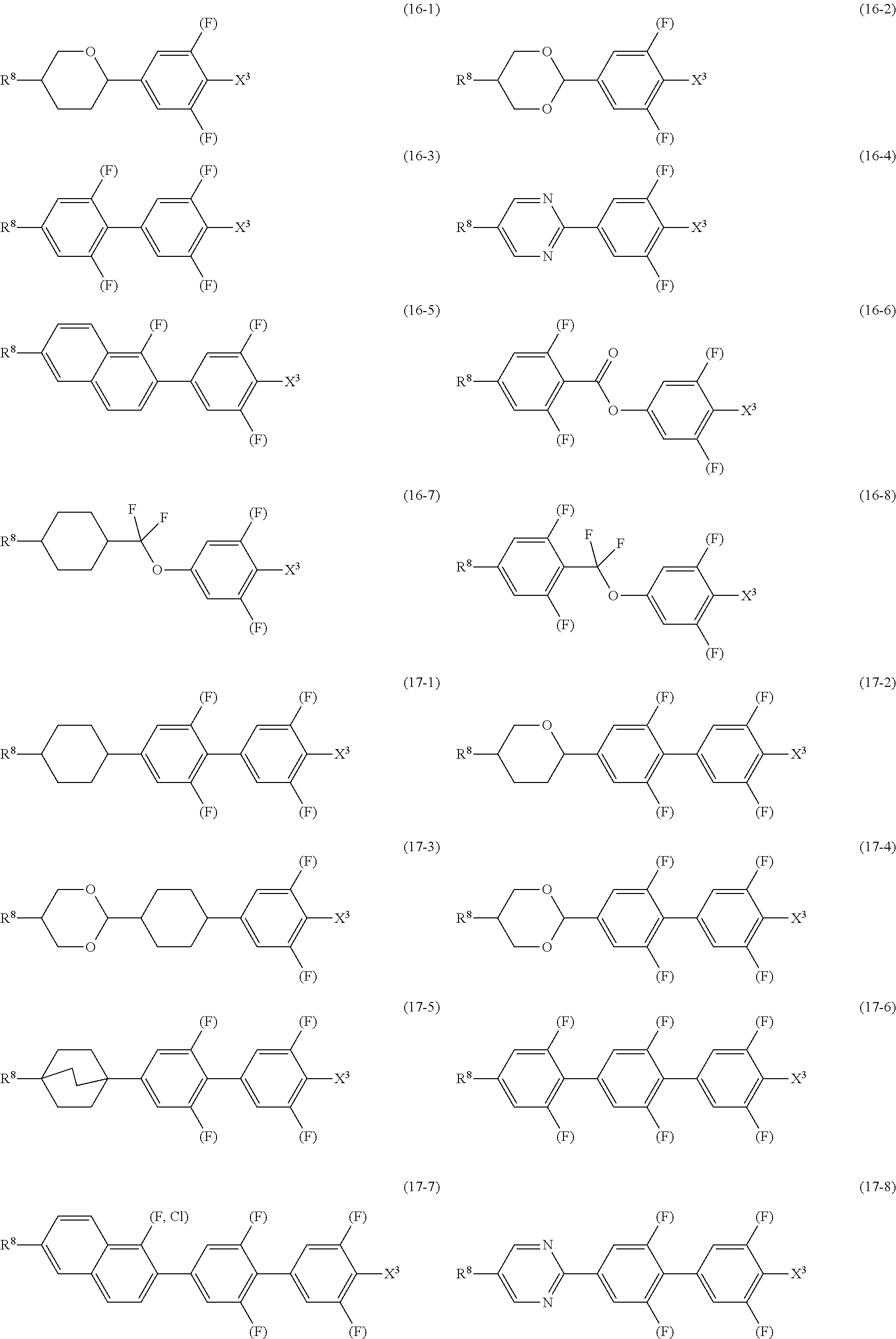

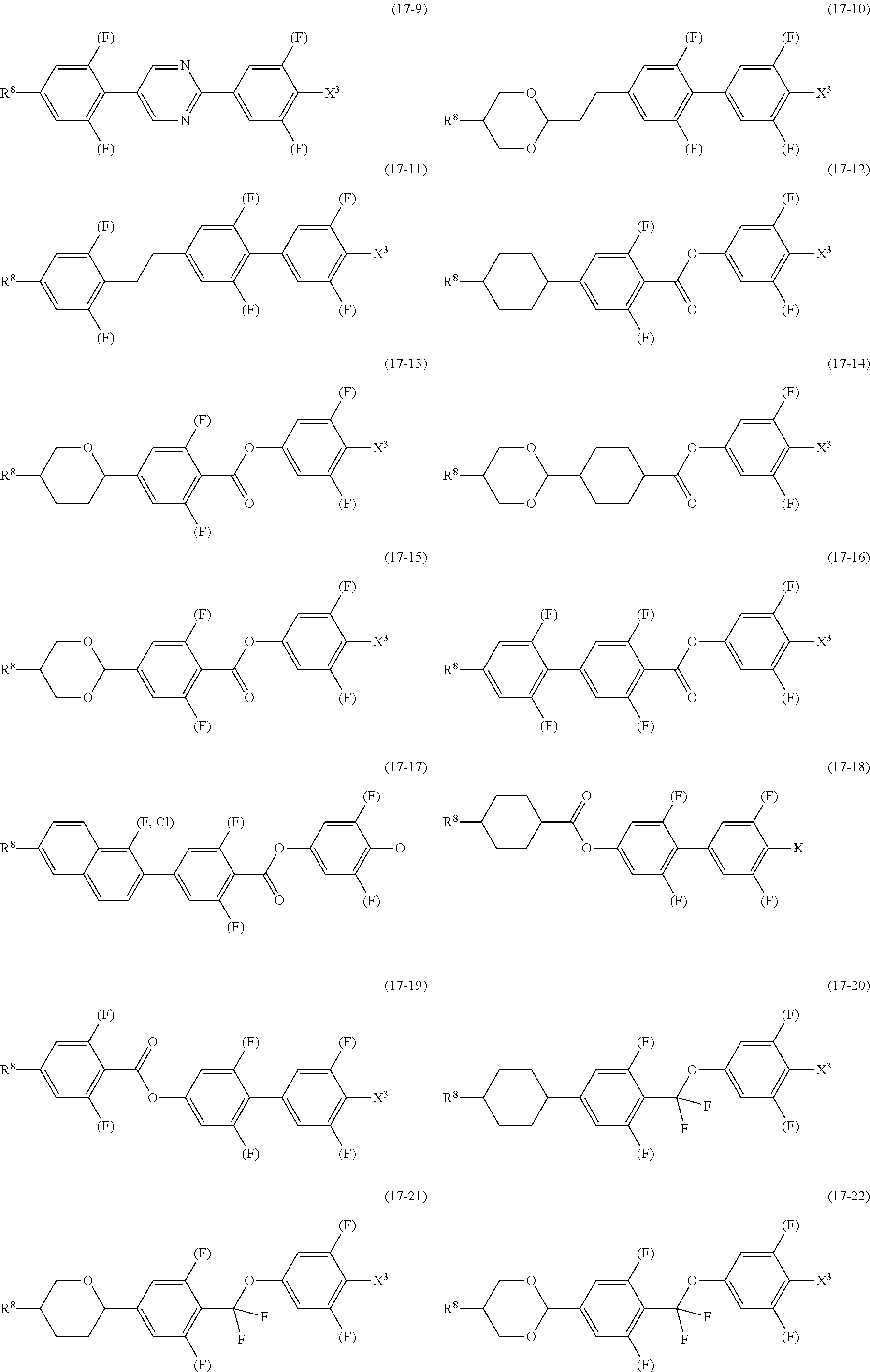

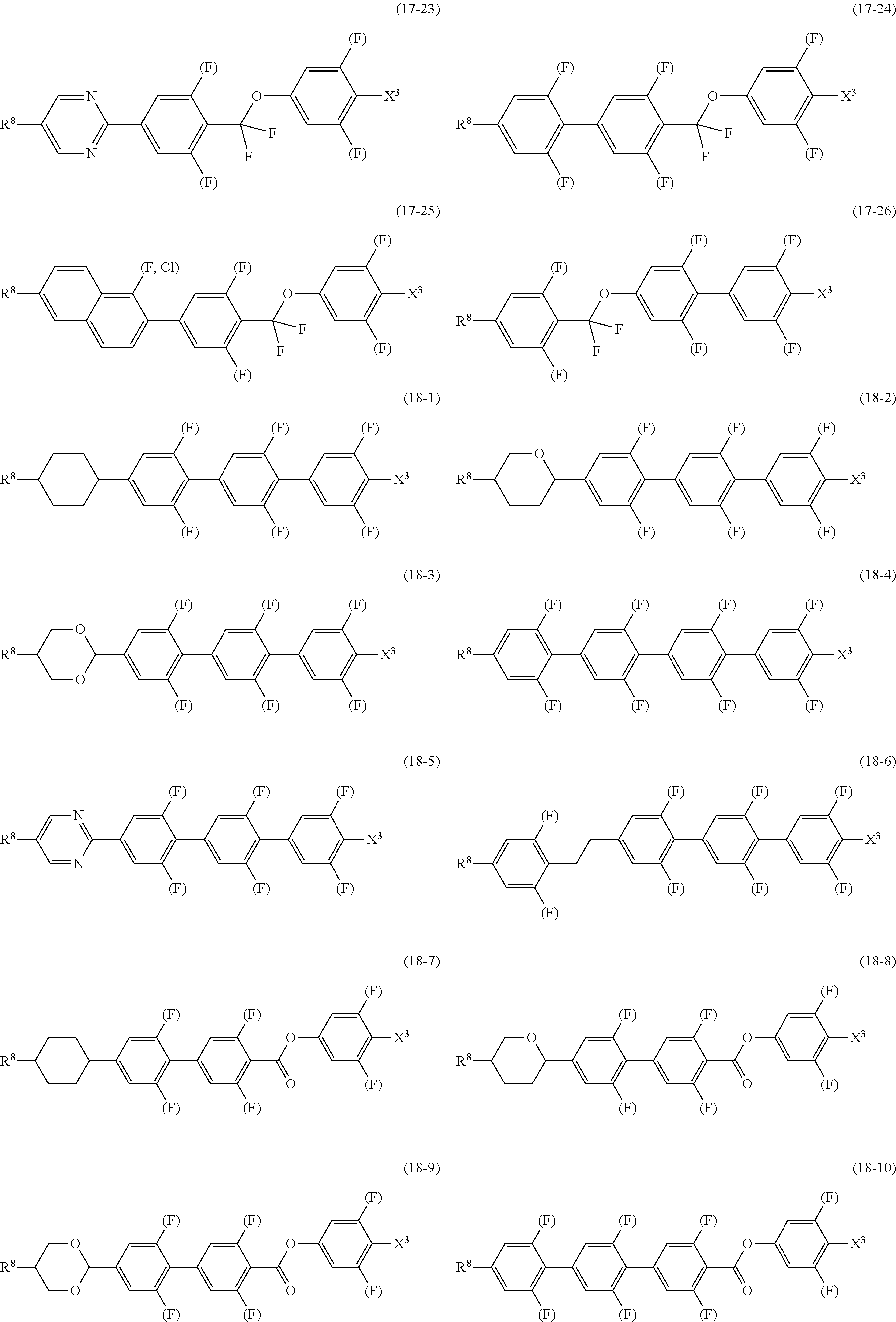

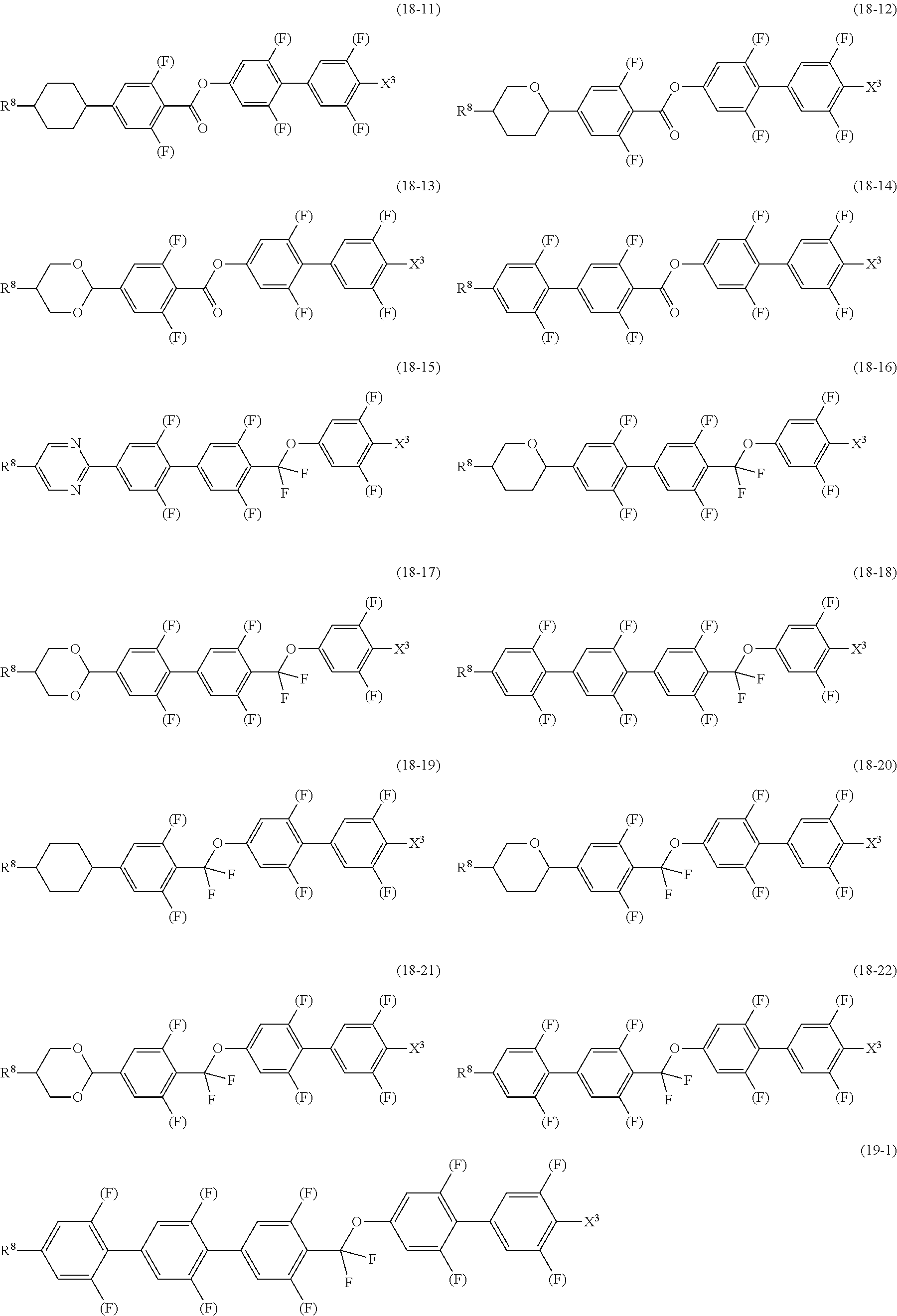

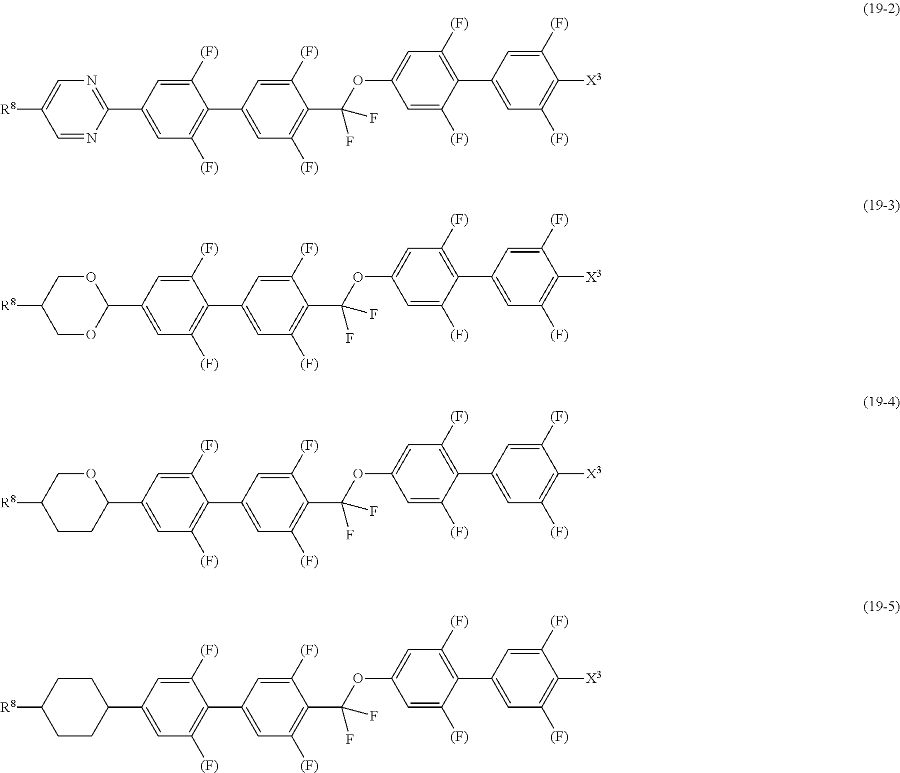

Compounds represented by formula (16) to formula (19), namely component E, have a positive value of dielectric anisotropy with a very large value, and have an exceptional thermal stability or chemical stability, and therefore are suitable when preparing the liquid crystal composition for active drive, such as a TFT drive. Content of component E in the liquid crystal composition of the invention is suitably in the range of 1 to 100% by weight, preferably, in the range of 10 to 100% by weight, further preferably in the range of 40 to 100% by weight based on the total weight of the liquid crystal composition. Moreover, a clearing point and viscosity can be controlled by allowing the compounds represented by formula (12) to formula (15) (component D) to further contain in the composition.

### 3.7 Compounds Represented by Formula (20) (Component F)

In formula (20), R⁹ is alkyl having 1 to 10 carbons, alkenyl having 2 to 10 carbons or alkynyl having 2 to 10 carbons, and in the alkyl, the alkenyl and the alkynyl, arbitrary hydrogen may be replaced by fluorine, and arbitrary —CH₂— may be replaced by —O—.

In formula (20), X⁴ is —C≡N, —N═C═S or —C≡C—C≡N, and in formula (20), ring F¹, ring F² and ring F³ are independently 1,4-cyclohexylene, 1,4-phenylene, or 1,4-phenylene in which arbitrary hydrogen is replaced by fluorine or chlorine, naphthalene-2,6-diyl, or naphthalene-2,6-diyl in which arbitrary hydrogen is replaced by fluorine or chlorine, 1,3-dioxane-2,5-diyl, tetrahydropyran-2,5-diyl or pyrimidine-2,5-diyl.

In formula (20), Z¹² is —(CH₂)₂—, —COO—, —CF₂O—, —OCF₂—, —C≡C—, —CH₂O— or a single bond.

In formula (20), L¹⁰ and L¹¹ are independently hydrogen or fluorine.

In formula (20), g is 0, 1 or 2, h is 0 or 1, and g+h is 0, 1 or 2.

Specific examples of suitable compounds represented by formula (20), namely, component E, include compounds represented by formula (20-1) to formula (20-37). In the formulas, R⁹, X⁴, (F), and (F, Cl) are identically defined as described above.

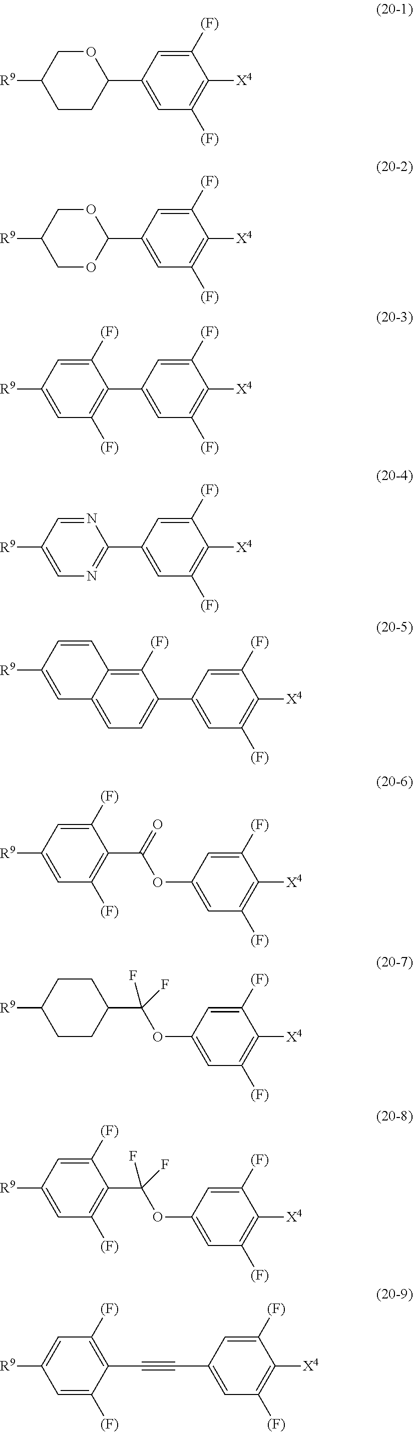

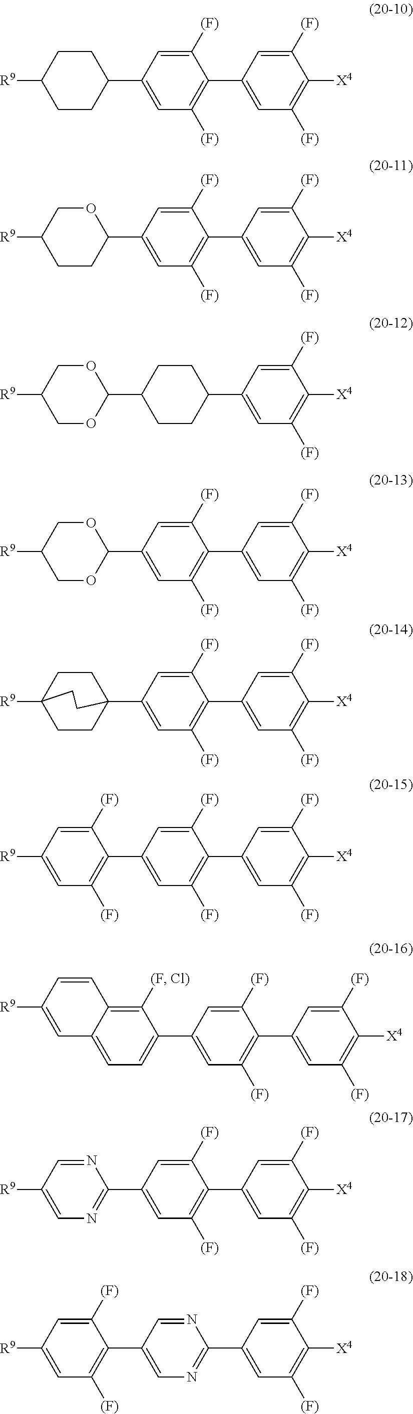

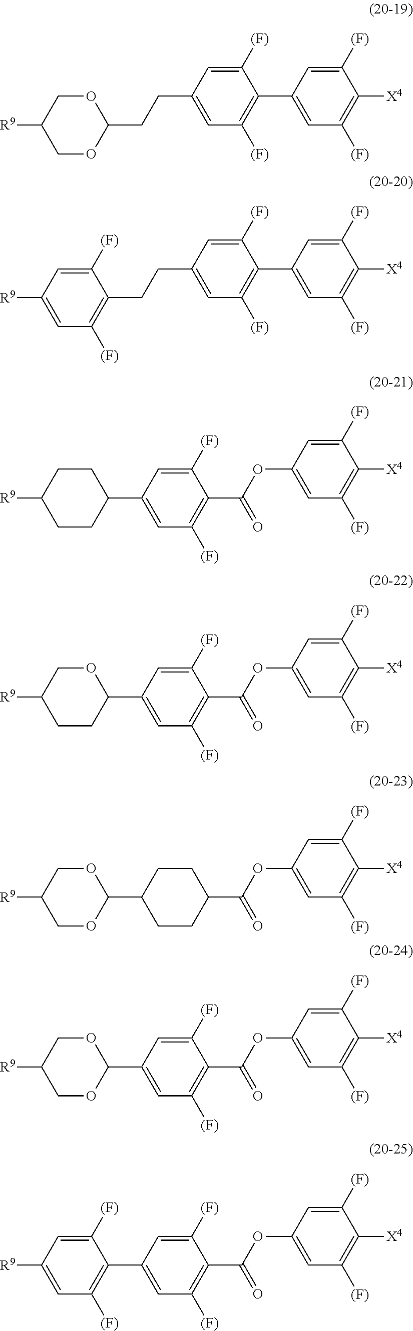

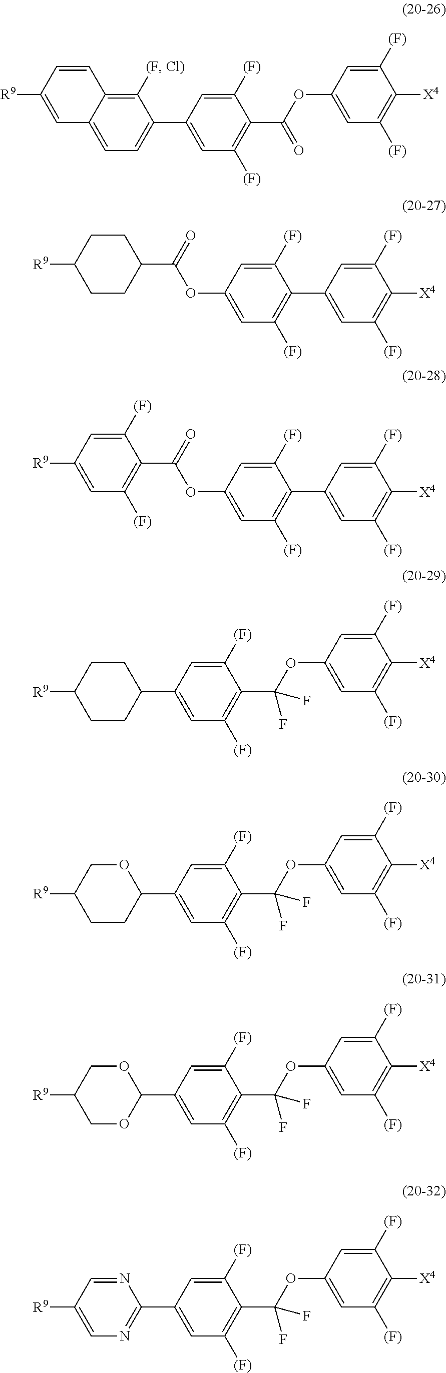

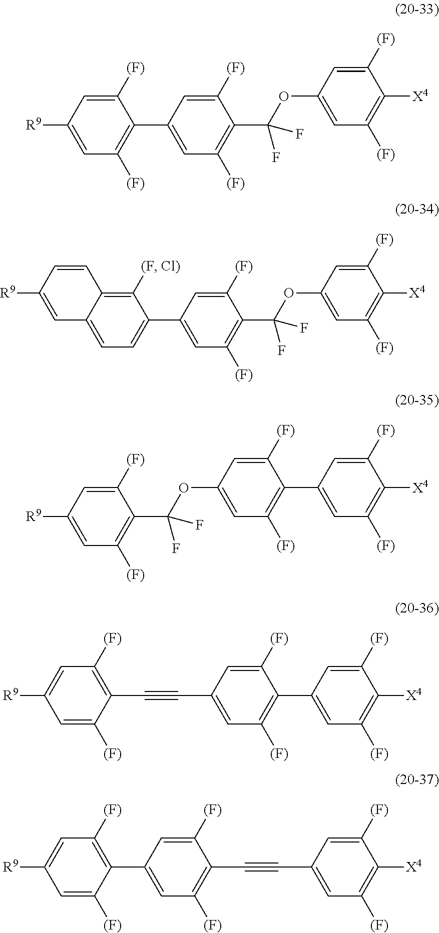

Compounds represented by formula (20), namely, component F, have a positive value of dielectric anisotropy with a very large value, and therefore are mainly used when decreasing driving voltage of an element such as an element driven by an optically isotropic liquid crystal phase or elements such as PDLCD, PNLCD and PSCLCD. Driving voltage of composition can be decreased by allowing component F to contain in the composition. Moreover, a range of adjusting viscosity and a value of refractive index anisotropy, and a temperature range of the liquid crystal phase can be extended. Furthermore, the compounds can be utilized for improving steepness.

Content of component F is preferably in the range of 0.1 to 99.9% by weight, further preferably, in the range of 10 to 97% by weight, still further preferably, in the range of 40 to 95% by weight based on the whole of the liquid crystal composition.

### 4. Chiral Agent

As a chiral agent contained in the liquid crystal material used for the liquid crystal display element of the invention, a compound having a large helical twisting power is preferred. The liquid crystal material is obtained by adding the chiral agent to the liquid crystal composition. An adding amount needed for obtaining a desired pitch can be decreased in the compound having a large helical twisting power, and therefore an increase of drive voltage can be suppressed, and thus the compound having the large helical twisting power is advantageous in practical use. Specifically, compounds represented by the following formula (K1)

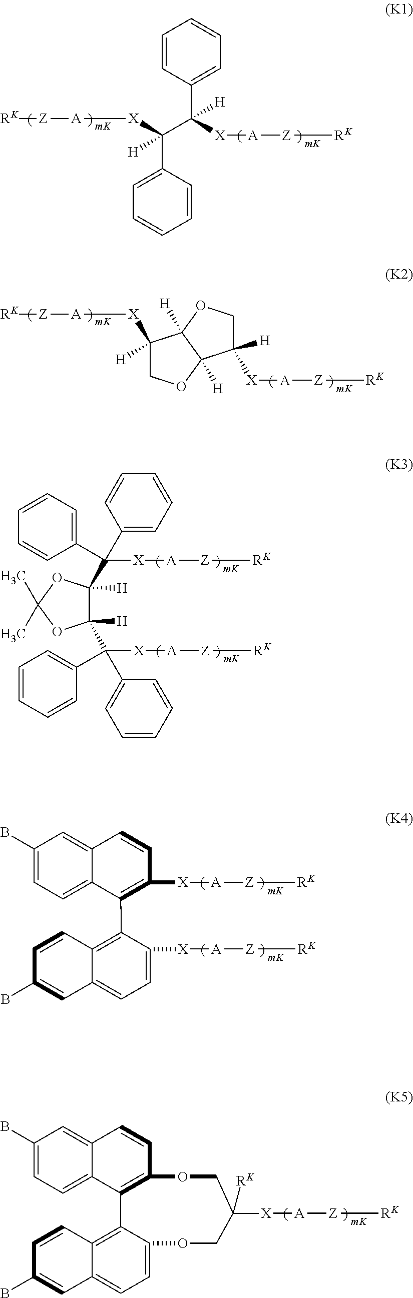

where, in formula (K1) to formula (K5), R^{K} is independently hydrogen, halogen, —C≡N, —N═C═O, —N═C═S or alkyl having 1 to 20 carbons, and in the alkyl, arbitrary —CH₂— may replaced by —O—, —S—, —COO—, —OCO—, —CH═CH—, —CF═CF— or —C≡C—, and arbitrary hydrogen may be replaced by halogen; A is independently an aromatic or non-aromatic 3-membered ring to 8-membered ring or a condensed ring having 9 or more carbons, and in the rings, arbitrary hydrogen may be replaced by halogen, or alkyl or haloalkyl having 1 to 3 carbons, —CH₂— may be replaced by —O—, —S— or —NH—, and —CH═ may be replaced by —N═; B is independently hydrogen, halogen, alkyl having 1 to 3 carbons, haloalkyl having 1 to 3 carbons, or aromatic or non-aromatic 3-membered ring to 8-membered ring or a condensed ring having 9 or more carbons, and in the rings, arbitrary hydrogen may be replaced by halogen, or alkyl or haloalkyl having 1 to 3 carbons, —CH₂— may be replaced by —O—, —S— or —NH—, and —CH═ may be replaced by —N═; Z is independently a single bond or alkylene having 1 to 8 carbons, and arbitrary —CH₂— may be replaced by —O—, —S—, —COO—, —OCO—, —CSO—, —OCS—, —N═N—, —CH═N—, —N═CH—, —CH═CH—, —CF═CF— or —C≡C—, and arbitrary hydrogen may be replaced by halogen; X is a single bond, —COO—, —OCO—, —CH₂O—, —OCH₂—, —CF₂O—, —OCF₂— or —CH₂CH₂—; and mK is 1 to 4.

Among the compounds, as the chiral agent, the compounds represented by formula (K2-1) to formula (K2-8) included in formula (K2), formula (K4-1) to formula (K4-6) included in formula (K4), and formula (K5-1) to formula (K5-3) included in formula (K5) are preferred.

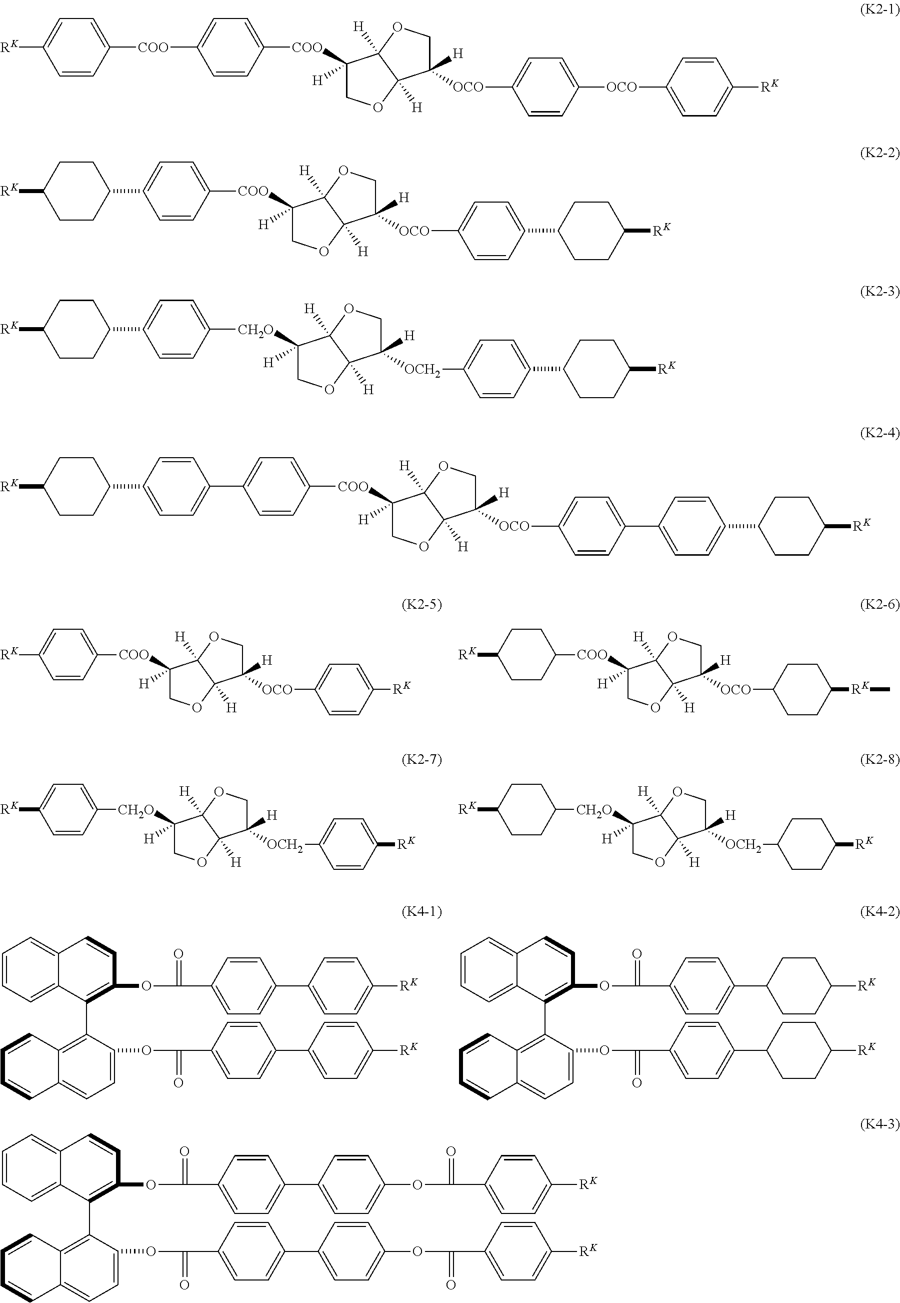

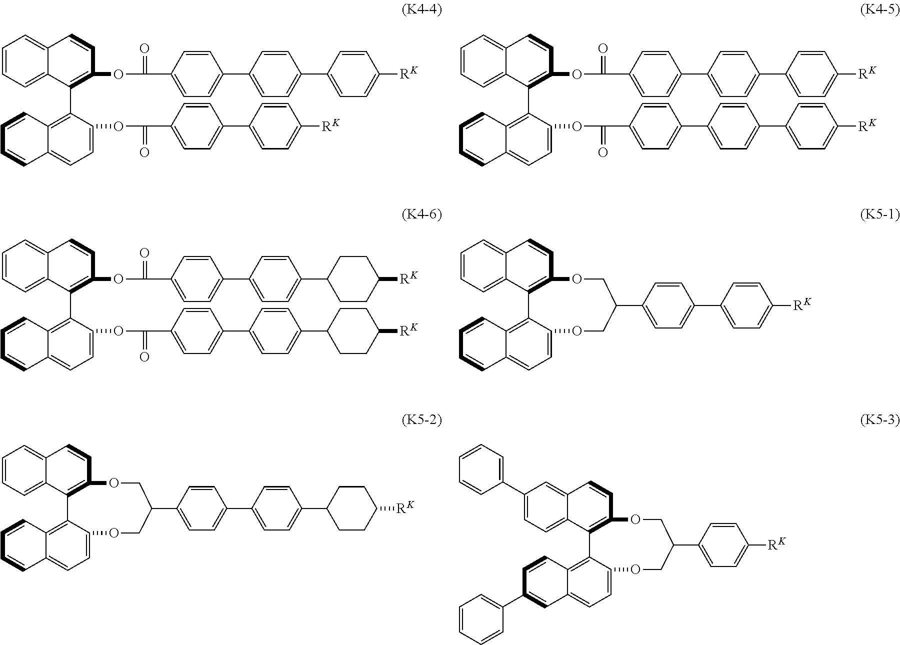

where, in the formulas, R^{K} is independently alkyl having 3 to 10 carbons, —CH₂— adjacent to the ring in the alkyl may be replaced by —O—, and arbitrary —CH₂— may be replaced by —CH═CH—.

Content of the chiral agent contained in an optically isotropic liquid crystal material of the invention is preferably lower as long as desired optical properties are provided. The content is preferably in the range of 1 to 20% by weight, further preferably, in the range of 1 to 10% by weight.

When the optically isotropic liquid crystal material including the chiral agent of this invention is used for a liquid crystal display element, it is desirable for a diffraction light and a reflection light not to be accepted substantially by adjusting amount of chiral agent in a visible region.

It is desirable for diffraction and a reflection not to be accepted substantially by adjusting A by a visible level.

### 5. Liquid Crystal Material or the Like being Polymer/Liquid Crystal Composite Material

The liquid crystal material used for the liquid crystal display element of the invention may further contain a polymerizable monomer or a polymer. In the specification, a liquid crystal material containing the polymer is referred to as “polymer/liquid crystal composite material.”

The polymer/liquid crystal composite material can exhibit an optically isotropic liquid crystal phase in a wide temperature range, and is preferably used as the liquid crystal material in the invention. Moreover, the polymer/liquid crystal composite material concerning a preferred embodiment of the invention has a very fast response. Accordingly, the polymer/liquid crystal composite material is preferably used in the liquid crystal display element of the invention.

### 5.1 Method for Manufacturing the Polymer/Liquid Crystal Composite Material

The polymer/liquid crystal composite material can be also manufactured by mixing the liquid crystal material with the polymer obtained by polymerization in advance, but preferably manufactured by mixing a low-molecular-weight monomer, a macromonomer, an oligomer or the like (hereinafter, collectively referred to as “monomer or the like”) being a material of the polymer with a chiral liquid crystal composition (CLC) containing the chiral agent, and then performing a polymerization reaction in the mixture. A mixture containing the monomer or the like and the chiral liquid crystal composition is referred to as “polymerizable monomer/liquid crystal mixture” in the specification.

In “polymerizable monomer/liquid crystal mixture,” a polymerization initiator, a hardener, a catalyst, a stabilizer, a dichroic dye, a photochromic compound or the like as described later may also be contained, when necessary, within the range where the advantageous effects of the invention are not adversely affected. For example, the polymerization initiator may be contained, when necessary, in the range of 0.1 to 20 parts by weight based on 100 parts by weight of a polymerizable monomer in the polymerizable monomer/liquid crystal mixture of the invention.

Polymerization temperature preferably includes temperature at which the polymer/liquid crystal composite material shows a high transparency and isotropy. The polymerization temperature further preferably includes temperature at which a mixture of the monomer and the liquid crystal material exhibits an isotropic phase or a blue phase, and polymerization is ended in the isotropic phase or the optically isotropic liquid crystal phase. More specifically, the polymerization temperature preferably includes the temperature at which the polymer/liquid crystal composite material does not substantially scatter light in a side of a wavelength longer than visible light, and an optically isotropic state is exhibited.

The polymer in the polymer/liquid crystal composite material preferably has a three-dimensional bridge structure. Therefore, a polyfunctional monomer having two or more polymerizable functional groups is preferably used as a raw material monomer of the polymer. The polymerizable functional group is not particularly limited, and specific examples include an acrylic group, a methacrylic group, a glycidyl group, an epoxy group, an oxetanyl group and a vinyl group. The acrylic group and the methacrylic group are preferred from a viewpoint of a rate of polymerization. When 10% by weight or more of a monomer having two or more polymerizable functional groups is allowed to be contained in the monomer among raw material monomers of the polymer, a high transparency and isotropy are easily exhibited in the composite material of the invention, and therefore such application is preferred.

Moreover, in order to obtain a suitable composite material, the polymer preferably has a mesogen moiety, and a raw material monomer having the mesogen moiety can be partially or wholly used as the raw material monomer of the polymer.

### 5.2.1 Monofunctional or Bifunctional Monomer Having the Mesogen Moiety

A monofunctional or bifunctional monomer having the mesogen moiety is not particularly limited structurally. Specific examples include compounds represented by the following formula (M1) or formula (M2):

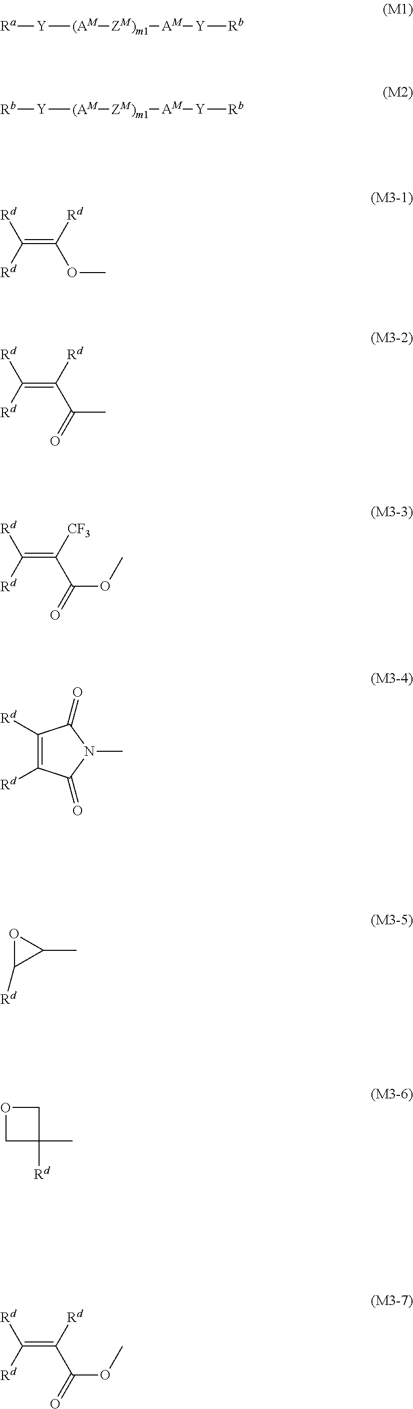

where, in formula (M1), R^{a} is each independently hydrogen, halogen, —C≡N, —N═C═O, —N═C═S or alkyl having 1 to 20 carbons, and in the alkyls, arbitrary —CH₂— may be replaced by —O—, —S—, —CO—, —COO—, —OCO—, —CH═CH—, —CF═CF— or —C≡C—, and arbitrary hydrogen may be replaced by halogen or —C≡N. R^{b} is each independently a polymerizable group according to formula (M3-1) to formula (M3-7).

Preferred R^{a} is hydrogen, halogen, —C≡N, —CF₃, —CF₂H, —CFH₂, —OCF₃, —OCF₂H, alkyl having 1 to 20 carbons, alkoxy having 1 to 19 carbons, alkenyl having 2 to 21 carbons and alkynyl having 2 to 21 carbons. Particularly preferred R^{a} is —C≡N, alkyl having 1 to 20 carbons and alkoxy having 1 to 19 carbons.

In formula (M2), R^{b} is each independently a polymerizable group according to formula (M3-1) to formula (M3-7).

Herein, R^{d} in formula (M3-1) to formula (M3-7) is each independently hydrogen, halogen or alkyl having 1 to 5 carbons, and in the alkyls, arbitrary hydrogen may be replaced by halogen. Preferred R^{d} is hydrogen, halogen and methyl. Particularly preferred R^{d} is hydrogen, fluorine and methyl.

Compounds represented by formula (M3-2), formula (M3-3), formula (M3-4) and formula (M3-7) are suitably polymerized according to a radical polymerization. Compounds represented by formula (M3-1), formula (M3-5) and formula (M3-6) are suitably polymerized according to a cationic polymerization. Any of polymerizations is a living polymerization, and therefore polymerization starts if a small amount of radical or cationic active species is generated in a reaction system. The polymerization initiator can be used in order to accelerate generation of active species. Light or heat can be used for generating the active species.

In formulas (M1) and (M2), A^{M} is each independently an aromatic or non-aromatic 5-membered ring or 6-membered ring or a condensed ring having 9 or more carbons, and —CH₂— in the ring may be replaced by —O—, —S—, —NH— or —NCH₃—, and —CH═ in the ring may be replaced by —N═, and a hydrogen atom on the ring may be replaced by halogen, or alkyl or halogenated alkyl having 1 to 5 carbons. Specific examples of preferred A^{M} include 1,4-cyclohexylene, 1,4-cyclohexenylene, 1,4-phenylene, naphthalene-2,6-diyl, tetrahydronaphthalene-2,6-diyl, fluorene-2,7-diyl or bicyclo[2.2.2]octane-1,4-diyl. In the rings, arbitrary —CH₂— may be replaced by —O—, arbitrary —CH═ may be replaced by —N═, and arbitrary hydrogen may be replaced by halogen, alkyl having 1 to 5 carbons or halogenated alkyl having 1 to 5 carbons.

In view of stability of a compound, —CH₂—O—CH₂—O— in which oxygen and oxygen are not adjacent is preferable to —CH₂—O—O—CH₂— in which oxygen and oxygen are adjacent. A same description applies also to sulfur.

Among the groups, particularly preferred A^{M} is 1,4-cyclohexylene, 1,4-cyclohexenylene, 1,4-phenylene, 2-fluoro-1,4-phenylene, 2,3-difluoro-1,4-phenylene, 2,5-difluoro-1,4-phenylene, 2,6-difluoro-1,4-phenylene, 2-methyl-1,4-phenylene, 2-trifluoromethyl-1,4-phenylene, 2,3-bis(trifluoromethyl)-1,4-phenylene, naphthalene-2,6-diyl, tetrahydronaphthalene-2,6-diyl, fluorene-2,7-diyl, 9-methylfluorene-2,7-diyl, 1,3-dioxane-2,5-diyl, pyridine-2,5-diyl andpyrimidine-2,5-diyl. In addition, trans is preferable to cis as a configuration of the 1,4-cyclohexylene and 1,3-dioxane-2,5-diyl.

Since 2-fluoro-1,4-phenylene is structurally identical with 3-fluoro-1,4-phenylene, the latter is not included as a specific example. The rule also applies to a relationship between 2,5-difluoro-1,4-phenylene and 3,6-difluoro-1,4-phenylene, or the like.

In formulas (M1) and (M2), Y is each independently a single bond or alkylene having 1 to 20 carbons, and in the alkylenes, arbitrary —CH₂— may be replaced by —O—, —S—, —CH═CH—, —C≡C—, —COO— or —OCO—. Preferred Y is a single bond, —(CH₂)ₘ₂—, —O(CH₂)ₘ₂— and —(CH₂)ₘ₂O— (in the formulas, r is an integer of 1 to 20). Particularly preferred Y is a single bond, —(CH₂)ₘ₂—, —O(CH₂)ₘ₂—, and —(CH₂)ₘ₂O— (in the formulas, m2 is an integer of 1 to 10). In view of stability of a compound, —Y—R^{a} and —Y—R^{b} preferably do not have —O—O—, —O—S—, —S—O— or —S—S— in the groups.

In formulas (M1) and (M2), Z^{M} is each independently a single bond, —(CH₂)ₘ₃—, —O(CH₂)ₘ₃—, —(CH₂)ₘ₃O—, —O(CH₂)ₘ₃O—, —CH═CH—, —C≡C—, —COO—, —OCO—, —(CF₂)₂—, —(CH₂)₂—COO—, —OCO—(CH₂)₂—, —CH═CH—COO—, —OCO—CH═CH—, —C≡C—COO—, —OCO—C≡C—, —CH═CH—(CH₂)₂—, —(CH₂)₂—CH═CH—, —CF═CF—, —C≡C—CH═CH—, —CH═CH—C≡C—, —OCF₂—(CH₂)₂—, —(CH₂)₂—CF₂O—, —OCF₂— or —CF₂O— (in the formulas, m3 is an integer of 1 to 20).

Preferred Z^{M} is a single bond, —(CH₂)ₘ₃—, —O(CH₂)ₘ₃—, —(CH₂)ₘ₃O—, —CH═CH—, —C≡C—, —COO—, —OCO—, —(CH₂)₂—COO—, —OCO—(CH₂)₂—, —CH═CH—COO—, —OCO—CH═CH—, —OCF₂— and —CF₂O—.

In formulas (M1) and (M2), m1 is an integer of 1 to 6. Preferred m1 is an integer of 1 to 3. When m1 is 1, formulas (M1) and (M2) represent a two-ring compound having two rings such as a 6-membered ring. When m1 is 2 and 3, formulas (M1) and (M2) represent three-ring and four-ring compounds, respectively. For example, when m1 is 1, two of A^{M} may be identical or different. For example, when m1 is 2, three of A^{M} (or two of Z^{M}) may be identical or different. A same rule applies to a case where m1 is 3 to 6. A same rule applies to R^{a}, R^{b}, R^{d}, Z^{M}, A^{M} and Y.

Even when compound (M1) represented by formula (M1) and compound (M2) represented by formula (M2) contain a larger amount of isotopes such as ²H (deuterium) and ¹³C than an amount of a natural abundance ratio, compound (M1) and compound (M2) have the same properties and therefore can be preferably used.

Examples of further preferred compound (M1) and compound (M2) include compound (M1-1) to compound (M1-41) and compound (M2-1) to compound (M2-27) represented by formula (M1-1) to (M1-41) and (M2-1) to (M2-27), respectively. In the compounds, definitions of R^{a}, R^{b}, R^{d}, Z^{M}, A^{M}, Y and p are identical with the definitions in formulas (M1) and (M2) as described in the embodiments of the invention.

The following partial structure in compound (M1-1) to compound (M1-41) and compound (M2-1) to compound (M2-27) will be explained. Partial structure (a1) represents 1,4-phenylene in which arbitrary hydrogen is replaced by fluorine. Partial structure (a2) represents 1,4-phenylene in which arbitrary hydrogen may be replaced by fluorine. Partial structure (a3) represents 1,4-phenylene in which arbitrary hydrogen may be replaced by either fluorine or methyl. Partial structure (a4) represents fluorene in which hydrogen on position 9 may be replaced by methyl.

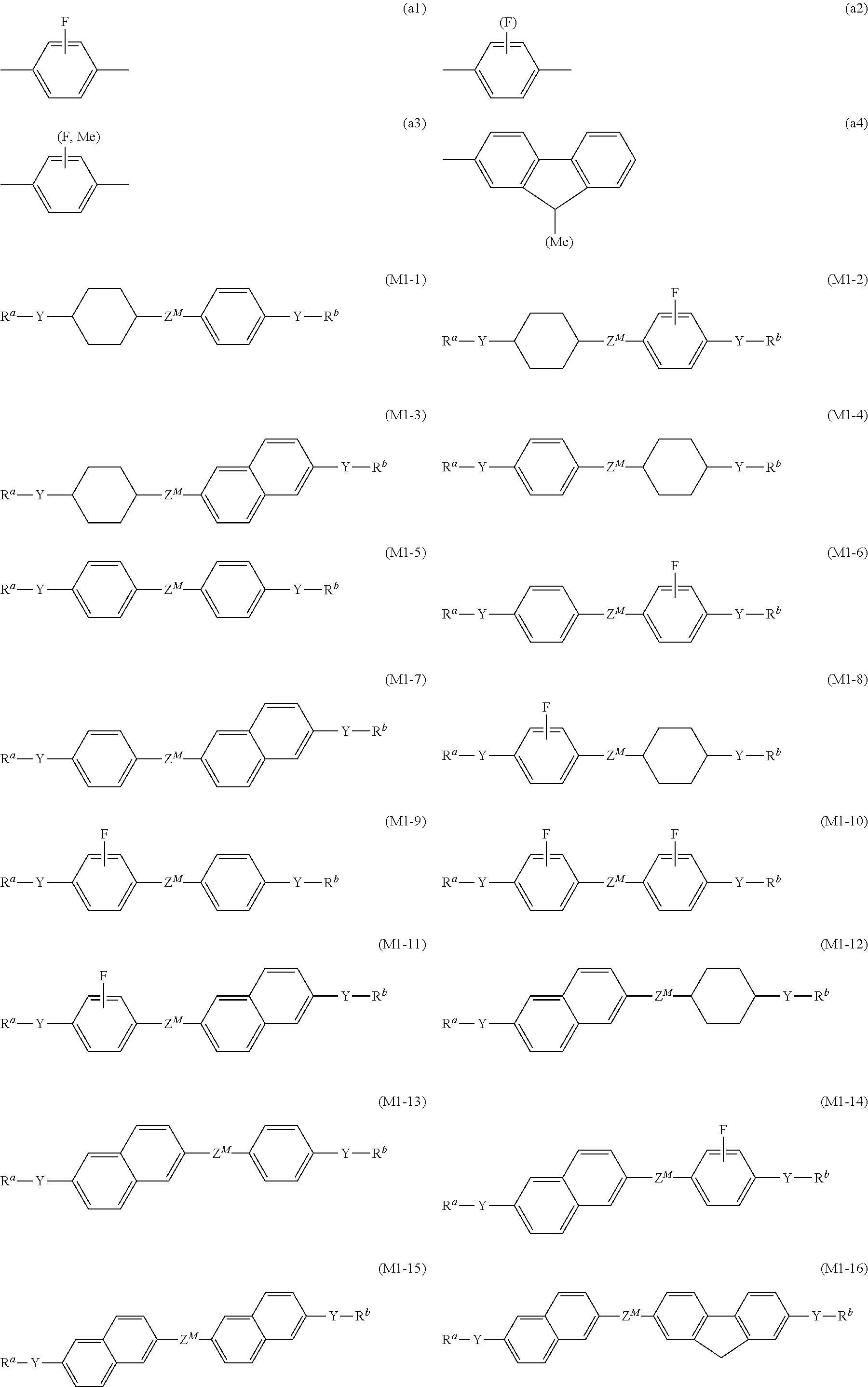

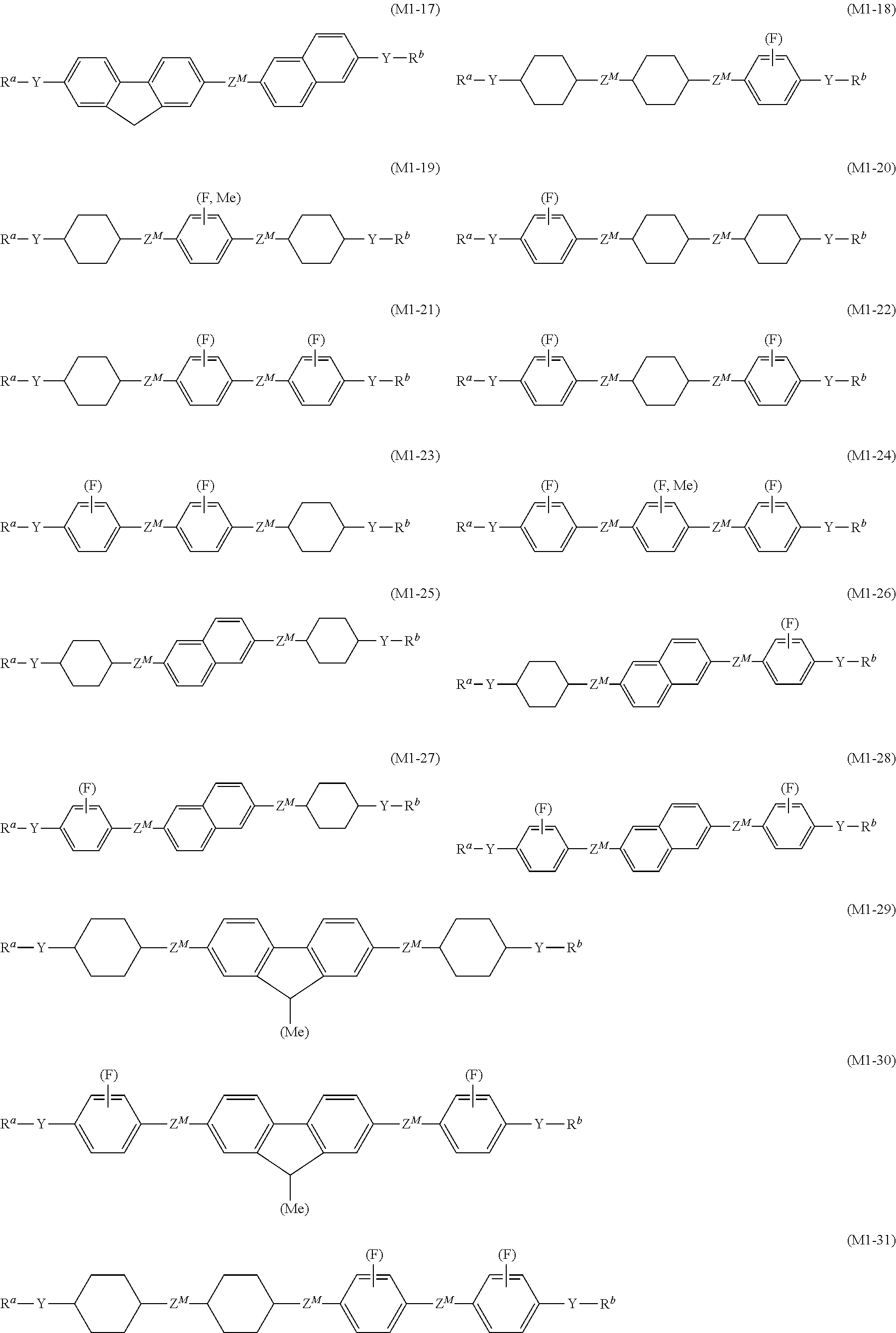

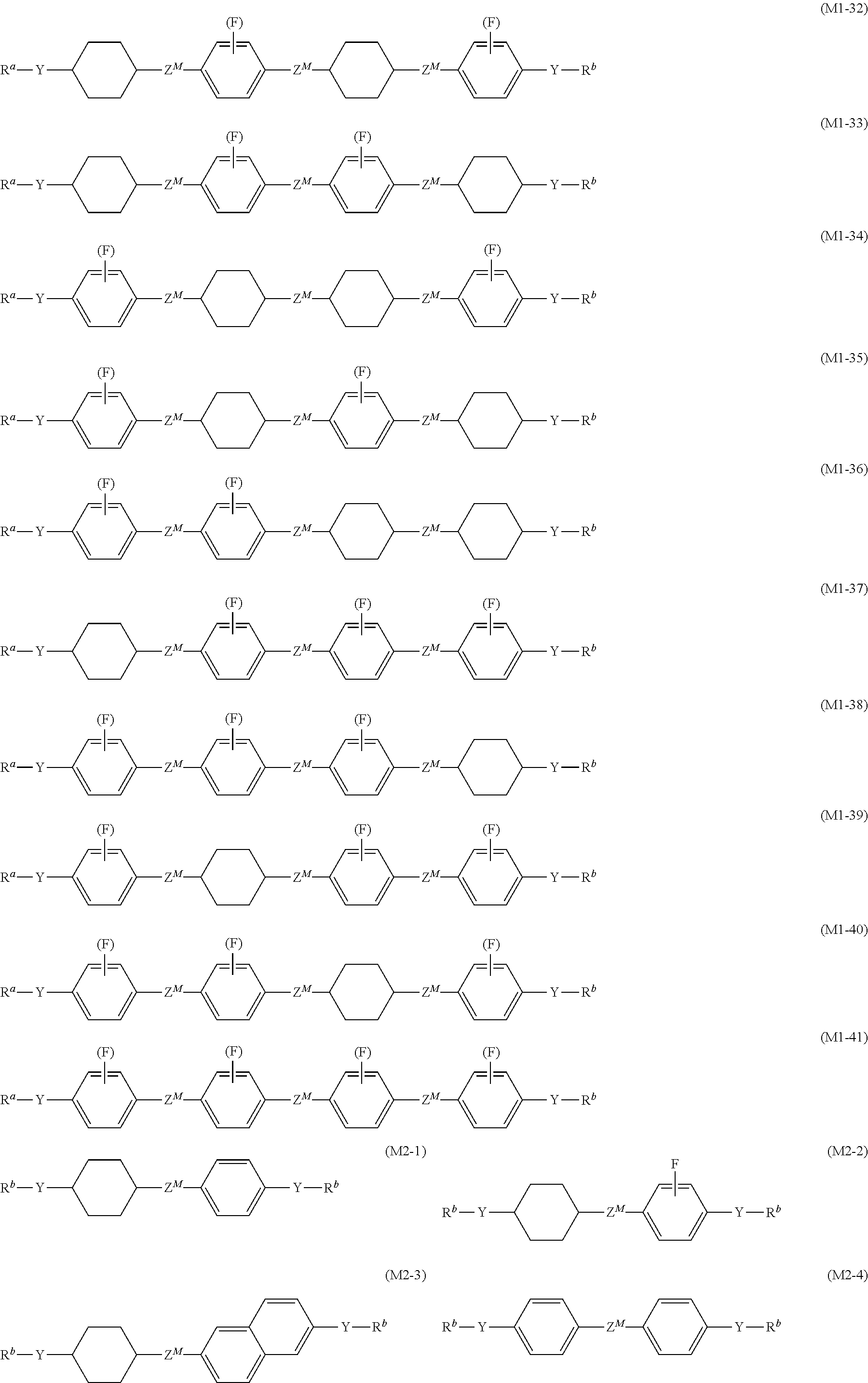

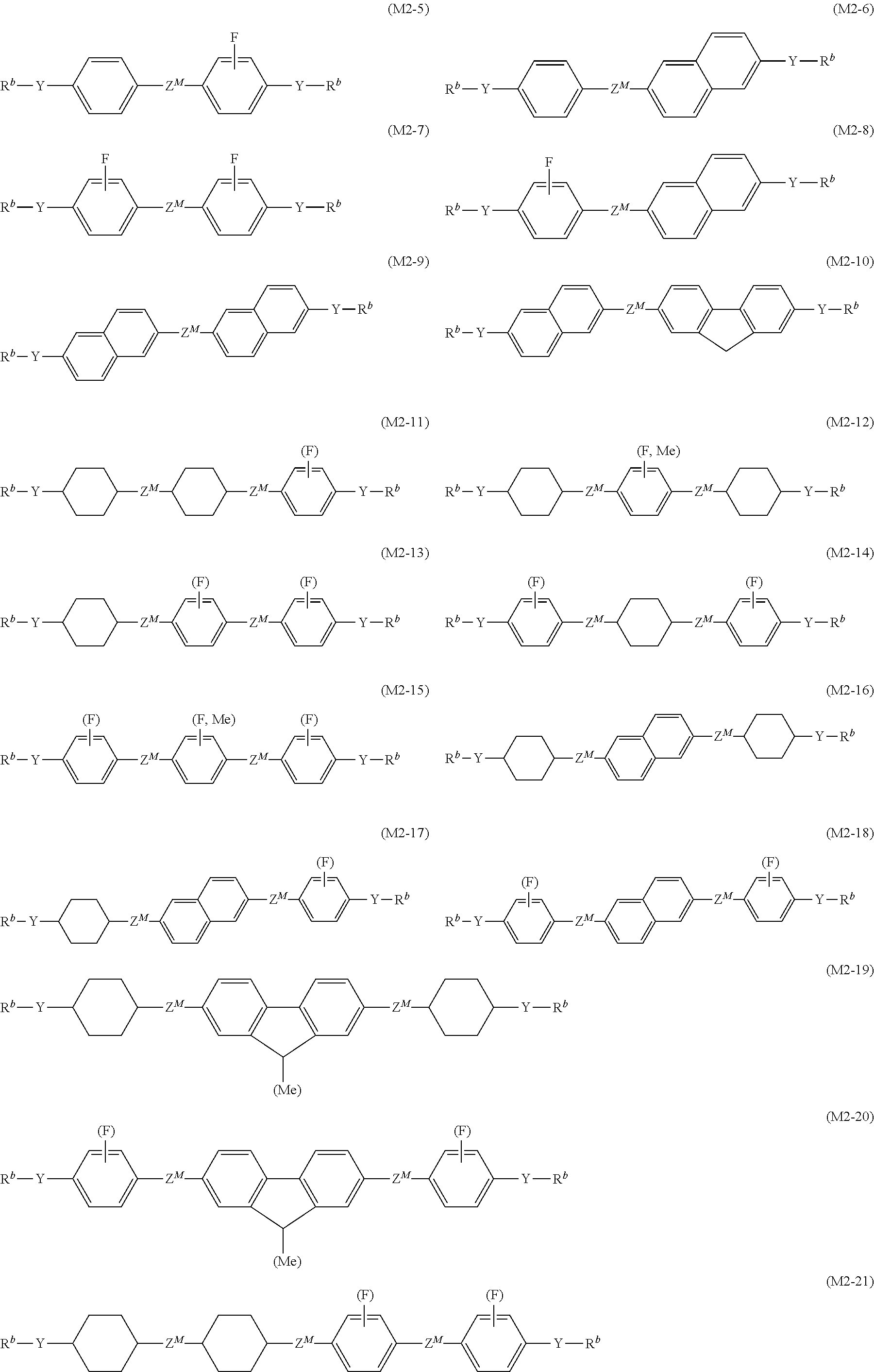

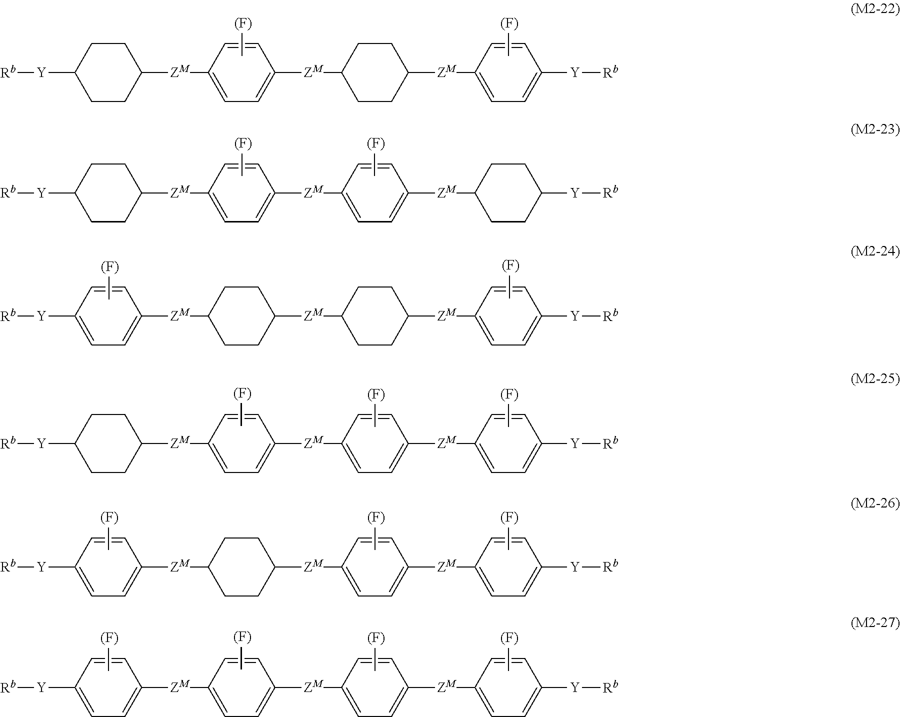

A monomer having no mesogen moiety as described above, or a polymerizable compound other than monomers (M1) and (M2) having the mesogen moiety can be used when necessary.

For the purpose of optimizing optically isotropy of the polymer/liquid crystal composite material of the invention, a monomer having the mesogen moiety and three or more polymerizable functional groups can also be used. As the monomer having the mesogen moiety and three or more polymerizable functional groups, a publicly known compound can be suitably used. For example, the monomer includes (M4-1) to (M4-3). More specific examples include compounds as described in JP 2000-327632 A, JP 2004-182949 A and JP 2004-59772 A. However, in (M4-1) to (M4-3), R^{b}, Z^{a}, Y and (F) are identically defined as described above.

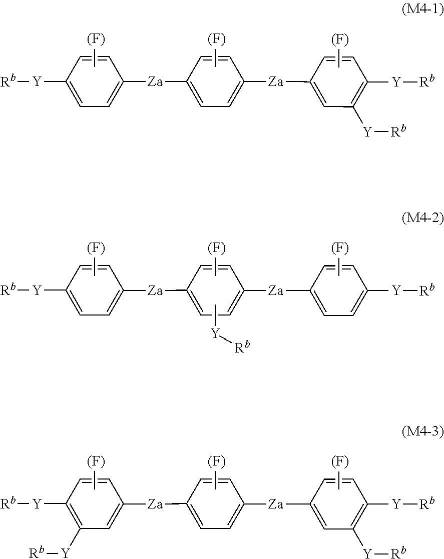

### 5.2.2 Monomer Having the Polymerizable Functional Group and Having No Mesogen Moiety

Specific examples of monomers having the polymerizable functional group and having no mesogen moiety include a straight chain or branched acrylate having 1 to 30 carbons or a straight chain or branched diacrylate having 1 to 30 carbons, and specific examples of monomers having three or more polymerizable functional groups include glycerol propoxylate (1 PO/OH) triacrylate, pentaerythritol propoxylate triacrylate, pentaerythritol triacrylate, trimethylolpropanethoxylate triacrylate, trimethylolpropanepropoxylate triacrylate, trimethylolpropane triacrylate, di(trimethylolpropane)tetraacrylate, pentaerythritol tetraacrylate, di(pentaerythritol)pentaacrylate, di(pentaerythritol)hexaacrylate and trimethylolpropane triacrylate, but not limited thereto.

### 5.3 Polymerization Initiator

The polymerization reaction in synthesis of the polymer contained in the polymer/liquid crystal composite material is not particularly limited. Specific examples include a photoradical polymerization reaction, a thermal radical polymerization reaction and a photocationic polymerization reaction.

Examples of photoradical polymerization initiators that can be used in the photoradical polymerization reaction include DAROCUR (registered trademark) 1173 and 4265 (trade names for both, BASF Japan Ltd.) and IRGACURE (registered trademark) 184, 369, 500, 651, 784, 819, 907, 1300, 1700, 1800, 1850 and 2959 (trade names for all, BASF Japan Ltd.).

Examples of preferred initiators for the radical polymerization by heat that can be used in the thermal radical polymerization reaction include benzoyl peroxide, diisopropyl peroxydicarbonate, t-butyl peroxy-2-ethylhexanoate, t-butyl peroxypivalate, t-butyl peroxydiisobutyrate, lauroyl peroxide, dimethyl 2,2′-azobisisobutyrate (MAIB), di-t-butyl peroxide (DTBPO), azobisisobutyronitril (AIBN) and azobiscyclohexane carbonitrile (ACN).

Specific examples of photocationic polymerization initiators that can be used in the photocationic polymerization reaction include diaryliodonium salt (hereinafter, referred to as “DAS”) and triarylsulfonium salt (hereinafter, referred to as “TAS”).

Specific examples of DAS include diphenyliodonium tetrafluoroborate, diphenyliodonium hexafluorophosphonate, diphenyliodonium hexafluoroarsenate, diphenyliodonium trifluoromethanesulfonate, diphenyliodonium trifluoroacetate, diphenyliodonium p-toluenesulfonate, diphenyliodonium tetra(pentafluorophenyl)borate, 4-methoxypheny phenyliodonium tetrafluoroborate, 4-methoxypheny phenyliodonium hexafluorophosphonate, 4-methoxypheny phenyliodonium hexafluoroarsenate, 4-methoxypheny phenyliodonium trifluoromethanesulfonate, 4-methoxyphenyl phenyliodonium trifluoroacetate and 4-methoxypheny phenyliodonium p-toluenesulfonate.

A photosensitizer such as thioxanthone, phenothiazine, chlorothioxanthone, xanthone, anthracene, diphenylanthracene and rubrene is added to DAS, and thus a higher sensitivity can also be achieved.

Specific examples of TAS include triphenylsulfonium tetrafluoroborate, triphenylsulfonium hexafluorophosphonate, triphenylsulfonium hexafluoroarsenate, triphenylsulfonium trifluoromethanesulfonate, triphenylsulfonium trifluoroacetate, triphenylsulfonium p-toluenesulfonate, triphenylsulfonium tetra(pentafluorophenyl)borate, 4-methoxypheny diphenylsulfonium tetrafluoroborate, 4-methoxypheny diphenylsulfonium hexafluorophosphonate, 4-methoxypheny diphenylsulfonium hexafluoroarsenate, 4-methoxyphenyl diphenylsulfonium trifluoromethanesulfonate, 4-methoxyphenyl diphenylsulfonium trifluoroacetate and 4-methoxypheny diphenylsulfonium p-toluenesulfonate.

Examples of specific trade names of the photocationic polymerization initiator include Cyracure (registered trademark) UVI-6990, Cyracure UVI-6974 and Cyracure UVI-6992 (trade names, respectively, UCC), Adeka Optomer SP-150, SP-152, SP-170 and SP-172 (trade names, respectively, ADEKA Corporation), Rhodorsil Photoinitiator 2074 (trade name, Rhodia Japan Ltd.), IRGACURE (registered trademark) 250 (trade name, BASF Japan Ltd.) and UV-9380C (trade name, GE Toshiba Silicones Co., Ltd.).

### 5.4 Hardener or the Like

In synthesis of the polymer constituting the polymer/liquid crystal composite material, one kind or two or more kinds of other suitable components, for example, the hardener, the catalyst and the stabilizer may be added, in addition to the monomer and the polymerization initiator.

As the hardener, a conventionally known latent hardener ordinarily used as a hardener of an epoxy resin can be used. Specific examples of the latent hardeners for the epoxy resin include an amine type hardener, a novolak resin type hardener, an imidazole type hardener and an acid anhydride type hardener. Specific examples of the amine type hardeners include an aliphatic polyamine such as diethylenetriamine, triethylenetetramine, tetraethylenepentamine, m-xylenediamine, trimethylhexamethylenediamine, 2-methylpentamethylenediamine and diethylaminopropylamine, an alicyclic polyamine such as isophoronediamine, 1,3-bisaminomethylcyclohexane, bis(4-aminocyclohexyl)methane, norbornenediamine, 1,2-diaminocyclohexane and laromine, and an aromatic polyamine such as diaminodiphenylmethane, diaminodiphenylethane and metaphenylenediamine.

Specific examples of the novolak resin type hardeners include a phenolic novolak resin and a bisphenol novolak resin. Specific examples of the imidazole type hardeners include 2-methylimidazole, 2-ethylhexylimidazole, 2-phenylimidazole and 1-cyanoethyl-2-phenylimidazolium trimellitate.

Specific examples of the acid anhydride type hardeners include tetrahydrophthalic anhydride, hexahydrophthalic anhydride, methyltetrahydrophthalic anhydride, methylhexahydrophthalic anhydride, methylcyclohexene tetracarboxylic dianhydride, phthalic anhydride, trimellitic anhydride, pyromellitic dianhydride and benzophenone tetracarboxylic dianhydride.

Moreover, a hardening accelerator for accelerating a hardening reaction of the hardener with the polymerizable compound having the glycidyl group, the epoxy group and the oxetanyl group may be further used. Specific examples of the hardening accelerators include tertiary amines such as benzyldimethylamine, tris(dimethylaminomethyl)phenol, and dimethylcyclohexylamine, imidazoles such as 1-cyanoethyl-2-ethyl-4-methylimidazole and 2-ethyl-4-methylimidazole, an organic phosphorus compound such triphenyl phosphine, quaternary phosphonium salts such as tetraphenyl phosphonium bromide, diazabicyclo alkenes such as 1,8-diazabicyclo[5.4.0]undecene-7 and an organic acid salt thereof, quaternary ammonium salts such as tetraethylammonium bromide and tetrabutylammonium bromide, and boron compounds such as boron trifluoride and triphenyl borate. The hardening accelerators can be used alone or in combination by mixing two or more kinds.

Moreover, the stabilizer is preferably added in order to prevent an undesired polymerization under storage, for example. As the stabilizer, all the compounds known to those skilled in the art can be used. Representative examples of the stabilizers include 4-ethoxyphenol, hydroquinone and butylated hydroxytoluene (BHT).

### 5.5 Other Components

The polymer/liquid crystal composite material may contain the dichroic dye and the photochromic compound, for example, within the range where the advantageous effects of the invention are not adversely affected.

### 5.6 Content of a Liquid Crystal Composition or the Like

Content of the liquid crystal composition in the polymer/liquid crystal composite material is preferably as high as possible if the content is within the range where the composite material can exhibit the optically isotropic liquid crystal phase because a value of the electric birefringence of the composite material of the invention increases as the content of the liquid crystal composition is higher.

In the polymer/liquid crystal composite material, the content of the liquid crystal composition is preferably in the range of 60 to 99% by weight, further preferably, in the range of 60 to 95% by weight, particularly preferably, in the range of 65 to 95% by weight based on the composite material. The content of the polymer is preferably in the range of 1 to 40% by weight, further preferably, in the range of 5 to 40% by weight, particularly preferably, in the range of 5 to 35% by weight based on the composite material.

### 6. Liquid Crystal Display Element

The liquid crystal display element of the invention includes a liquid crystal display element in which a gap between a pair of substrates to be arranged oppositely to each other is regulated to a predetermined width by the spacer or the like, and the liquid crystal material is sealed in the gap (a sealed part is referred to as a liquid crystal layer), and the spacer arranged on the substrate for keeping thickness of the liquid crystal layer constant is formed using a photosensitive resin transfer material of the invention as described already, and the substrate includes the substrate of the invention.

Specific examples of the liquid crystals in the liquid crystal display element suitably include a STN mode, a TN mode, a GH mode, an ECB mode, ferroelectric liquid crystals, antiferroelectric liquid crystals, a VA mode, an MVA mode, an ASM mode, an IPS mode, an OCB mode, an AFFS mode and other various modes. A photospacer of the invention has an excellent uniformity, and therefore is specially adapted for a mode in which uniformity of a cell gap is particularly required, such as the IPS mode, the MVA mode, the AFFS mode and the OCB mode.

Specific examples of basic constitution embodiments of the liquid crystal display element of the invention include 1) a constitution in which a drive side substrate where a driver element such as a thin film transistor (TFT) and a pixel electrode (conductive layer) are subjected to alignment formation are arranged with a color filter side substrate provided with a color filter and a counter electrode (conductive layer) oppositely to each other by interposing a spacer, and a liquid crystal material is sealed into a gap part, and 2) a constitution in which a color filter integral type drive substrate where the color filter is directly formed on the drive side substrate is arranged with a counter substrate provided with the counter electrode (conductive layer) oppositely to each other by interposing the spacer, and the liquid crystal material is sealed into the gap part. The liquid crystal display element of the invention can be applied suitably to various types of liquid crystal display equipment.

In the liquid crystal display element of the invention, a liquid crystal medium is optically isotropic during no electric field application, but when the electric field is applied, the liquid crystal medium generates optical anisotropy and light modulation by the electric field is allowed.

Specific examples of structure of the liquid crystal display element include, as shown in FIG. 1, structure in which an electrode of a comb electrode substrate has electrode 1 extended from a left side and electrode 2 extended from a right side alternatively arranged. When a potential difference exists between electrode 1 and electrode 2, such a state can be provided in which electric fields from two directions including an upper direction and a lower direction exist on the comb electrode substrate as shown in FIG. 1.

### EXAMPLES

In the following, the invention will be further specifically explained by way of Examples, but the invention is not limited by the Examples.

In the specification, I represents a non-liquid crystal isotropic phase, N represents a nematic phase, N* represents a chiral nematic phase, BP represents a blue phase, and BPX represents an optically isotropic liquid crystal phase in which diffracted light of two or more colors is not observed. In the specification, an I-N phase transition point may be referred to as an N-I point. An I-N* transition point may be referred to as an N*-I point. An I-BP phase transition point may be referred to as a BP-I point.

In Examples and so forth in the specification, values of physical properties and so forth were measured and calculated according to the methods described below. Most of the methods were applied as described in EIAJ ED-2521A of the Standard of Electronic Industries Association of Japan or as modified thereon.

### Measurement of an Optical Texture and Phase Transition Temperature

A sample was placed on a hot plate (made by Linkam Scientific Instruments Ltd., trade name: Large-size sample heating/freezing stage for microscopy 10013, automatic cooling unit LNP94/2) of a melting point apparatus equipped to a polarizing microscope (made by Nikon Corporation, trade name: Polarizing Microscope System LV100 POL/DS-2Wv), under a crossed Nicols state, first heated to temperature where the sample turned into a non-liquid crystal isotropic phase, and then cooled at a rate of 1° C. per minute to exhibit a chiral nematic phase or an optically anisotropic phase completely. A phase transition temperature during the course was measured, and then the sample was heated at a rate of 1° C. per minute, and a phase transition temperature during the course was measured. When distinguishing a phase transition point was difficult in an optically isotropic liquid crystal phase under crossed Nicols in a dark field, a polarizer was deviated by 1 to 10 degrees from the crossed Nicols state, and then the phase transition temperature was measured.

### Measurement of a Pitch (P; 25° C.; Nm) and a Reflection Spectrum

Pitch length was measured using a selective reflection (Ekisho Binran (Handbook of Liquid Crystals in Japanese), page 196, Maruzen, published in 2000). A relational expression <n>p/λ=1 is given by a selective reflection wavelength (λ). Herein, <n> represents a mean refractive index and is given by the following expression: <n>={(n∥2+n⊥2)/2}½. The selective reflection wavelength was measured by means of a microspectrophotometer (made by Otsuka Electronics Co., Ltd., trade name: FE-3000). A pitch was determined by dividing a value of a reflection wavelength obtained from the measurement by the mean refractive index. As for a pitch of cholesteric liquid crystals having the reflection wavelength in a long wavelength region or a short wavelength region of visible light, and a pitch of cholesteric liquid crystals in which measurement was difficult, a selective reflection wavelength (λ′) was measured by adding a chiral agent at a concentration (concentration C′) having the selective reflection wavelength in a visible light region, and the pitch was determined by calculating an original selective reflection wavelength (λ) from an original chiral concentration (concentration C) according to a linear extrapolation method (λ=λ′×C′/C).

A reflection peak arising from diffraction of an optically isotropic phase was measured after a sample was placed on a hot plate (made by Linkam Scientific Instruments Ltd., trade name: Large-size sample heating/freezing stage for microscopy 10013, automatic cooling unit LNP94/2), first heated to temperature where the sample turned into a non-liquid crystal isotropic phase, and then cooled at a rate of 1° C. per minute to exhibit an optically anisotropic phase completely, and then the reflection peak was measured by means of a microspectrophotometer (made by Otsuka Electronics Co., Ltd., trade name: FE-3000).

### Dielectric Anisotropy (Δ∈)

An elastic constant was determined using voltage dependency of an electrostatic capacitance. Sweeping was performed sufficiently slowly so as to enter into a quasi-equilibrium state. A resolution of applied voltage was reduced as much as possible (an increment of about several tens of mV) particularly near Freedericksz transition in order to obtain an accurate value. Then ∈∥ was calculated from an electrostatic capacitance (C0) in a low voltage region as obtained from the measurement, and ∈⊥ was calculated from an electrostatic capacitance when the applied voltage was extrapolated into infinity, and then Δ∈ was determined from the values. K11 was determined from a Freedericksz transition point using the Δ∈. Furthermore, K33 was determined from K11 obtained from the measurement, and curve fitting to a capacitance change (apparatus: made by TOYO Corporation, Elastic Constant Measurement System Model EC-1).

In addition, as for conditions for measuring dielectric anisotropy, VAC was applied to a sample from 0 V to 15 V at a voltage increase rate of 0.1 V using square waves created by superimposing sine waves. Frequency of the square waves was 100 Hz, and VAC was 100 mV and frequency was 2 kHz for the sine waves. The square waves were measured at temperature lower by 20° C. than TNI of each liquid crystal component. As an evaluation cell, an antiparallel cell having a cell gap of 10 micrometers on which an alignment film was applied (made by E.H.C Co., Ltd., trade name: evaluation cell KSPR-10/B111N1NSS) was used.

### Refractive Index Anisotropy (Δn)

Measurement was carried out by means of an Abbe refractometer with a polarizer mounted on an ocular (made by Atago Co., Ltd. trade name: NAR-4T) using light at a wavelength of 589 nanometers. A surface of a main prism was rubbed in one direction, and then a sample was added dropwise onto the main prism. A refractive index (n∥) was measured when the direction of polarized light was parallel to the direction of rubbing. A refractive index (n⊥) was measured when the direction of the polarized light was perpendicular to the direction of rubbing. A value of optical anisotropy was calculated from an expression: Δn=n∥−n⊥. As measuring temperature, the measurement was carried at a point lower by −20° C. than TNI of the liquid crystal component.

Herein, a clearing point means a point in which a compound or composition exhibits an isotropic phase in the course of rising temperature. In the specification, an N-I point being a phase transition point from a nematic phase to the isotropic phase was indicated as TNI, a phase transition point from a chiral liquid crystal phase or an optically isotropic phase to the isotropic phase was indicated as TC.

### Method for Evaluating a Lattice Plane and a Lattice Plane Ratio of a Blue Phase by Using an Optical Texture

A lattice plane parallel to a substrate can be determined from a reflection peak of diffracted light of platelet texture, a selective reflection wavelength (TC−20° C.) in a chiral nematic phase and expression (I). From the results, a correlation between coloring of a plurality of platelets and the lattice plane of a blue phase was determined. Next, under observation using a polarizing microscope, a ratio in which the platelet observed occupies in a predetermined area was evaluated as a lattice plane ratio. For example, if the selective reflection wavelength of a chiral nematic phase was 400 nanometers, as for diffraction originating from a lattice plane (110) of the blue phase, a reflection peak appeared near around 560 nanometers. Under observation using the polarizing microscope (reflection), the platelet was observed as colored at a wavelength of the relevant reflection peak. An occupancy ratio of the platelet in a predetermined region was calculated as a ratio of a pixel of the relevant color relative to all pixels, and evaluated as the lattice plane ratio of the 110 plane. In addition, image analysis software (trade name: Micro Analyzer) made by Nihon Poladigital, K.K. was used for image analysis.

Method for Measuring a Contact Angle and Analyzing Surface Free Energy (γ^{T}, γ^{p}, γ^{d})

As for a contact angle, the contact angle of a solid surface substrate at a temperature of 60° C. was measured by means of an automatic contact angle meter (made by Kyowa Interface Science Co., Ltd., trade name: DM300) according to a drop method. A probe liquid, the solid surface substrate and an atmosphere inside an apparatus was at 60° C. The contact angle was measured spontaneously after dropping a liquid droplet. Water, diethylene glycol and n-hexadecane were used for the probe liquid. Total surface free energy γ^{T} was analyzed by applying a theory of Kaelble-Uy to a value of a measured contact angle. Surface free energy was analyzed by dividing components into polar component (γ^{p}) and dispersion component (γ^{d}).

### Measurement of a Contact Angle on a Substrate Surface of a Liquid Crystal Material Having an Isotropic Phase

As for a contact angle, the contact angle of a solid surface substrate at a temperature of 60° C. was measured by means of an automatic contact angle meter (made by Kyowa Interface Science Co., Ltd., trade name: DM300) according to a drop method. A probe liquid, the solid surface substrate and an atmosphere inside an apparatus was at 60° C. The contact angle was measured spontaneously after dropping a liquid droplet. In addition, all of liquid crystal materials of the invention indicated an isotropic phase at 60° C.

### Method for Measuring an Electro-Optic Effect

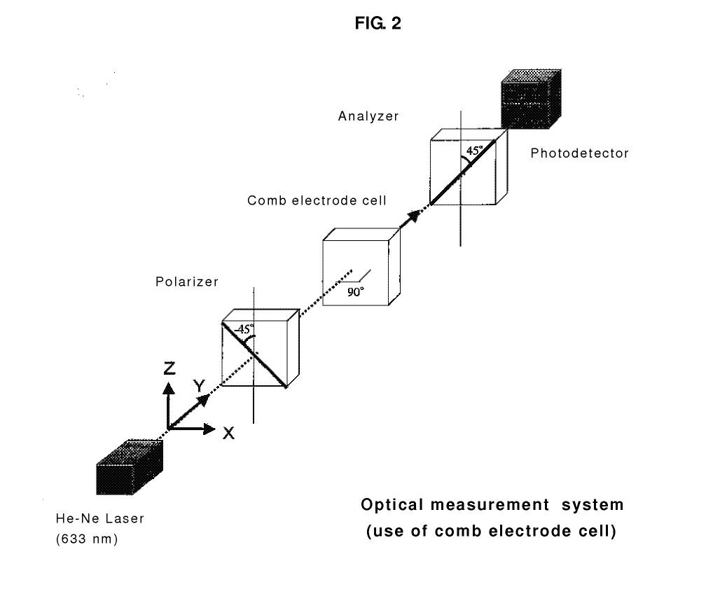

Electro-optic properties (transmitted light intensity during electric field application and during no application, or the like) were measured by installing a comb electrode cell containing a polymer/liquid crystal composite material into an optical system shown in FIG. 2. A sample cell was arranged vertically to incident light, and fixed on a large-size sample stand of a hot plate (made by Linkam Scientific Instruments Ltd., trade name: Large-size sample heating/freezing stage for microscopy 10013, automatic cooling unit LNP94/2), and cell temperature was adjusted at an arbitrary temperature. A direction of applying an electric field to the comb electrode was inclined by 45 degrees relative to a direction of polarization of the incident light, and as an electro-optic response, the transmitted light intensity with electric field application and without application was measured by applying alternating current square waves having VAC in the range of 0 to 230 V and a frequency of 100 Hz to the comb electrode cell under crossed Nicols. The transmitted light intensity with electric field application was defined as I, the transmitted light intensity without application was defined as I0, and voltage dependency properties of the transmitted light intensity were measured by applying expression (II). Hereafter, the properties were defined as VT properties.

$$I = {I}_{0} {sin}^{2} 2 θ {sin}^{2} \frac{π R}{λ} \qquad ( II )$$

Where R represents retardation and A represents an incident light wavelength.

### Preparation of Liquid Crystal Composition Y

Liquid crystal composition Y being a nematic liquid crystal composition was prepared by mixing 4′-pentyl-4-biphenylcarbonitrile (5CB) and JC1041XX (made by Chisso Corporation) at an equal weight ratio of 50:50. A liquid crystal material (liquid crystal material Y6) was prepared by adding 6% by weight of a chiral agent (ISO-6OBA2) as shown below to liquid crystal composition Y. The chiral agent to be added was added at such a ratio that a selective reflection wavelength of a chiral liquid crystal composition obtained was located at about 430 nanometers.

Moreover, a liquid crystal material (liquid crystal material Y6.5), a liquid crystal material (liquid crystal material Y7) and a liquid crystal material (liquid crystal material Y8) were prepared by adding 6.5% by weight, 7% by weight and 8% by weight of the chiral agent to liquid crystal composition Y, respectively.

### ISO-6OBA2

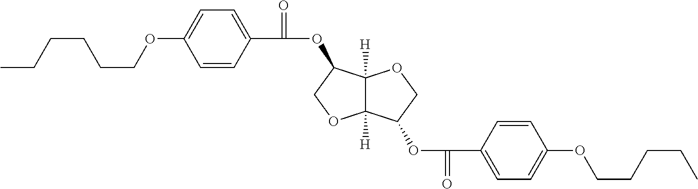 [SMILES: CCCCCCOc1ccc(C(=O)O[C@@H]2CO[C@H]3[C@@H]2OC[C@@H]3OC(=O)c2ccc(OCCCCC)cc2)cc1]

In addition, ISO-60BA2 was obtained by esterifying isosorbide and 4-hexyloxy benzoic acid under the presence of dicyclohexylcarbodiimide (DCC) and 4-dimethylaminopyridine.

Phase transition temperature of liquid crystal composition Y was measured by holding liquid crystal composition Y between blank glass substrates (a cell gap of 10 micrometers, E.H.C Co., Ltd., trade name: KSZZ-10/B511N7NSS) and under observation using a polarizing microscope. Measurement was carried out from a chiral nematic phase under measuring conditions of a heating rate of 1.0° C. per minute. The phase transition temperature of liquid crystal composition Y was N*·47.1° C.·BPI·48.7° C.·BPII·49.0° C.·I.

### Preparation of a Substrate Coated with a Resin Thin Film

### Examples 1 to 6

### (1) Preparation of a Varnish

Into a four-necked flask equipped with a stirrer, a nitrogen inlet, a thermometer and a raw material inlet, diamine compound A (DA-a3 (1.43 g, 2.75 mmol)), diamine compound B (DA-b1 (0.25 g, 1.18 mmol)) and a solvent N-methyl-2-pyrrolidinone (15 g, made by Mitsubishi Chemical Corporation, hereinafter, referred to as “solvent A”) were put, stirred and dissolved, and then acid anhydride compound C (AA-c1 (0.385 g, 1.97 mmol)), acid anhydride compound D (AA-d1 (0.429 g, 1.97 mmol)) and solvent A (15.0 g) were added, and the resultant mixture was stirred for about 1 hour.

Next, dilution was performed by adding 2-n-butoxyethanol (35 g, made by Kanto Chemical Co., Inc., hereafter, referred to as “solvent B), and then stirring was performed at 70° C. for about 6 hours or more, and thus a transparent solution (varnish A) of about 5% by weight of polyamide acid was obtained.

Viscosity at 25° C. of varnish A was 39.6 mPa·s.

Varnish B to varnish F were prepared under conditions similar to preparation of varnish A except that compounds and an amount thereof to be used as diamine compound A (hereinafter, referred to as “diamine A”), diamine compound B (hereinafter, referred to as “diamine B”), acid anhydride compound C (hereinafter, referred to as “acid anhydride C”) and acid anhydride compound D (hereinafter, referred to as “acid anhydride D”) were applied as shown in Table 1.

TABLE 1

| | | | | Acid |
|---|---|---|---|---|
| | Diamine A | Diamine B | Acid anhydride C | anhydride D |
| Varnish A | DA-a3(35) | DA-b1(15) | AA-c1(25) | AA-d1(25) |
| Varnish B | DA-a3(25) | DA-b1(25) | AA-c1(25) | AA-d1(25) |
| Varnish C | DA-a2(35) | DA-b1(35) | AA-c1(25) | AA-d1(25) |
| Varnish D | DA-a2(25) | DA-b1(25) | AA-c1(25) | AA-d1(25) |
| Varnish E | DA-a2(15) | DA-b1(25) | AA-c1(25) | AA-d1(25) |
| Varnish F | DA-a1(25) | DA-b1(25) | AA-c1(25) | AA-d1(25) |

Note:
A value in parenthesis was represented in terms of mole %.

In addition, in the specification, structure formulas of DA-a1, DA-a2, DA-a3, DA-b1, AA-c1 and AA-d1 were as described below.

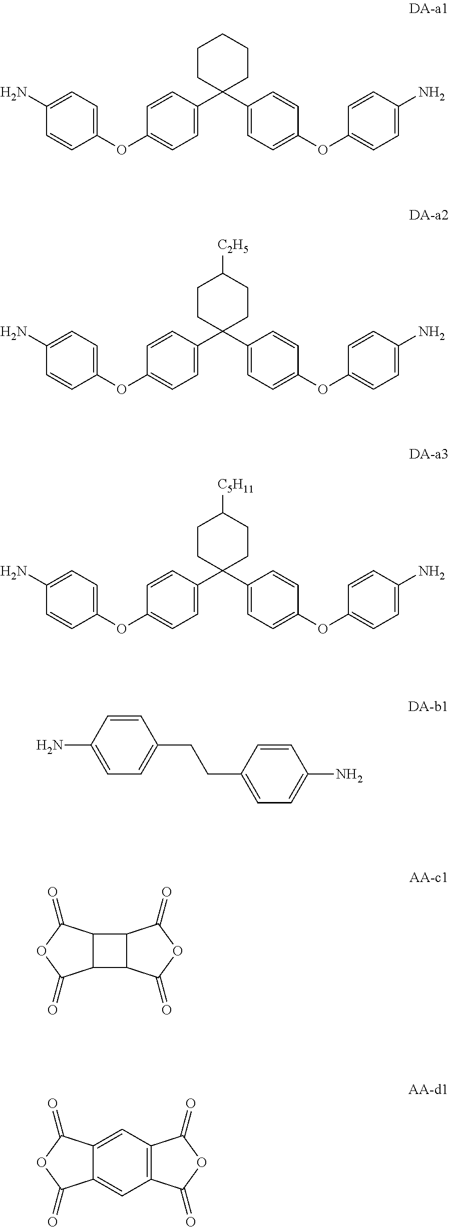

### (2) Preparation of a Solid Surface Substrate with a Polyimide Resin Thin Film (PA to PF)

A solvent in which 0.667 g of solvent A and 0.667 g of solvent B were mixed at a weight ratio of 50:50 was added to prepared varnish A (1.0 g), and thus a resin composition of 3% by weight was obtained. The composition was added dropwise onto a glass substrate subjected to surface modification by ozone treatment, and applied according to a spinner method (2,100 rpm, 60 seconds). After the application, heating was performed at 80° C. for 5 minutes to evaporate the solvent, heat treatment was performed at 230° C. for 20 minutes on a hot plate, and thus substrate PA1 coated with a polyimide resin thin film was manufactured (Example 1).

Moreover, substrate PA2 coated with the polyimide resin thin film also on a glass substrate provided with a comb electrode on one side (made by Alone Co., Ltd.) was manufactured by using varnish A in a similar technique.

Substrate PB1 and substrate PB2 (Example 2), substrate PC1 and substrate PC2 (Example 3), substrate PD1 and substrate PD2 (Example 4), substrate PE1 and substrate PE2 (Example 5), and substrate PF1 and substrate PF2 (Example 6) were manufactured under conditions similar to manufacture of substrate PA1 and substrate PA2 (Example 1) except that varnish B to varnish F were used in place of varnish A, respectively.

### Preparation of a Substrate Coated with an Organosilane Thin Film

### Examples 7 to 12

Formation of an organosilane thin film was performed in accordance with a method as described in Surface and Interface Analysis, 34, 550-554, (2002), or The Journal of Vacuum Science and Technology, A19, 1812, (2001).

### Example 11

After cleaning a glass substrate, surface modification was performed by ozone treatment. The glass substrate and organosilane coupling agent SE (n-octadecyltrimethoxysilane, Gelest, Inc.) were sealed into a closed vessel made of Teflon (registered trademark) under an atmospheric pressure, and then the closed vessel was left to stand in a heated electric furnace for a predetermined period of time (about 3 hours), and thus substrate SE1 coated with an organosilane thin film was manufactured. Substrate SE2 coated with the organosilane thin film also on a glass substrate provided with a comb electrode on one side (made by Alone Co., Ltd., trade name: electrode substrate with Cr) was manufactured by using organosilane coupling agent SE.

Substrate SA1 and substrate SA2 (Example 7), substrate SB1 and substrate SB2 (Example 8), substrate SC1 and substrate SC2 (Example 9), substrate SD1 and substrate SD2 (Example 10), and substrate SF1 and substrate SF2 (Example 12) were manufactured under conditions similar to manufacture of substrate SE1 and substrate SE2 (Example 11) except that organosilane coupling agent SA to organosilane coupling agent SD or organosilane coupling SF were used in place of organosilane coupling agent SE, respectively.

In addition, in the specification, structural formulas of organosilane coupling agent SA to organosilane coupling agent SF were as described below.

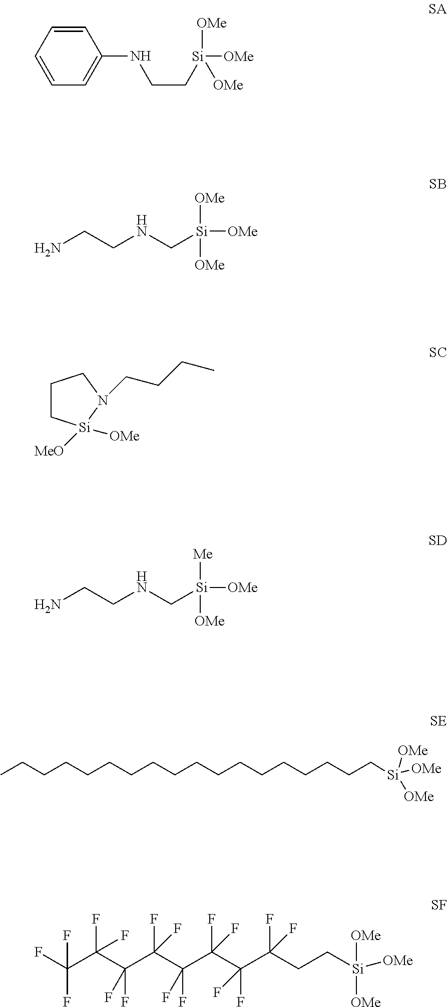 [SMILES: CO[Si](CCNc1ccccc1)(OC)OC ; CO[Si](CNCCN)(OC)OC ; CCCCN1CCC[Si]1(OC)OC ; CO[Si](C)(CNCCN)OC ; CCCCCCCCCCCCCCCCCC[Si](OC)(OC)OC ; CO[Si](CCC(F)(F)C(F)(F)C(F)(F)C(F)(F)C(F)(F)C(F)(F)C(F)(F)C(F)(F)F)(OC)OC]

Substrates, thin films provided for preparing the substrates, and thin film materials therefor according to Examples 1 to 12 were summarized as shown in Table 2.

TABLE 2

| | | | Substrate | |
|---|---|---|---|---|
| | Thin film | | Without a | With a |
| | provided on | | comb | comb |
| Example | a substrate | Thin film material | electrode | electrode |
| 1 | Polyimide | Varnish A | PA1 | PA2 |
| 2 | resin thin | Varnish B | PB1 | PB2 |
| 3 | film | Varnish C | PC1 | PC2 |
| 4 | | Varnish D | PD1 | PD2 |
| 5 | | Varnish E | PE1 | PE2 |
| 6 | | Varnish F | PF1 | PF2 |
| 7 | Organo- | Organosilane coupling | SA1 | SA2 |
| | silane | agent SA | | |
| 8 | thin film | Organosilane coupling | SB1 | SB2 |
| | | agent SB | | |
| 9 | | Organosilane coupling | SC1 | SC2 |
| | | agent SC | | |
| 10 | | Organosilane coupling | SD1 | SD2 |
| | | agent SD | | |
| 11 | | Organosilane coupling | SE1 | SE2 |
| | | agent SE | | |
| 12 | | Organosilane coupling | SF1 | SF2 |
| | | agent SF | | |

### Measurement of Surface Free Energy

Surface free energy (on a surface coated with a thin film) of substrate PA1 to substrate PF1 and substrate SA1 to substrate SF1 on which a comb electrode was not provided according to Example 1 to Example 12 was analyzed from a contact angle of a probe liquid of water, n-diethylene glycol (EG) and n-hexadecane (n-Hex). Moreover, a contact angle (LC iso.) in an isotropic phase (60° C.) of liquid crystal composition Y was measured as an index of interaction between a substrate and a liquid crystal composition.

TABLE 3
Contact angle to each probe liquid

| | | Contact angle (θ) | | | |
|---|---|---|---|---|---|
| | Substrate | Water | n-Hex | EG | LC iso. |
| Example 1 | P-A | 85.1 | 5.8 | 34.1 | 4.7 |
| Example 2 | P-B | 82.3 | 5.8 | 29.1 | 4.9 |
| Example 3 | P-C | 80.9 | 6.6 | 31.0 | 5.7 |
| Example 4 | P-D | 75.0 | 5.5 | 30.2 | 5.3 |
| Example 5 | P-E | 70.5 | 6.8 | 17.9 | 5.6 |
| Example 6 | P-F | 70.4 | 8.1 | 14.7 | 7.7 |
| Example 7 | S-A | 74.4 | 6.3 | 44.4 | 15.7 |
| Example 8 | S-B | 70.5 | 5.2 | 43.3 | 27.1 |
| Example 9 | S-C | 73.0 | 6.1 | 51.5 | 29.4 |
| Example 10 | S-D | 108.1 | 25.5 | 59.5 | 38.9 |
| Example 11 | S-E | 107.1 | 70.6 | 93.1 | 74.8 |
| Example 12 | S-F | 103.9 | 68.0 | 92.6 | 78.1 |

TABLE 4
Surface free energy

| | | Surface free | | |
|---|---|---|---|---|
| | | energy (/mJm⁻²) | | |
| | Substrate | γ^{T} | γ^{d} | γ^{p} |
| Example 1 | P-A | 31.9 | 27.5 | 4.4 |
| Example 2 | P-B | 33.0 | 27.5 | 5.5 |
| Example 3 | P-C | 33.5 | 27.4 | 6.1 |
| Example 4 | P-D | 36.4 | 27.5 | 8.9 |
| Example 5 | P-E | 38.8 | 27.4 | 11.4 |
| Example 6 | P-F | 37.3 | 27.4 | 9.9 |
| Example 7 | S-A | 36.7 | 27.4 | 9.3 |
| Example 8 | S-B | 38.6 | 27.5 | 11.1 |
| Example 9 | S-C | 37.4 | 27.4 | 10.0 |
| Example 10 | S-D | 25.0 | 25.0 | 0.0 |
| Example 11 | S-E | 13.9 | 12.2 | 1.7 |
| Example 12 | S-F | 15.3 | 13.0 | 2.3 |

Note)
γ^{T}: Total surface free energy
γ^{d}: Dispersion component of surface free energy
γ^{p}: Polar component of surface free energy

### Optical Texture of a Liquid Crystal Composition

Two of substrate PA1 manufactured in Example 1 were made ready, and bonded such that surfaces coated with a polyimide resin thin film of the substrates were opposed to each other. On the occasion, a PET film (thickness: 10 micrometers) was used for a spacer for a cell gap. Bonding of the substrates was carried out by dispersing a UV curable adhesive (made by E.H.C Co., Ltd., trade name: UV-RESIN LCB-610) in drops and performing UV irradiation (Ushio Inc., trade name: Multi-light System ML-501 C/B) for 5 minutes. Then liquid crystal composition Y was injected into a space between the two substrates, and thus liquid crystal composition Y was sandwiched and held therebetween. Thus, cell PA1 using substrate PA1 was prepared.

In addition, the cell gap was measured using a microspectrophotometer (made by Otsuka Electronics Co., Ltd., trade name: FE-3000).

Cell PB1 to cell PF1 and cell SA1 to cell SF1 were prepared under conditions similar to preparation of cell PA1 except that substrate PB1 to substrate PF1 and substrate SA1 to substrate SF1 were used in place of substrate PA1.

An optical texture of an optically isotropic phase in cell PA1 to cell PF1 and cell SA1 to cell SF1 was observed using a polarizing microscope (transmission type) under crossed Nicols.

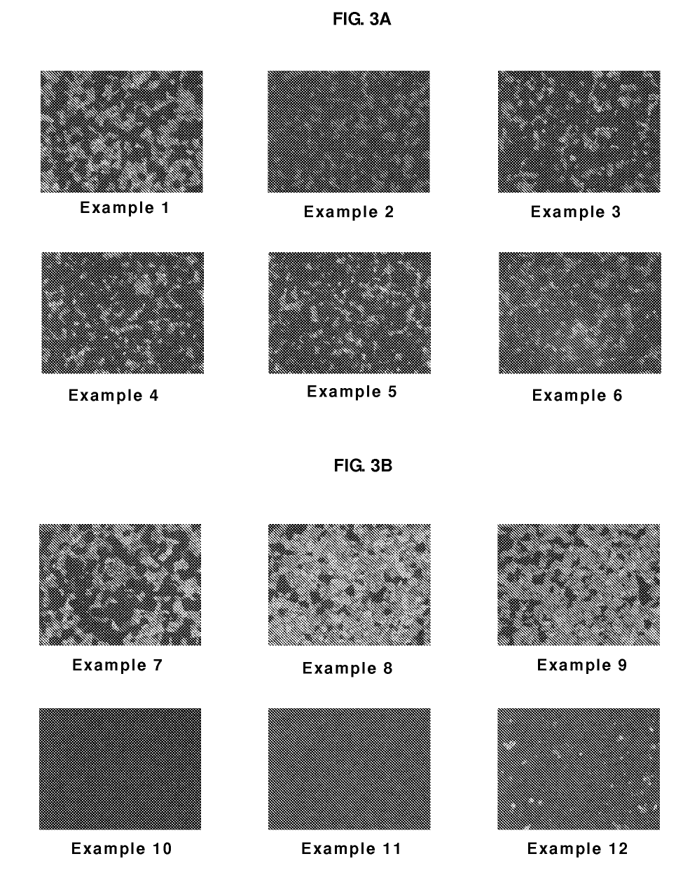

Specifically, cooling was performed from an isotropic phase at 60° C. to 52° C. at a cooling rate of 1.0° C. per minute, and then to 46° C. at a cooling rate of 0.3° C. per minute. The optical texture was photographed from 50° C. to 46° C. at every 0.5° C. by means of a camera attached to a microscope (made by Nikon Corporation, trade name: Polarizing Microscope System LV100 POL/DS-2Wv). In addition, photographing was performed after holding temperature for 3 minutes from the time when the temperature reached each observation temperature. FIG. 3A shows images obtained by photographing optical textures of cell PA1 to cell PF1, and FIG. 3B shows images obtained by photographing optical textures of cell SA1 to cell SF1.

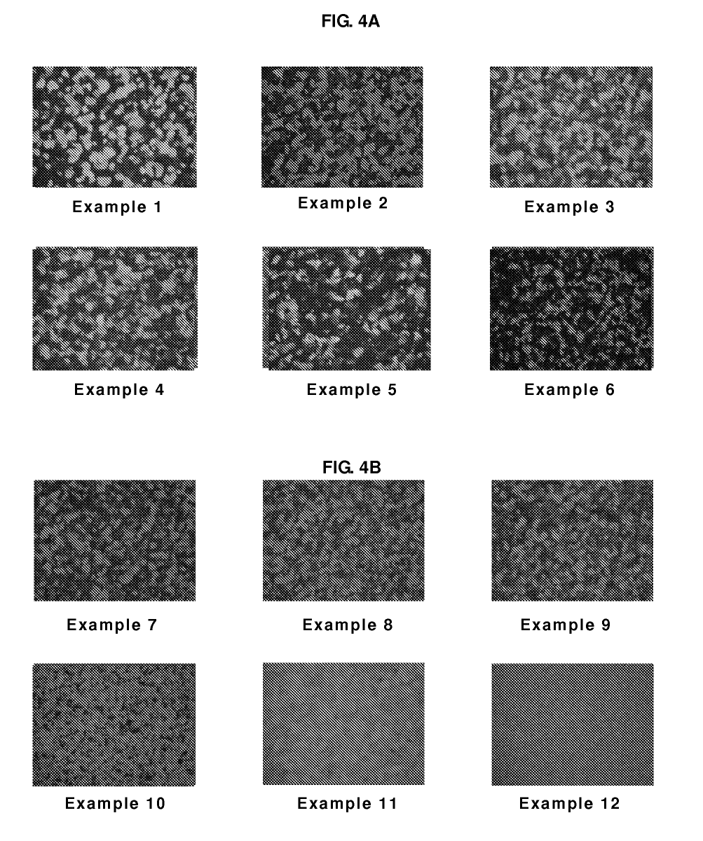

An optical texture of an optically isotropic phase in cell PA1 to cell PF1 and cell SA1 to cell SF1 was observed under crossed Nicols under completely identical conditions except that a polarizing microscope (reflection type) having an incident-light unit was used for the polarizing microscope. FIG. 4A shows images obtained by photographing optical textures of cell PA1 to cell PF1, and FIG. 3B shows images obtained by photographing optical textures of cell SA1 to cell SF1.

### Lattice Plane Ratio of a Liquid Crystal Composition

When blue phase I of liquid crystal composition Y in cell PA1 to cell PF1 and cell SA1 to cell SF1 was observed using a polarizing microscope (transmission type), a platelet (platelet optical texture) of a blue phase was exhibited at 48.0 to 47.5° C. One of the platelets exhibited in the cell exhibited red, and as for diffraction from the platelet, a reflection peak appeared at about 600 nanometers.

The platelet originating from a lattice plane (110) exhibited red under the polarizing microscope (transmission type), and the optical texture could be determined the lattice plane (110) of blue phase I which was aligned in parallel to the substrate as the optical texture.

A lattice plane ratio of the lattice plane (110) in cell PA1 to cell PF1 and cell SA1 to cell SF1 was as shown in Table 5. In addition, in the specification, a red platelet optical texture observed by means of the polarizing microscope (transmission type) was used as a reference of the lattice plane ratio of the lattice place (110) of a liquid crystal material.

TABLE 5
Lattice plane ratio (lattice plane (110))

| | Substrate | Lattice plane ratio (%) |
|---|---|---|
| Example 1 | P-A | 44.4 |
| Example 2 | P-B | 31.8 |
| Example 3 | P-C | 68.2 |
| Example 4 | P-D | 52.9 |
| Example 5 | P-E | 51.9 |
| Example 6 | P-F | 71.1 |
| Example 7 | S-A | 38.2 |
| Example 8 | S-B | 11.7 |
| Example 9 | S-C | 17.6 |
| Example 10 | S-D | 99.3 |
| Example 11 | S-E | 97.4 |
| Example 12 | S-F | 85.2 |

A microspectrophotometer (made by Otsuka Electronics Co., Ltd., trade name: FE-3000) was used for measuring diffraction. In addition, image analysis software (made by Nihon Poladigital, K.K., trade name: Micro Analyzer) was used for calculating, as the lattice plane ratio, an occupancy ratio of red platelets originating from the (110) plane in all images of red platelets from an image of a photographed optical texture (blue phase I) of liquid crystal composition Y.

### Relationship Between Surface Free Energy and a Lattice Plane Ratio (Lattice Plane 110)

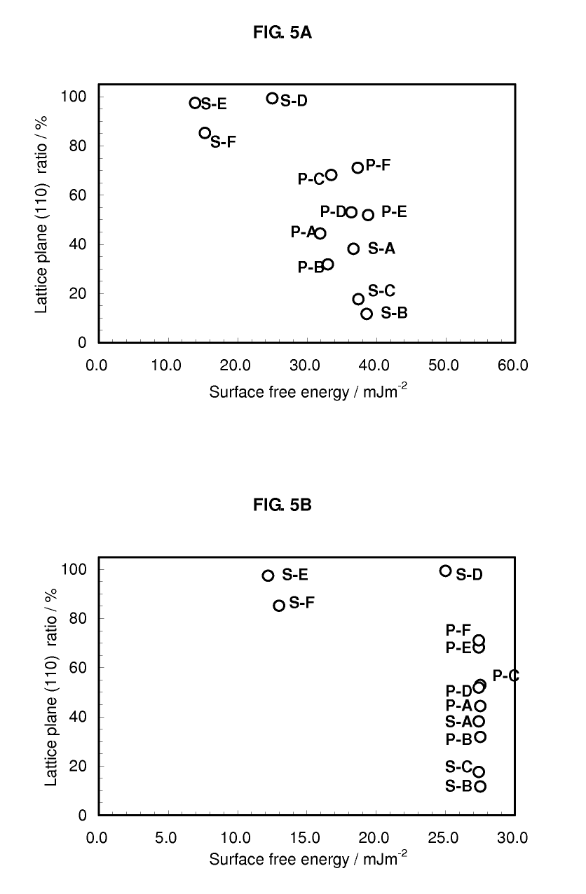

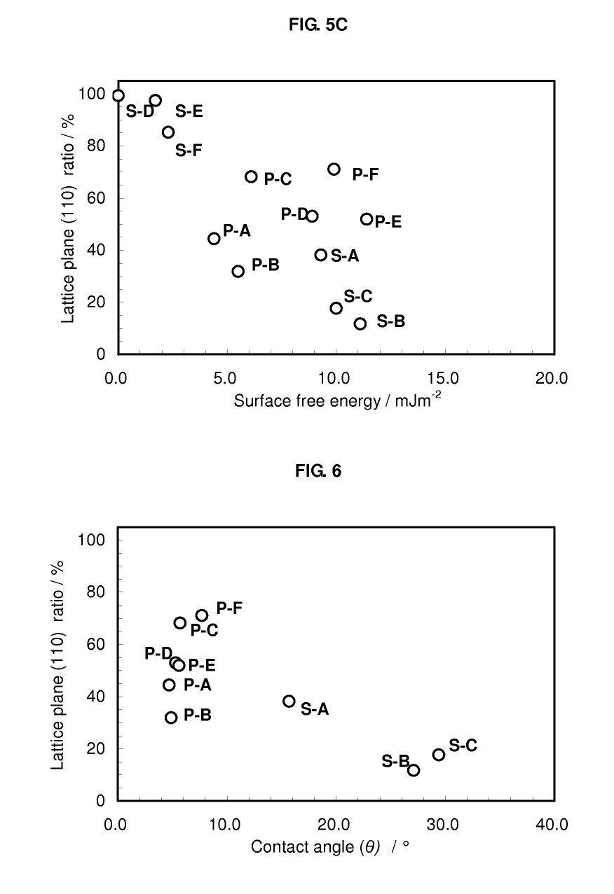

FIG. 5A is a graph prepared by setting, as a horizontal axis, total surface free energy (γ^{T}) of substrate PA1 to substrate PF1 and substrate SA1 to substrate SF1 respectively constituting cell PA1 to cell PF1 and cell SA1 to cell SF1, and setting, as a vertical axis, a lattice plane ratio (lattice plane 110) of liquid crystal composition Y sandwiched and held in the cell. In a similar manner, FIG. 5B is a graph prepared by setting, as a horizontal axis, surface free energy (γ^{d}) of the substrate, and FIG. 5C is a graph prepared by setting, as a horizontal axis, surface free energy (γ^{p}) of the substrate.

As shown in FIG. 5A, a predetermined correlation was recognized for total surface free energy (γ^{T}) and the lattice plane ratio (lattice plane 110).

Surface free energy (γ^{d}) had a substantially identical value except some of the cells.

A predetermined correlation was recognized for surface free energy (γ^{p}) and the lattice plane ratio (lattice plane 110). Specifically, the lattice plane ratio increased as the substrate had a smaller value of surface free energy (γ^{p}). Moreover, in the water-repellent board, BP which a lattice plane almost oriented it in the entire surface, and was controlled of the cell is provided. The relationship is not dependent on chirality of a liquid crystal composition. An identical trend was confirmed also in a composition having a small chirality.

### Relationship Between a Contact Angle to a Liquid Crystal Material and a Lattice Plane Ratio (Lattice Plane 110)

FIG. 6 is a graph prepared by setting, as a horizontal axis, a contact angle to liquid crystal composition Y in substrate PB1 to substrate PF1 and substrate SA1 to substrate SC1 being substrates indicating a value larger than 5 mJm⁻² in polar component (γ^{p}) of surface free energy, and respectively constituting cell PB1 to cell PF1 and cell SA1 to cell SC1, and setting, as a vertical axis, a lattice plane ratio (lattice plane 110) of liquid crystal composition Y sandwiched and held in the cell.

As shown in FIG. 6, when polar component (γ^{p}) of surface free energy indicated the value larger than 5 mJm⁻², a trend was shown in which the lattice plane ratio (lattice plane 110) increased as the contact angle between the substrate and liquid crystal composition Y (isotropic phase, 60° C.) was smaller. The lattice plane ratio was calculated from an image of an optical texture under observation using a transmission type polarizing microscope. When liquid crystal composition Y was sandwiched and held in an antiparallel rubbing cell (made by E.H.C Co., Ltd., trade name: KSRP-10/B111N1NSS), a single color blue phase was easily exhibited. FIG. 6 showed a correlation between the contact angle and the lattice plane ratio in the isotropic phase of the liquid crystal composition when γ^{p} indicated the value larger than 5 mJm−2 according to Examples 1 to 9, and a trend of increase of the lattice plane (110) ratio was indicated when wettability of the liquid crystal composition increased.

Relationship Between Surface Free Energy and a Lattice Plane Ratio (Other than Lattice Plane 110)

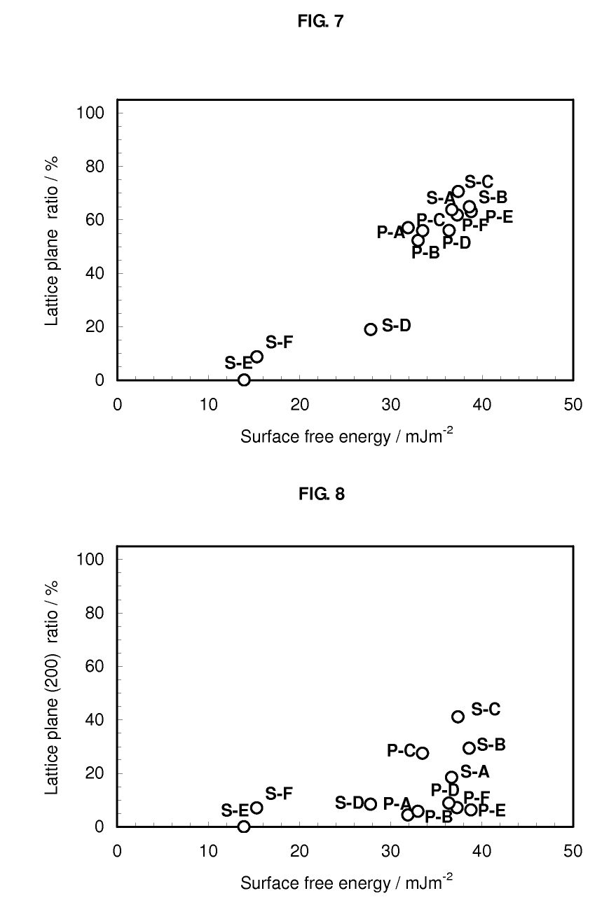

FIG. 7 is a graph prepared by setting, as a horizontal axis, total surface free energy (γ^{T}) of substrate PA1 to substrate PF1 and substrate SA1 to substrate SF1 respectively constituting cell PA1 to cell PF1 and cell SA1 to cell SF1, and setting, as a vertical axis, a lattice plane ratio (other than lattice plane 110) of liquid crystal composition Y sandwiched and held in the cell.

As shown in FIG. 7, the lattice plane ratio of a lattice other than the lattice plane 110 increased as a solid surface substrate has a larger value of total surface free energy (γ^{T}). The relationship is not dependent on chirality of a liquid crystal composition. An identical trend was confirmed also in a composition having a small chirality. Thus, a predetermined correlation was recognized between total surface free energy (γ^{T}) and lattice plane 200, 211, 111 or the like other than the lattice plane 110.

### Relationship Between Surface Free Energy and a Lattice Plane Ratio (Lattice Plane 200)

FIG. 8 is a graph prepared by setting, as a horizontal axis, total surface free energy (γ^{T}) of substrate PA1 to substrate PF1 and substrate SA1 to substrate SF1 respectively constituting cell PA1 to cell PF1 and cell SA1 to cell SF1, and setting, as a vertical axis, a lattice plane ratio (lattice plane 200) of liquid crystal composition Y sandwiched and held in the cell.

### Relationship Between a Contact Angle to a Liquid Crystal Material and a Lattice Plane Ratio (Lattice Plane 200)

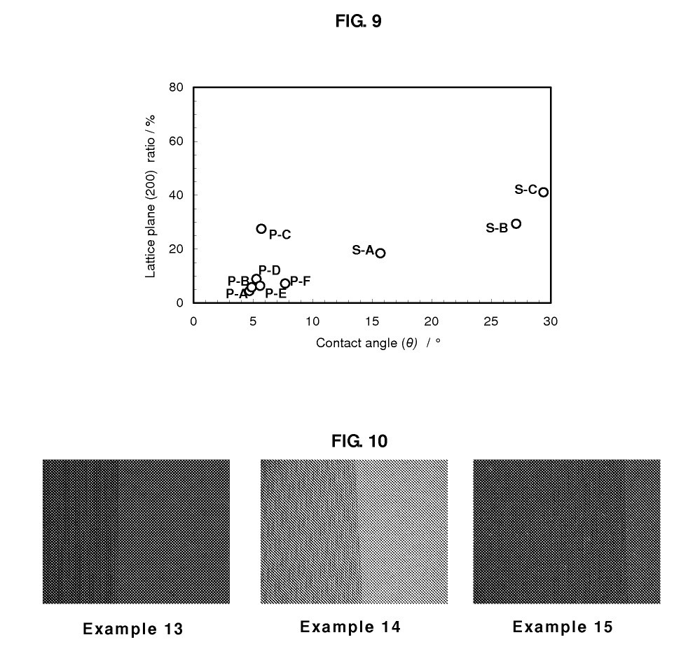

FIG. 9 is a graph prepared by setting, as a horizontal axis, a contact angle to liquid crystal composition Y in substrate PB1 to substrate PF1 and substrate SA1 to substrate SC1 respectively constituting cell PA1 to cell PF1 and cell SA1 to cell SC1, and setting, as a vertical axis, a lattice plane ratio (lattice plane 200) of liquid crystal composition Y sandwiched and held in the cell.

As shown in FIG. 9, in the case of an isotropic phase of a liquid crystal composition indicating a value larger than 5 mJm−2 in polar component (γ^{p}) of surface free energy (Examples 1 to 9), a trend was shown in which the lattice plane ratio (lattice plane 200) increased as the contact angle between the substrate and liquid crystal composition Y (isotropic phase, 60° C.) was larger.

A solid surface substrate indicating the value larger than 5 mJm−2 in polar component (γ^{p}) of surface free energy can leave diffracted light in a short wavelength side of an optically isotropic liquid crystal material, and allow diffracted light in a long wavelength side to substantially disappear. The diffracted light could be easily shifted to an ultraviolet region by slightly increasing chirality of liquid crystal composition Y (isotropic phase, 60° C.), and thus a liquid crystal display element having a high contrast could be obtained.

### Preparation of a Polymer/Liquid Crystal Composite Material

A polymer/liquid crystal composite material containing a liquid crystal composition and a polymerizable monomer were prepared in the following procedure.

Monomer composition (M) was prepared by mixing RM257 (made by Merck & Co., Inc.) and dodecylacrylate (made by Tokyo Chemical Industry Co., Ltd.) at a weight ratio of 50:50. Next, a raw material of a polymer/liquid crystal composite material (polymer/liquid crystal composite raw material 6.5) was prepared by preparing a monomer-containing mixture including 10% by weight of monomer composition (M) and 90% by weight of liquid crystal material Y6.5, and further mixing 2,2-dimethoxy-1,2-diphenylethan-1-one (made by Aldrich Corporation) as a polymerization initiator to be a ratio of 0.4% by weight based on the total weight of the mixture.

Polymer/liquid crystal composite raw material 7 and polymer/liquid crystal composite raw material 8 were prepared under conditions similar to preparation of polymer/liquid crystal composite raw material 1 except that liquid crystal material Y7 or liquid crystal material Y8 was used in place of liquid crystal material Y6.5.

### Preparation of a Cell Using a Polymer/Liquid Crystal Composite Material

### Examples 13 to 15

Substrate SE1 and substrate SE2 manufactured in Example 1 were made ready, and bonded such that surfaces coated with an organosilane thin film of the substrates were opposed to each other. On the occasion, a PET film (thickness: 10 micrometers) was used for a spacer for a cell gap. Bonding of the substrates was carried out by dispersing a UV curable adhesive (made by E.H.C Co., Ltd., trade name: UV-RESIN LCB-610) in drops and performing UV irradiation (Ushio Inc., trade name: Multi-light System ML-501 C/B) for 5 minutes.

Liquid crystal composition Y was sealed between two substrates at 70° C., and thus liquid crystal composition Y was sandwiched and held therebetween. Thus, comb electrode cell SE1 was prepared in which a polymer/liquid crystal composite material was used for a liquid crystal material, and substrate SE1 and substrate SE2 were used for the substrates.

Comb electrode cell SE2 (Example 13), comb electrode cell SE3 (Example 14) and comb electrode cell SE4 (Example 15) were prepared under preparation conditions similar to preparation of comb electrode cell SE1 except that polymer/liquid crystal composite raw material 6.5, polymer/liquid crystal composite raw material 7 or polymer/liquid crystal composite raw material 8 was injected in place of liquid crystal composition Y, and photopolymerization was performed (irradiation at 3 mW/cm² for 10 minutes) using a DEEP UV (made by Ushio Inc., trade name: Optical Modulex DEEP UV-500) light source in a temperature range in which blue phase I was exhibited after injecting the polymer/liquid crystal composite raw material.

Phase transition temperature of the liquid crystal materials in comb electrode cell SE2, comb electrode cell SE3 and comb electrode cell SE4, polymerization temperature conditions to the composite materials and reflection peaks in blue phase I were as shown in Table 6.

TABLE 6

| | Comb | | | Polymerization | Reflection |
|---|---|---|---|---|---|
| | electrode | Liquid crystal | Phase transition | temperature | peak |
| | cell | material | temperature (° C.) | (° C.) | (nm) |
| Example | SE2 | Polymer/liquid | N* 37.8 BPI 38.5 BPII 40.7 I | 38.1 | 606.0 |
| 13 | | crystal composite | | | |
| | | raw material 6.5 | | | |
| Example | SE3 | Polymer/liquid | N* 37.1 BPI 38.3 BPII 39.6 I | 37.2 | 564.0 |
| 14 | | crystal composite | | | |
| | | raw material 7 | | | |
| Example | SE4 | Polymer/liquid | N* 36.3 BPI 37.0 BPII 38.9 I | 36.5 | 492.0 |
| 15 | | crystal composite | | | |
| | | raw material 8 | | | |

An optical texture of a blue phase exhibited a structural color by diffraction in a short wavelength side when chirality increased, and exhibited a structural color by diffraction in a long wavelength side when chirality decreased. A polymer-stabilized blue phase obtained from the cell had a single color in any of optical textures. A blue structural color in the short wavelength side was obtained from the cell in Example 13, a red structural color in the long wavelength side was obtained from the cell in Example 14, and a green structural color located in an intermediate wavelength region was obtained from the cell in Example 15 by controlling chirality (FIG. 10).

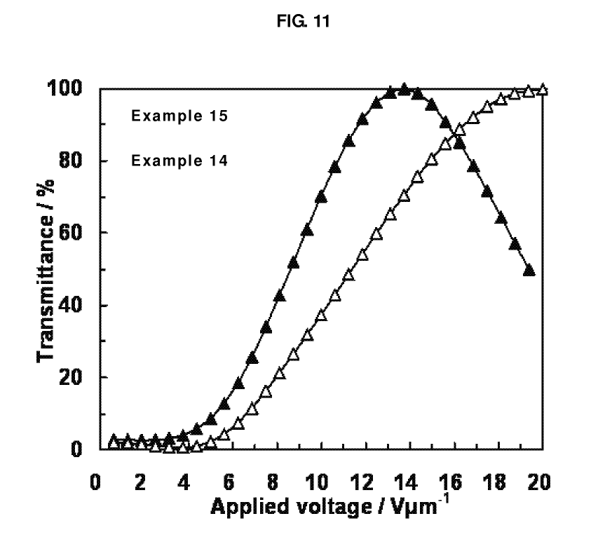

Transmitted light intensity at 25° C. during electric field application and during no application was measured, under crossed Nicols, using the comb electrode cells (SE3 and SE4) in Example 14 and Example 15 including the polymer/liquid crystal composite material. Specific electric field conditions were alternating current square waves having VAC in the range of 0 to 230 V and a frequency of 100 Hz, and as for transmittance, a maximum value of transmittance upon applying the electric field under crossed Nicols was defined to be 100%. Voltage applied at the time was defined to be saturation voltage. The thus measured VT properties of the comb electrode cells (SE3 and SE4) in Example 14 and Example 15 are shown in FIG. 11.

As shown in FIG. 11, the comb electrode cells in Example 14 and Example 15 had saturation voltage changed depending on chirality, but showed a gentle VT curve relative to applied voltage. The conventionally observed electro-optical properties were confirmed also in the polymer-stabilized blue phase subjected to lattice plane control.

### Preparation of a Rubbing Cell

### Example 16

A rubbing cell was prepared by holding liquid crystal material Y6 in an antiparallel rubbing cell (made by E.H.C Co., Ltd., trade name: KSRP-10/B111N1NSS) (Example 16).

In the rubbing cell in Example 16, a single color blue phase was easily exhibited.

### INDUSTRIAL APPLICABILITY

Specific examples of methods for utilization of the invention include a liquid crystal material and a liquid crystal element using the liquid crystal material.

1-49. (canceled)

50. A liquid crystal display element having two or more substrates arranged oppositely to each other and a liquid crystal material exhibiting a blue phase between the substrates,
where a polar component of surface free energy on a substrate surface in contact with the liquid crystal material is in the range of 5 to 20 mJm⁻², and
a contact angle with an isotropic phase of the liquid crystal material on the substrate surface is 50 degrees or less, wherein the substrate surface is subjected to coupling treatment.

51. The substrate according to claim 50, where the polar component of surface free energy on the substrate surface is in the range of 5 to 15 mJm⁻², and
the contact angle is 30 degrees or less.

52. The substrate according to claim 50, where the contact angle on the substrate surface of the liquid crystal material in the isotropic phase is 20 degrees or less.

53. The substrate according to claim 50, wherein the contact angle on the substrate surface of the liquid crystal material in the isotropic phase is in the range of 5 to 10 degrees.

54. The substrate according to claim 50, wherein total surface free energy on the substrate surface is 30 mJm⁻² or more.

55. The substrate according to claim 50, wherein the contact angle with water on the substrate surface is 10 degrees or more.

56. The substrate according to claim 50, where the substrate surface is subjected to rubbing treatment.

57. A liquid crystal display element in which a liquid crystal material exhibiting a blue phase is arranged between substrates, and an electric field application means is provided for applying an electric field to a liquid crystal medium through an electrode provided on one or both of the substrates,
where at least one of the substrates includes the substrate according to claim 50, and diffraction from a (110) plane or (200) plane of blue phase I is observed.

58. A liquid crystal display element in which a liquid crystal material exhibiting a blue phase is arranged between substrates, and an electric field application means is provided for applying an electric field to a liquid crystal medium through an electrode provided on one or both of the substrates,
where at least one of the substrates includes the substrate according to claim 50, and only diffraction from a (110) plane of blue phase II is observed.

59. A liquid crystal display element in which a liquid crystal material exhibiting a blue phase is arranged between substrates, and an electric field application means is provided for applying an electric field to a liquid crystal medium through an electrode provided on one or both of the substrates,
where at least one of the substrates includes the substrate according to claim 50, and a lattice plane of the blue phase of the liquid crystal material is single.

60. A liquid crystal display element in which a liquid crystal material exhibiting a blue phase is arranged between substrates, and an electric field application means is provided for applying an electric field to a liquid crystal medium through an electrode provided on one or both of the substrates,
where at least one of the substrates includes the substrate according to claim 50, and a lattice plane of blue phase I of the liquid crystal material is single.

61. A liquid crystal display element in which a liquid crystal material exhibiting a blue phase is arranged between substrates, and an electric field application means is provided for applying an electric field to a liquid crystal medium through an electrode provided on one or both of the substrates,
where at least one of the substrates includes the substrate according to claim 50, only diffraction from a (110) plane of blue phase I is observed, and a wavelength of diffracted light from the (110) plane is in the range of 700 to 1,000 nanometers.
